(19) United States
(12) Patent Application Publication
(10) Pub. No.: US 2026/0281725 A1
(43) Pub. Date: Sep. 17, 2026

(54) A METHOD AND SYSTEM FOR MANAGING A CONNETION IN CELLULAR NETWORKS

(71) Applicant: KONINKLIJKE PHILIPS N.V., EINDHOVEN (NL)

(72) Inventors: Oscar Garcia Morchon, Eindhoven (NL); Noureddine Sabah, Eindhoven (NL); Dan Jiang, Cambridge, MA (US); Walter Dees, Eindhoven (NL)

(21) Appl. No.: 19/509,539

(22) PCT Filed: Aug. 6, 2024
(86) PCT No.: PCT/EP2024/072260

§ 371 Date: May 14, 2026

Related U.S. Application Data
(60) Provisional application No. 63/614,028, filed on Dec. 22, 2023.
(60) Provisional application No. 63/645,231, filed on May 10, 2024.

(30) Foreign Application Priority Data
Aug. 7, 2023 (EP) 23190140.6
Sep. 22, 2023 (EP) 23199251.2
Mar. 21, 2024 (EP) 24165355.9
Apr. 1, 2024 (EP) 24167980.2
May 17, 2024 (EP) 24176801.9
May 30, 2024 (EP) 24179004.7
Jan. 18, 2025 (EP) 24152692.0
Feb. 14, 2025 (EP) 24157685.9

(51) Int. Cl. H04W 12/069; H04W 12/08; H04W 72/25; H04W 74/0833; H04W 76/14

(52) U.S. Cl. CPC H04W 12/069; H04W 12/08; H04W 72/25; H04W 74/0833; H04W 76/14

(57) ABSTRACT

This invention describes apparatuses/methods for enhanced user authentication in cellular networks wherein the apparatus/method checks for a preferred authentication procedure, performs the preferred authentication procedure with a core network, and sets up a connection. Thereby, authentication challenges (such as retrieving core network data, optimizing resources and strength of authentication) arising from users of one or more devices (e.g., UEs) using multiple/different networks, (e.g., with multiple subscriber identity modules and/or different radio access technologies), avatar-based communication and/or biometrics (e.g., by means of embedded sensors or wireless sensing) can be addressed.

### FIELD OF THE INVENTION

This invention relates to a method and system for managing a connection in cellular networks, in particular where the management of the connection involves enhanced user and device identification and authentication in cellular networks and may involve one or multiple devices. The invention can be implemented in (but is not limited to) augmented/virtual reality (AR/VR) or metaverse applications that can be defined as a virtual-reality space in which users can interact with a computer-generated environment and/or other users, devices using local communication interfaces, or ambient Internet of Things (IoT) devices.

### BACKGROUND OF THE INVENTION

Within the 3GPP Technical Specification Group Service and System Aspects (TSG SA), the main objective of 3GPP TSG SA WG1 (SA1) is to consider and study new and enhanced services, features, and capabilities of the 5G system and identify any corresponding stage 1 requirements to be met by 3GPP specifications. These service requirements are documented in normative specifications under SA1 responsibility. A related study is TR 22.847, “Study on supporting tactile and multi-modality communication services (TAMMCS)”. This study includes eight use cases and related requirements for the so-called “tactile internet” (TI).

The International Telecommunication Union (ITU) defines the TI as an internet network that combines ultra-low latency with extremely high availability, reliability and security. The mobile internet allowed exchange of data and multimedia content on the move. The next step is the internet of things (IoT) which enables interconnection of smart devices. The TI is the next evolution that will enable the control of the IoT in real time. It will add a new dimension to human-to-machine interaction by enabling tactile and haptic sensations, and at the same time revolutionize the interaction of machines. TI will enable humans and machines to interact with their environment, in real time, while on the move and within a certain spatial communication range.

IEEE publication P1918.1, “Tactile Internet: Application Scenarios, Definitions and Terminology, Architecture, Functions, and Technical Assumptions” demands that cellular 5G communication systems shall support a mechanism to assist synchronization between multiple streams (e.g., haptic, audio and video) of a multi-modal communication session to avoid negative impact on the user experience. Moreover, 5G systems shall be able to support interaction with applications on user equipment (UE) or data flows grouping information within one tactile and multi-modal communication service and to support a means to apply 3rd party provided policies for flows associated with an application. The policy may contain a set of UEs and data flows, an expected quality of service (QoS) handling and associated triggering events, and other coordination information.

In scenarios such as augmented or virtual reality (AR/VR) or metaverse or communications, a virtual-reality space in which users can interact with a computer-generated environment and other users, it is of key importance to authenticate the users and environment in such a way that the users can verify the identity of the other party, even if they are in an immersive metaverse call.

However, current video streaming platforms are not capable of performing a suitable authentication procedure of metaverse users as well as the avatar models used in the communication.

This problem is not only limited to metaverse users, but also to real world users in the case that, e.g., a UE of a user or a UE fulfilling a given task (e.g., a UE used to monitor or track an item) is stolen, misused or misplaced. Furthermore, by identifying the user or device, provided services may be adapted or optimized.

In some scenarios, the number of devices around a user keeps increasing. This leads to limitations regarding the required resources to connect those devices.

In other scenarios related to resource constrained devices, such as ambient IoT de-vices, constrained devices may need to establish a connection with an access device or core network to exchange data in a secure way. However, the resource constraints of those devices make it challenging to use existing solutions.

It is therefore desirable to offer a way to enhance existing methods, such as authentication methods, to handle the connection of one or more devices in cellular networks.

### SUMMARY OF THE INVENTION

It is an object of the present invention to enable an optimized authentication procedure for cellular networks.

This object is achieved by a method as claimed in claim 1, 47, by a user equipment as claimed in claim 52 or 53, by a computer program product as claimed in claim 54.

In accordance with a first aspect of the invention, it is proposed a method of an apparatus for managing a connection, comprising:
the apparatus selecting one of a plurality of authentication procedures;
the apparatus performing the selected authentication procedure with or through a core network; and
the apparatus setting up the connection once the selected authentication procedure is successful.

In a first variant of the first aspect, the apparatus may be provided at a first user device and the method comprises the apparatus
announcing its presence over a local communication (e.g., PC5) interface,
receiving authentication parameters from a second user device (e.g., UE or IoT device),
combining the authentication parameters from the second user device and its own authentication parameters to perform a combined authentication procedure, and
receiving communication parameters for the first user device and the second user device.

In a second variant of the first aspect which may be combined with the first variant, wherein the selected authentication procedure comprises:
performing a primary authentication procedure,
collecting user authentication information, such as biometric information of a user or information of other user devices close or connected to or attached to the apparatus and/or the user, and
securely sending the collected user authentication information to the core network.

In a third variant of the first aspect which may be combined with the other variants, wherein the selected authentication procedure comprises:
collecting user authentication information, such as biometric information of a user or information of other user devices close or connected to or attached to the apparatus and/or the user,
securely sending the user authentication information to the core network, and
receiving a confirmation to set up the connection.

In a fourth variant of the first aspect building on the first variant but which may be combined with the other variants as well, the apparatus may be adapted to forward a RAN identifier for the second user device
upon performing a joint random-access procedure, or
upon performing a joint random-access procedure and upon successful authentication of the second user device.

In a fifth variant of the first aspect building on the first variant but which may be combined with the other variants as well, combining the authentication parameters from the second user device and its own authentication parameters may involve
concatenating the authentication parameters of the apparatus and the second UE or
obtaining a new authentication parameter as a cryptographic function of the authentication parameters of the apparatus and the second user device.

Further to the fifth variant, the apparatus may be configured to first execute the authentication procedure based on the new authentication parameter, and if the authentication procedure fails, execute the authentication procedure based on the concatenation of the authentication parameters of the apparatus and the second user device.

In a further variant of the first aspect, that can be combined with the other variants, the apparatus may be configured to obtain a first measurement from a first sensor, obtain a second measurement from a second sensor, and correlate the first and second measurements to validate a user.

In another variant of the first aspect, that can be combined with the other variants, the method comprises the apparatus establishing an avatar-based communication with a remote user device upon successful biometric verification or joint authentication.

In another variant of the first aspect, that can be combined with the other variants, the method comprises the apparatus:
performing an authentication and key management for application procedure for user authentication and authorization, or
optimizing the connection based on an identified user, or
enabling a transmission of user identification data during an emergency call.

In another variant of the first aspect, that can be combined with the other variants, the method comprises the apparatus retrieving or configuring or appling a user authentication policy in a core network function, wherein:
the user authentication policy is user-defined or subscription-defined; and/or
the user authentication policy includes user authentication methods applicable or required to access different services; and/or
the user authentication policy includes a user consent to use a predetermined authentication method.

In another variant of the first aspect, that can be combined with the other variants, the method comprises
receiving a first message including one or more of:
   a random number or counter,
   an identity of an access device, authentication service, or group of devices or application or network,
   a supported message type,
   a supported device type,
   a data container,
   a request to retrieve certain information, and
   a supported communication topology,
determining whether the first message is intended for the apparatus, and
sending a message to perform the selected authentication procedure and setting up the connection including one or more of:
   a data container,
   a random number or counter,
   an identity of the access device or the authentication service, or application or network,
   a message type,
   a device type,
   an amount of energy harvested and an energy harvest duration, and
   a communication topology.

In accordance with a second aspect of the invention, a user equipment is proposed, which comprises or implements the apparatus of the first aspect, and optionally its variants.

In accordance with a third aspect, it is proposed a method for establishing and managing a connection between a first device and a network or application function, comprising:
an apparatus registering and announcing its capabilities to the network,
the apparatus receiving, from the network and/or an application function, a configuration for connection set up and management between the first device and the network and/or application function,
the apparatus managing, based on the received configuration, messages exchanged between the first device and the network or application function.

In a first variant of the third aspect, the method comprises the apparatus requesting the first device to switch its transmission mode to backscatter communication upon receiving an indication of low energy from the first device.

In a second variant of the third aspect which may be combined with the first variant, the capabilities announced to the network include one or more of the following:
transmission of messages including data containers,
receiving messages including data containers,
exchanging security protocol-specific parameters,
list of at least one topology supported,
list of at least one authentication method supported,
interim authentication results verification,
aggregation and/or storage of received response messages,
processing received response messages to identify and/or authenticate the first device.

The method of the first and third aspects and all their variants may be implemented by a computer program comprising code means for producing the steps of the method when run on a computer device.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the user equipment of claim 13, the method of claim 14, and the computer program product of claim 15 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIGS. 1A and 1B schematically show block diagrams of alternative network architectures for a metaverse implementation in a cellular network;

FIG. 2 schematically shows a block diagram of a cellular network involving multiple user equipment devices;

FIG. 3 schematically shows a procedure of an enhanced primary authentication procedure involving multiple user equipment devices;

FIG. 4 schematically shows another procedure of an enhanced primary authentication procedure involving multiple user equipment devices;

FIG. 5 schematically shows waveforms relating to a similarity check between the measurements of two user equipment devices;

FIG. 6 schematically shows a procedure of an enhanced authentication procedure in a metaverse application;

FIG. 7 schematically shows a procedure for communication with an ambient IoT device;

FIG. 8 schematically shows an exemplary procedure of a container-based approach;

FIG. 9 schematically shows an exemplary procedure of another container-based approach;

FIG. 10 is a communication exchange chart representing a procedure in accordance with another embodiment;

FIG. 11 is a communication exchange for user identification and authentication;

FIGS. 12 and 13 are two exemplary procedures of a container-based communication approach; and

FIG. 14 is a communication exchange for user identification and authentication.

### DETAILED DESCRIPTION OF EMBODIMENTS

Embodiments of the present invention are now described based on a cellular communication network environment, such as 5G. However, the present invention may also be used in connection with other wireless technologies in which TI or metaverse applications are provided or can be introduced. The present invention may also be applicable to other applications such as video streaming services, video broadcasting services, or data storage.

Throughout the present disclosure, the abbreviation “gNB” (5G terminology) or “BS” (base station) is intended to mean a wireless access device such as a cellular base station or a Wi-Fi access point or a ultrawide band (UWB) personal area network (PAN) coordinator. The gNB may consist of a centralized control plane unit (gNB-CU-CP), multiple centralized user plane units (gNB-CU-UPs) and/or multiple distributed units (gNB-DUs). The gNB is part of a radio access network (RAN), which provides an interface to functions in the core network (CN). The RAN is part of a wireless communication network. It implements radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” (BS) and “network” may be used as synonyms in this disclosure. This means for example that when it is written that the “network” performs a certain operation it may be performed by a CN function of a wireless communication network, or by one or more base stations that are part of such a wireless communication network, and vice versa. It can also mean that part of the functionality is performed by a CN function of the wireless communication network and part of the functionality by the base station.

Moreover, the term “metaverse” is understood as referring to a persistent shared set of interactable spaces, within which users may interact with one another alongside mutually perceived virtual features (i.e., augmented reality (AR)) or where those spaces are entirely composed of virtual features (i.e., virtual reality (VR)). VR and AR may generally be referred to as “mixed reality” (MR) or XR. In some cases, the terms may be used interchangeably.

Additionally, the term “data” is understood as referring to a representation according to a known or agreed format of information to be stored, transferred or otherwise processed. The information may particularly comprise one or more channels of audio, video, image, haptic, motion or other form of multimedia information that may be synchronized. Such multimedia information may be derived from sensors (e.g., microphones, cameras, motion detectors, etc.) or may be partially or wholly synthesized (e.g., live actor in front of a synthetic background).

It is noted that throughout the present disclosure only those blocks, components and/or devices that are relevant for the proposed embodiments are shown in the accompanying drawings.

Other blocks have been omitted for reasons of brevity. Furthermore, blocks designated by the same reference numbers are intended to have the same or at least a similar function, so that their function is not described again later.

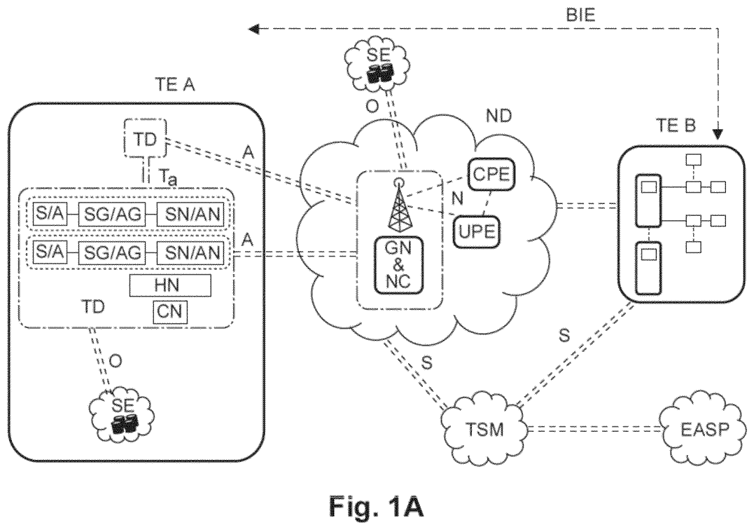

FIGS. 1A and 1B schematically show network architectures considered for implementing a metaverse (e.g., IEEE P1918.1 architecture). The architectures comprise an actuator gateway (AG), an actuator node (AN), a controller node (CN), a control plane entity (CPE), a gateway node (GN, wherein GNC corresponds to GN & CN), a human-system interface node (HN), a network controller (NC), a sensor/actuator (S/A), a computing and storage entity (SE), a sensor gateway (SG), a sensor node (SN), a tactile device (TD), a tactile edge (TE), a tactile service manager (TSM), a user plane entity (UPE), an access interface (A), a first tactile interface Ta (TD-to-TD communication), a second tactile interface Tb (TD-to-GNC communications), an open interface (O), a service interface(S), a network side (N), a network domain (ND), a bidirectional information exchange (BIE), an external application service provider (EASP), and a dedicated low latency network (LLNW).

The architectures of FIGS. 1A and 1B provide an overall communication architecture defined in a generic manner capable of running over/on any network, including 5G. They cover various modes of interconnectivity network domains between two TEs (TE A, TE B). Each TE consists of one or multiple TDs, where TDs in TE A communicate information, e.g., tactile/haptic, with TDs in TE B through the ND, to meet the requirements of a given TI use case. The ND can be either a shared wireless network (e.g., 5G radio access and core network), shared wired network (e.g., Internet core network), dedicated wireless network (e.g., point-to-point microwave or millimeter wave link), or dedicated wired network (e.g., point-to-point leased line or fiber optic link). Each TD can support one or multiple of the functions of sensing, actuation, haptic feedback, or control via one or multiple corresponding entities. The S or A entity refers to a device that performs sensing or actuation functions, respectively, without networking module. The SN or AN refers to a device that performs sensing or actuation functions, respectively, with an air interface network connectivity module. In order to connect S to SN or A to AN, the SG or AG entity should be used, respectively. These gateways provide a generic interface to connect to third-party sensing and actuation devices and another interface to connect to SNs and ANs. A TD can also serve as the HN, which can convert human input into haptic output, or as the CN, which runs control algorithms for handling the operation of a system of SNs and ANs, with the necessary network connectivity module.

The GN is an entity with enhanced networking capabilities that reside at the interface between the TE and the ND and is mainly responsible for user plane data forwarding. The GN is accompanied by the NC that is responsible for control plane processing including intelligence for admission and congestion control, service provisioning, resource management and optimization, and connection management in order to achieve the required QoS for the TI session. The GN and CN (together labelled as GNC) can reside either in the TE side (as shown in FIG. 1A) or in the ND side (as shown in FIG. 1B), depending on the network design and configuration. The GNC is a central node as it facilitates interoperability with the various possible network domain options, which is essential for compatibility with other emerging standards such as the 3GPP 5G NR specifications. Allowing the GNC to reside in the ND, for example under 5G, intends to support the option of absorbing its functionality into management and orchestration functionalities already therein. In FIGS. 1A and 1B, the ND is shown to be composed of a radio access point or base station connected logically to CPEs and UPEs in the network core.

A user in a region of interest (ROI) is surrounded by a set of TDs linked to a TE. A TD might comprise rendering actuators and/or sensors. Rendering actuators have the task of creating a metaverse environment around the user and might be VR glasses, a 3D television (TV), a holographic device, etc. A sensor TD is a device in charge of capturing the actions and/or environment of the user and might include video cameras, audio devices such as microphone, haptic sensors, etc. In general, a TD might be a UE in terms of a 5G system.

The TDs in a ROI may be connected to the TE of the user, e.g., by means of wires or wirelessly. In the wireless case, the UEs may be connected to a base station such as a 5G gNB or to a Wi-Fi access point. The networking infrastructure and computational resources of the TE are either co-located in the ROI or located (distance less than a maximum edge distance) in a close edge server to ensure a fast response.

To assist the implementation of the following embodiments, at least one of three communication functionalities may be introduced. First, latency-based flow synchronization (LBFS) may be provided, which is a functionality running in a device in the TE. It could also be deployed in a receiving TD capable of determining communication parameters with sending TDs (or TS) and synchronizing communication flows based on those communication parameters, in particular, the relative latency between TDs (or TEs). Second, an edge application at a TE may be configured to run a latency-dependent configurable predictive model (LDCPM) of the environment/persons in the metaverse session in a different TE. Third, a model management and configuration functionality may be provided, that is capable of registering a generic model of an ROI and/or device and/or person in a TE, storing it in a data base, and deploying a re-configured LDCPM upon determining the communication parameters.

Another pioneering node in the architectures of FIGS. 1A and 1B is the SE that provides both computing and storage resources for improving the performance of the TEs and meeting the delay and reliability requirements of the E2E communications. The SE will run advanced algorithms, employing AI techniques, among others, to offload processing operations that are too resource and/or energy intensive to be done in the TD (e.g., haptic rendering, motion trajectory prediction, and sensory compensation). The goal is to enable the perception of real-time connectivity using predictive analytics while overcoming the challenges and uncertainties along the path between the source and destination TDs, dynamically estimate network load and rate variations over time to optimize resource utilization, and to allow sharing of learned experiences about the environment among different TDs. On the other hand, the SE will also provide intelligent caching capabilities which can be very impactful in reducing the E2E traffic load and thus reducing the data transmission delays. The SE can reside locally within the TE to enhance the response rate for requests from TDs or GNC, and/or it can reside remotely in the cloud while providing services to the TEs and the ND. Moreover, the SE can be either centralized or distributed. Each of these options has its own pros and cons in terms of delay, reliability, capabilities, cost, and practical feasibility. The communications between the two TEs can be unidirectional or bidirectional, can be based on client-server or peer-to-peer models and can belong to any of the above-mentioned use cases with their corresponding reliability and delay requirements. To this end, the TSM plays a critical role in defining the characteristics and requirements of the service between the two TEs and in disseminating this information to key nodes in the TE and the ND. The TSM will also support functions such as registration and authentication and will provide an interface to EASPs of the TI.

The A interface provides connectivity between the TE and the ND. It is the main reference point for the user plane and the control plane information exchange between the ND and the TE. Depending on the architecture design, the A interface can be either between the TD and the ND or between the GNC and the ND. Furthermore, the T interface provides connectivity between entities within the TE. It is the main reference point for the user plane and the control plane information exchange between the entities of the TE. The T interface is divided into two sub-interfaces Ta and Tb to support different modes of TD connectivity, whereby the Ta interface is used for TD-to-TD communications and the Tb interface is used for TD-to-GNC communications when the GNC resides in the TE. Additionally, the O interface provides connectivity between any architectural entity and the SE, and the S interface provides connectivity between the TSM and the GNC. The S interface carries control plane information. Finally, the N interface refers to any interface providing internal connectivity between ND entities. This is normally covered as part of the network domain standards and can include sub-interfaces for both user plane and control plane entities.

Two broad categories of haptic information may be implemented, namely, tactile or kinesthetic, which may be combined. Tactile information refers to the perception of information by various mechanoreceptors of the human skin, such as surface texture, friction, and temperature.

Kinesthetic information refers to the information perceived by the skeleton, muscles, and tendons of the human body, such as force, torque, position, and velocity.

A first differentiating aspect of TI and related standards compared with 5G ultra reliable low latency communication (URLLC, ITU-R M.2083) relates to the fact that the TI must be developed in a way that can realize its requirements over longer distances than the 150 km (or 100 km in fiber) separation for a round-trip due to a propagation time of 1 ms. Such capability can be achieved through network side support functions built into the TI architecture, as envisioned through the standards work in IEEE 1918.1. These functions could, for example, model the remote environment using artificial intelligence (AI) approaches and could in some cases also partly or totally be present at the TI end device (i.e., the client of the TI/haptic information).

A second differentiating aspect relates to the fact that TI leads to an application with unique characteristics implied by that application and with the expectation that the application can be deployed as an overlay network on top of a network or combination of networks. It is not intended to apply in the context of 5G URLLC as the underlying communication means only.

Applications, e.g., metaverse or teleconferencing or video streaming, etc, making use of the above communication infrastructure may be capable of configuring and using the communication infrastructure for optimized performance. This configuration and usage may be done through the tactile service manager (TSM) that coordinates the underlying networks and communications. A 5G (or 6G) TSM may be present in the 5GS (or 6GS). The 6G TSM may interact with the 5G TSM. Furthermore, the configuration may be controlled by means of a policy which may include configuration items for each tactile device (TD) in each tactile edge (TE). Every time a new TE (TD) joins a (new) (metaverse) communication session, the application may add entries to the policy corresponding to the new TD or TE. The TSM and/or application may also coordinate the preferences of the transmitting/receiving entities and may adapt, correspondingly, the encoding/communication parameters, e.g., models used. For instance, the TSM may distribute the policy of the new TD (TE) to all existing TDs (TEs) already involved in the (metaverse) communication session. Additionally, the TSM may distribute the policy including entries of all existing TDs (TEs) already involved in the (metaverse) communication session to the new TD (TE). The configuration may be a one-time configuration or may be a metaverse session configuration for a metaverse session between a number of TEs (e.g., a number of users (A, B, . . . , i, . . . )).

Moreover, the configuration may include a policy specifying, e.g., QoS goals depending, e.g., on number of users, relative latency, need of continuous monitoring of the latency between TEs as well as update rate of parameters as explained in other embodiments, latency requirements for each of the TD in a TE, need of QoS equalization, and if applicable, so that compression schemes or models and/or a predictive model of each TD in a TE may be correspondingly adapted, or the TSM can deploy the model or a compressed model to the other TDs/TEs in a communication session.

Similarly, the communication infrastructure may also inform the (metaverse) application about communication parameters and/or configure the (metaverse) application.

It is to be noted that the transmitting and receiving devices maybe far or close, and therefore, the transmitting TE and receiving TE may be collocated. It is to be noted that the TE is not always required.

Unicast communication flows may require keeping unicast flows per sensing TD (N devices) towards each actuator/rendering TD (M devices). This can become less efficient as N and M increase. A more efficient approach consists in a multicast approach in which each sensing TD multicasts its flow and the flow is distributed to each of the subscribed rendering TDs. This involves N multicast flows even if it is still important to consider that the multicast flow may reach different rendering TDs/TEs at different instants of times, and those TDs/TEs receiving the multicast flow earlier may use, e.g., a compressed model of the sending TD/TE while those TDs/TEs receiving the multicast flow later might require, e.g., a less compressed model.

Furthermore, the architecture of the proposed compression system may be enhanced for or used to enhance the, e.g., next generation real time communication or multicast and broadcast services. For instance, 3GPP specification TR 23.700-87 v1.0.0 describes 5G system architecture enhancements for next generation real time communication including IP multimedia subsystem (IMS) network architecture enhancements required to support AR telephony communication for different types of AR-capable UEs, and IMS procedures including signaling and media processing need to be changed to support AR telephony communication. Solutions #8 and #9 in TR 23.700-87 specification address these architecture enhancements. In TR 23.700-87, it is concluded that the data channel architecture is used as baseline to support AR telephony communication. If the UE needs network support for media rendering, the architecture and procedures specified in Solution #9 are used.

Otherwise, if the UE can perform the media rendering without network support, the procedures as specified in Solution #8 are taken as baseline for terminal rendering process.

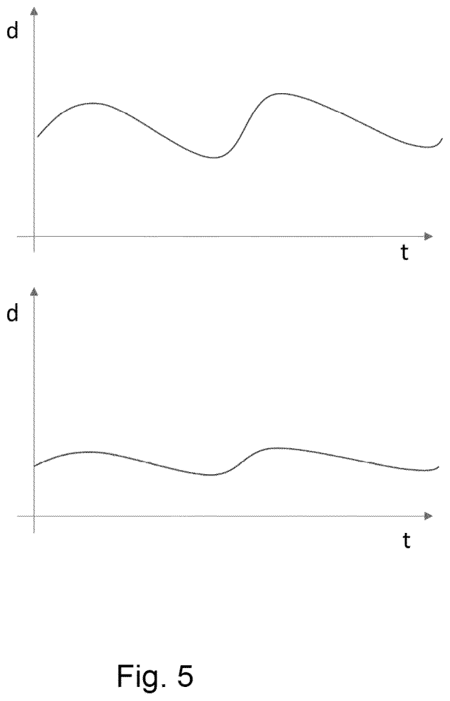

In an example, the system and functionalities described in solution #8 in TR 23.700-87 may be extended to support at least some of the embodiments described above. Figure 6.8.2-1 in TR 23.700-87 describes a communication flow between two UEs including three procedures: (1) IMS multimedia telephony call; (2) bootstrap Data Channel (DC) establishment; and (3) application DC establishment.

In a further example, the system and functionalities in solution #9 in TR 23.700-87 may be extended to support at least some of the embodiments described above. Figure 6.9.2.2-1 in TR 23.700-87 describes a communication flow between two UEs with a network rendering process in which an AR media processing network function (ARMF) is responsible for AR communication media transmission and media rendering function, including the functions of an AR rendering logic that controls an application-based rendering logic of AR communication, and AR media processing function including a vision engine and a 3D rendering engine, which may establish a spatial map and render the scenes, virtual human models and 3D object models according to the field of view, posture, position, etc. which are transmitted from UE using data channel. Different embodiments may be combined with each other or may be used independently as required to address requirements and/or missing capabilities.

The following embodiments are directed to enhanced user and/or device authentication in cellular networks. It is noted that these embodiments can be combined with the previous embodiments described above.

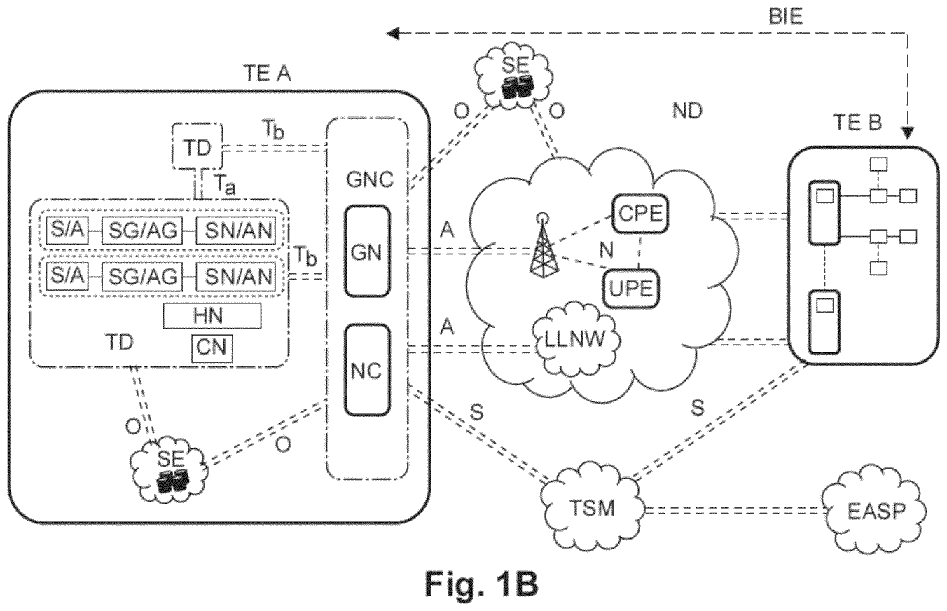

FIG. 2 schematically shows a block diagram of a cellular network involving multiple user equipment devices.

The network architecture of FIG. 2 comprises a first user equipment (UE1) 100, in which first and second (or zero, one or more than two) SIMs 101, 102 are installed. Additionally, a second user equipment (UE2) 103 is provided, in which first and second (or zero, one or more than two) SIMs 104, 105 are installed.

The first and second UEs 100, 103 may comprise respective sensors 126, 127 that may be used for biometric-enhanced authentication/authorization.

A communication interface 120 is configured to allow direct communication between the first and second UEs 100, 103, e.g., a PC5 interface in 5G.

Furthermore, the network architecture comprises a radio access network (RAN) 106 with two or more access devices (e.g., gNBs) 107, 108 of a cellular network, wherein the first access device 107 may be configured to serve the first SIM 101 of the first UE 100 (or the first SIM 104 of the second UE 103) and the second access device 108 may be configured to serve the second SIM 102 of the first UE 100 (or the second SIM 105 of the second UE 103. Standard communication interfaces 121, 122 (e.g., Uu interfaces in 5G) are provided between the RAN 106 and the first and second UEs 100, 103.

Additionally, a first core network 109 of the cellular network comprises network functions 110 to 113, e.g., an access and mobility management function (AMF), an authentication server function (AUSF), a unified data repository (UDR), an AKMA anchor function AAnF, a network exposure function (NEF), a location management function (LMF), and the like.

Moreover, a second core network 114 of the cellular network is provided, which comprises network functions 115 to 118, e.g., an access and mobility management function (AMF), an authentication server function (AUSF), a unified data repository (UDR), an AKMA anchor function (AAnF), a network exposure function (NEF), a location management function (LMF), and the like.

Further, an application function (AF) 119 is provided, which is a control plane function that provides application services to subscribers, e.g., for video streaming service. If the AF 119 is trusted, it can interact directly with above core network functions or if it is a third party, then it could interact with an NEF.

In addition, the network architecture of FIG. 2 comprises a different type of device 123 (e.g., an unmanned aerial vehicle (UAV) such as a satellite) that is configured to provide connectivity to one or more UEs, e.g., the first UE 100 and/or the second UE 103. The different type of device 123 may be configured to use a different type of RAT, wherein a first communication interface 124 is provided between the RAN 106 or a local gateway towards the different type of device 123. Furthermore, a second communication interface 125 is provided between the different type of device 123 and the first UE 100.

In an embodiment, both first and second UEs 100 and 103 may be present, wherein the first UE 100 includes its first SIM 101 and the second UE 103 includes its first SIM 104, and both SIMs 101, 104 are associated to the same or different networks.

Additionally or alternatively, embodiments may be provided, in which the first UE 100 comprises both SIMs 101 and 102.

The SIMS 101, 102, 104, 105 may be physical SIMs or eSIMs that may be installed in an embedded universal smart circuit card (USCC). An eSIM is an industry-standard digital SIM that allows to activate a mobile plan from a network provider without having to use a physical SIM. Given the above system architecture of FIG. 2, different embodiments are proposed to improve authentication and authorization procedures in cellular networks for different scenarios.

### Scenario 1: Optimized Primary Authentication Over Multiple Networks and/or for Multiple UEs

In a first scenario that relates to optimized primary authentication over multiple networks and/or for multiple UEs, a UE may have zero, one or multiple SIMs and it is desired to optimize the network access/primary authentication procedure. In a further scenario, it is further desired to optimize network access/primary authentication based on two or more UEs (where zero, one, two or more SIMs are installed in the UEs).

Network access is a process that allows a UE to connect to the radio access network (RAN) and core network. Primary authentication/network access is a process that allows a UE to connect to the network, establish a security context, and authenticate. Such a primary authentication process is, e.g., described in 3GPP specification TS 33.501.

In an embodiment, the first and second UEs 100, 103 that may use SIMs 101 and 104, respectively, may perform a step of connecting to the RAN 106 (network access). The first and second UEs 100, 103 may then require to receive a Master Information Block (MIB) and/or a System Information Block (SIB) as broadcasted by the RAN 106 and perform a random access procedure (e.g., a sequence of processes between the UEs 100, 103 and one of the access devices (e.g., gNBs) 107, 108 of the RAN 106 to acquire uplink synchronization and obtain a specific ID for radio access communications). The MIB carries information about reference subcarrier spacing, control channel for SIB PDSCH, DMRS position etc. and the SIB carries basic information for the UEs to perform the initial attachment procedure at least up to the RRC setup. Furthermore, the SIB may also carry scheduling information for other SIBs. Further details may be gathered from 3 GPP 38.331 (5.2 System information).

The first and second UEs 100, 103 may however not be aware in an initial step that they are bound together, and thus, in an initial process, the first and second UEs 100, 103 may both perform the network access/primary authentication procedure independently of each other. The first and second UEs 100, 103 may connect to the same core network (e.g., the first core network 109). In this case, the core network may store configuration information stating that both UEs 100, 103 are bound to each other, e.g., in the UDM/UDR, PCF, or in any other network function in charge of keeping track of subscriptions/policies. Examples of devices that may be bound together are phone and smartwatch, phone and tracker, phone and smartwatch and AR/VR glasses, etc. This configuration information may have been or be stored as a part of the user subscription. The storage of this configuration information may be triggered by an AF (e.g., the AF 119). This configuration information may be inferred by the network through the authentication response of at least one of the UEs (e.g., the first UE 100 and/or the second UE 103), which could indicate that they are paired. Upon successful primary authentication, the core network (e.g., first core network 109) may then store the configuration information in the UEs, e.g., in their SIMs, indicating that they are bounded/coupled. This configuration information may indicate that subsequent network access and/or network registration and/or primary authentication procedures can be performed in a combined manner, if possible.

In an embodiment variant, the first and second UEs 100, 103 may disconnect and reattempt connecting to the RAN 106. In this case, the first and second UEs 100, 103 may store the configuration information indicated in the previous embodiment, and thus, before attempting to perform the network access/primary authentication independently of each other, the first and second UEs 100, 103 may search each other, and if found, they may choose one of them as master/coordinator in charge of coordinating (e.g., (dis)aggregating) the network access/primary authentication messages for the disconnecting or connecting procedure.

In a further embodiment variant, the choice of the master/coordinator may have been done in an initial step by the core network (e.g., first core network 109) and stored in the first and second UEs 100, 103.

In a further embodiment variant, the first and second UEs 100, 103 may discover each other over a local communication interface such as the PC5 interface, e.g., the master/coordinator (e.g., the first UE 100) may broadcast its presence, e.g., by means of discovery messages similar to, e.g., Step 1 in Clause 6.3.3.3.2 in TS 33.503. In a following step, the other UE (e.g., the second UE 103) may reply with its initial network access message, e.g., encapsulated/transported in a direct communication request (DCR) message. The following steps may be such that the master/coordinator (first UE 100) combines the initial network access message received from the second UE 103 and its own network access message in a combined network access message for both UEs (first UE 100 and second UE 103).

In a further embodiment variant, the second UE 103 may not be a user equipment or may not have a SIM, but it may just be a device (e.g., smart watch or the like) bound to the first UE 100. The presence of the second UE 103 or measurements by the second UE 103 may be used to improve the authentication procedure of the first UE 100 (and the second UE 103). For example, the second UE 103 may perform measurements of the radio environment and send them to the first UE 100, which may use them to adjust its transmit power and/or select a suitable carrier frequency. Alternatively, the second UE 103 may send a signal to the first UE 100 to indicate that it is in proximity and that the first UE 100 can initiate the network access/primary authentication procedure. The first UE 100 may then use the identity of the second UE 103 or a derived value as part of its network access message, e.g., as a device group identifier. The core network (e.g., first core network) 109 may verify the binding between the first UE 100 and the second UE 103 based on the received information and may grant or deny the network access/primary authentication for the first UE 100 accordingly.

In a further embodiment variant, the network access/primary authentication of the bound first and second UEs 100, 103 may only be successful if the/all individual primary authentication(s) succeed.

In another embodiment variant, the first UE 100 may have the two SIMs 101 and 102 available and may perform a combined network access/primary authentication procedure.

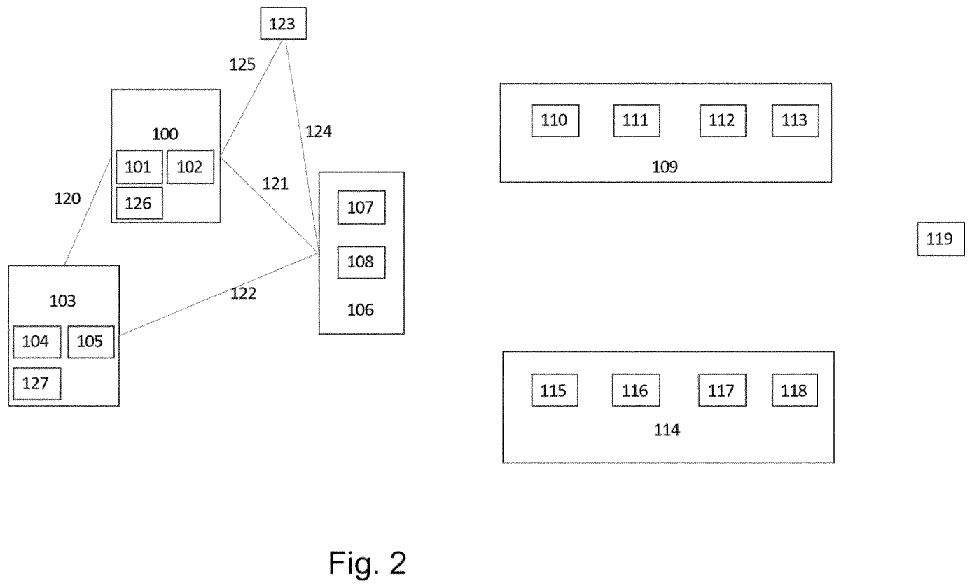

FIG. 3 schematically shows a procedure of an enhanced primary authentication procedure involving multiple user equipment devices. The exemplary procedure of FIG. 3 may be used in the previously described embodiments and their variants. The system entities involved in FIG. 3 are those described in connection with FIG. 2 and the following messages may be used, wherein not all steps may always be required and/or some steps may be performed in a different order or more than once. The diagram of FIG. 3 indicates the involved network entities (i.e., the second UE 103, the first UE 100, the RAN 106 and the first core network 109) at the top, wherein the arrows below indicate successive message flows in time-dependent order with time passing from the top to the bottom of FIG. 3.

In step 200, the RAN 106 distributes synchronization signals, e.g., MIB/SIB, which are received by the first UE 100 and/or the second UE 103.

In step 201, the first UE 100 distributes communication beacons (e.g., PC5 synchronization signals) that are received by the second UE 103 to establish a communication link (e.g., 3GPP based, Wi-Fi based, Bluetooth based, etc).

In step 202, the first UE 100 performs a random-access procedure with the RAN 106.

In step 203, the first and second UEs 100, 103 discover each other over the communication interface (e.g., PC5 discovery).

In step 204, the second UE 103 provides information for network access to the first UE 100 over the communication interface, e.g., PC5 interface, e.g., in a direct communication request. In particular, this may include contents of the 5G Registration Request (e.g., RRCSetupComplete message) including Registration Type, 5G-Guti, Last TAI, Requested NSSAI, UE capabilities, List of PDU sessions). This may include the contents for a registration request of a more resource-constraint device such as an (ambient) IoT device.

In step 205, the first UE 100 sends a similar network access request including its own information and the information received from the second UE 103 in previous step 203.

In step 206, the RAN 106 sends a message towards the first core network 109 for the registration request and/or authentication request etc.

In step 207, the first core network 109 replies to the registration request of the RAN 106 with (an) aggregated authentication request(s).

In step 208, the aggregated NAS authentication request(s) (e.g., an NAS Authentication Request) including the information of the NAS authentication request messages for both first UE 100 and second UE 103 are forwarded by the RAN 106 to the first UE 100.

In step 209, that the first UE 100 sends the contents of the NAS authentication request to the second UE 103 e.g. over the PC5 interface. Note that the first UE 100 may not just forward in step 208 but may first extract its own part of the NAS authentication request and may then only forward the part of the NAS authentication request addressed to the second UE 103.

In step 210, that the second UE 103 extracts and checks sequence number (SQN) and message authentication code (MAC); if successful, the second UE 103 computes RES*2 and sends the content of the NAS authentication response, i.e., RES*2 to the first UE 100 over the PC5 interface.

In step 211, the first UE 100 aggregates the authentication responses (own information and data from the second UE 103 as received in step 210) and sends the content of the aggregated NAS authentication response (RES* and RES*2) to the RAN 106.

In step 212, the RAN 106 forwards the message received in step 211 to the first core network 109 so that the first core network 109 can check the UE's NAS authentication responses and authenticate both first and second UEs 100, 103.

In step 213, the first core network 109 confirms to the RAN 106 that the authentication procedure for the first and second UEs 100, 103 was successful. If so, the RAN 106 can allocate at this state RAN identifiers associated to the first and second UEs 100, 103 and can derive the AS security context.

An advantage of the message flow described in FIG. 3 is that it reduces the signaling required by the RAN 106, e.g., to perform the random-access procedure, as well as, the number of interactions with the first core network 109 when performing the initial authentication of devices.

In a variant of the embodiment of FIG. 3, step 202 may comprise information about the UEs, number of UEs, or type of UEs that are performing a joint random access procedure.

In a further variant of the embodiment of FIG. 3, step 203 may be performed prior to step 202.

In a still further variant of the embodiment of FIG. 3, the RAN 106 may allocate a RAN identifier to the first and second UEs 100, 103 performing a joint RACH.

In a still further variant of the embodiment of FIG. 3, the steps related to the joint random-access procedure may be used independently of the steps related to the joint multiple authentication/authorization procedure.

The procedure described in FIG. 3 performs the primary authentication of the first UE 100 and the second UE 103 independently of each other. This means that even if the primary authentication of the second UE 103 fails, the primary authentication of the first UE 100 may still succeed and the first UE 100 may successfully connect to the network. However, in such a case, the device (first UE, second UE or a device combining both the first and second UE) may only get access to a subset of services and/or applications and/or a reduced QoS.

FIG. 6 schematically shows a procedure of an enhanced authentication procedure in a metaverse application.

The exemplary procedure of FIG. 6 for a combined authentication for multiple UEs may be useful to reduce overhead and/or in cases in which all involved UEs need to be present to be accepted in the network. The exemplary procedure of FIG. 6 may be used in the previously described embodiments and their variants. Similar to FIG. 3, the involved system entities are those described in FIG. 2 and the following messages are used, wherein not all steps may be required and/or some steps may be performed more than once and/or in a different order. The diagram of FIG. 6 indicates the involved network entities (i.e., the second UE 103, the first UE 100, the RAN 106 and the first core network 109) at the top, wherein the arrows below indicate successive message flows in time-dependent order with time passing from the top to the bottom of FIG. 6.

In step 600, UEs (e.g., the first UE 100 and the second UE 103) establish or have already established a (secure) communication link (e.g., PC5 link).

In another step 601, the RAN 106 broadcasts synchronization signals, comprising e.g., MIB/SIB, which are received by the first UE 100 and optionally the second UE 103.

In another step 602, that the first UE 100 performs a random-access procedure with the RAN 106, taking into account the other UEs (e.g., the second UE 103) which require RAN identifiers (e.g., a cell radio network temporary identifier (such as C-RNTI)) or network access. In other words, this random-access procedure may indicate that it is a combined random-access procedure for more than a single UE.

In another step 603, the first UE 100 may assign identifiers, e. g, temporary identifiers, to the other UEs (e.g., the second UE 103), and may request information required for the registration request (e.g., SUCI derived from SUPI, a globally unique temporary identifier (such as 5G-GUTI), security capabilities, registration type, etc). Such temporary identifiers may be used as a mapping for information that is forwarded between the second UE 103 and the first CN 109 or the AF 119. Alternatively, these temporary identifiers may be based on an identifier for the second UE 103, e.g., a layer 2 identity (L2 ID). The request from the first UE 100 to the second UE 103 may include information related to the PLMN/NPN (e.g. PLMN ID or in case of SNPN: PLMN ID+NID) as broadcasted by the RAN 106, and/or may include information related to which PLMN/NPN the first UE 100 is subscribed.

In another step 604, the second UE 103 provides the first UE 100 with the requested information for a registration request, e.g., the 5G registration request. For example, the information provided by the second UE 103 to the first UE 100 may include a SUCI of the second UE 103 and/or may include information related to which PLMN/NPN the first UE 100 is subscribed. It may also comprise information required for an application layer registration request that the first UE 100 may need to forward to provide access to the second UE 103. It may also comprise uplink information that needs to be transmitted by the first UE 100 on behalf of the second UE 103 (e.g. sensor data, location information, transparent payload) to the network.

In another step 605, the first UE 100 bundles the registration request information from the second UE 103 with its own and sends it to the RAN 106, while indicating which identifiers correspond to which UE.

In another step 606, the RAN 106 forwards the registration request to the serving network (SN) (e.g., the AMF of the first CN 109), which, if required, may send a non-access stratum (NAS) identity request to retrieve the identity of one or more UEs. The UEs may have agreed on a master/coordinator (e.g., the first UE 100) to aggregate and send subscription concealed identifiers (SUCIs). The SUCI-based approach prevents direct and unprotected transmission of the international mobile subscriber identity (IMSI) to protect the anonymity of the end user. Each other UE (e.g., the second UE 103) conceals its subscription permanent identifier (SUPI) and transmits it to the first UE 100, which then aggregates SUCIs based on the home network identifier (e.g., if the first SIMs 104, 101 of the first and second UEs 100, 103 correspond to the same public land mobile network (PLMN), they are bundled together). Once received, the AMF forwards the identities and serving network's name to the corresponding unified data management entities (UDM(s)) to trigger primary authentication(s). The UDM is configured to manage network user data in a single, centralized element. It can be paired with a UDR that stores user data such as customer profile information, customer authentication information, and encryption keys for the information. The UDM may reside on the control plane and may utilize microservices to communicate between the user plane and the control plane.

In another step 607, the first CN 109 (e.g., the UDM) de-conceals the SUCIs and retrieves the permanent keys which correspond to the SUPIs retrieved. The UDM then generates a multi-UE authentication vector taking into account the identity of the master/coordinator (e.g., the first UE 100) which will perform the verification e.g., of authentication token (AUTN), MAC, and expected result (XRES*), which may be computed based on the master UE's (e.g., the first UE 100) permanent key K, and subsequent keys derived from it (i.e., anonymity kex (AK), integrity key (IK), and cipher key (CK)). To achieve this, an authentication management field (AMF), K, SQN and random challenge (RAND) values may be fed into an algorithm (e.g., Milenage algorithm) which generates responses for AUTN, AK, CK, IK and XRES*.

To ensure the other UEs (e.g., the second UE 103) are also authenticated, XRES* takes into consideration the XRES(s) computed based on the other UEs permanent keys, such that XRES* is computed as a cryptographic function that depends on XRES of the different UEs, e.g. as:
XRES*=KDF (CKm∥IKm, SNN∥SQN⊕XRESm⊕XRES2⊕XRES3 . . . XRESi). In the example, XRES*=KDF (CKm∥IKm, SNN∥SQN⊕XRESm⊕XRES2), where XRES2 corresponds to the second UE 103; or
XRES*=KDF (CKm∥IKm, SNN∥SQNm+XRESm |SQN2 +XRES2 |. |SQNi XRESi). In the example, XRES* =KDF (CKm|IKm, SNN|SQN⊕XRESm∥SQN2⊕XRES2), where SQN2 and XRES2 corresponds to the second UE 103.

In another step 608, the first CN 109 generates the authentication vector and sends a NAS authentication request to the first UE 100 through the SN and RAN 106.

In another step 609, the first UE 100 verifies the authentication vector (e.g., checks MAC and SQN), and if successful, sends the parameters (e.g., RAND, AUTNi), required to compute RES(s) and verify the authentication vector, to the other UEs (e.g., the second UE 103).

In another step 610, each UE computes RES using its permanent key and sends the result back to the master/coordinator UE (e.g., the first UE 100), which computes RES* similarly to the first CN 109 in step 307 of FIG. 3 (i.e., in this example: RES*=KDF (CKm∥IKm, SNN∥SQN⊕RESm RES2) or RES*=KDF (CKm∥IKm, SNN∥SQN⊕RESm∥SQN2⊕RES2)).

Note that in the first option, the CN is authenticated solely by the master/coordinator UE (e.g., the first UE 100) and hence the authentication vector includes only one AUTN (and subsequently, one SQN/MAC). In the second option, the CN is authenticated by all UEs, which entails that the CN sends an authentication vector containing an AUTNs container that includes X-number of AUTNs, where X is the number of UEs to be authenticated (e.g., two AUTNs in the example, for the first UE 100 and the second UE 103). Each UE (e.g., ith UE) extracts SQNi, computes and verifies MACi, and, if successful, computes SQNi⊕XRESi and sends the result to the master/coordinator UE to compute a combined RES*, e.g., RES*=KDF (CKm∥IKm, SNN∥SQNm⊕RESm∥SQN2⊕RES2).

In another step 611, the first UE 100 sends the NAS authentication response (i.e., RES*) to the RAN 106.

In another step 612, the RAN 106 forwards the NAS authentication response to the SN which computes and verifies HRES *=SHA256(RAND∥RES*) against HXRES*=SHA256(RAND∥XRES*) received from the AUSF, and deems the multi-UE authentication successful from the SN's point of view if they match. It then forwards RES* to the AUSF of the first CN 109 which compares it to XRES*, deeming the multi-UE authentication successful from the CN's point of view if they match.

An advantage of the procedure/message flow described in FIG. 6 is that it reduces the signaling messages required by the RAN 106 and the first CN 109 to perform primary authentication for multiple UEs by leveraging the credentials of a master/coordinator UE (e.g., the first UE 100) to authenticate the network, and combine message authentication codes computed by all UEs requiring authentication to produce one authentication response. Another advantage is that UEs do not have to share or disclose any of their permanent keys, while also establishing separate security contexts, one each.

In a related embodiment variant, the procedure described related to FIG. 6 may be performed as default, and only if it fails, the procedure described related to FIG. 3 may be performed. This may be done based on a policy configured in the first UE 100.

In reference to FIG. 3, it is to be noted that in the above procedures, the first UE 100 may receive synchronization signals and system information (e.g., in step 200) from one or multiple access devices. The first UE 100 may then perform a selection of the access device (e.g., RAN 106). In an additional embodiment that may be combined with other embodiments or used independent, the first UE 100 may perform the selection of the access device (e.g., RAN 106) on behalf of the second UE 103 wherein the first UE 100 may announce, e.g., in step 201 or 203, the selected access device as well as measurements performed when making this selection. This information may be used by the second UE 103 to determine whether to further connect to the RAN 106 through the first UE 100 or directly. This information may also be used by the second UE 103 to acquire synchronization signals and/or system information of the RAN 106 in a better way (e.g., faster or more efficiently because the timing of the signals is known).

In a related embodiment that may be combined with other embodiments or used independently, the registration request may combine the SUCIs/GUTIs of two or more UEs (SIMs) as described in Step 605 of FIG. 6, but the primary authentication procedures may be performed independently of each other as in FIG. 3.

In a related embodiment that may be combined with other embodiments or used independently, it is to be noted that UE 100 contains two SIMs 101 and 102. Thus, the procedure in FIG. 3 and FIG. 6 may be performed a similar way for UE 100 and its two SIMs. In particular, UE 100 may be a DualSteer device as per the definition in TS 22.841 comprising two “UEs” allowing for simultaneous data transmission over two networks or RATs or a single UE in case of non-simultaneous data transmission over two networks. A SIM contains the credentials of a user including the user identity (e.g., a subscription permanent identifier (SUPI)) or other keys used to perform primary authentication according to TS 31.102. The SIMs of a UE may belong to a same core network or to two different core networks. Thus, a single random-access procedure may be performed for both SIMs and a joint primary authentication procedure may be performed for both SIMs.

In a related embodiment that may be combined with other embodiments or used independently, UE 100 may request SIM 101 and/or SIM 102 through local communication interface to provide user identification (e.g., SUCIs or SUPIs or GUTI). UE 100 may compute SUCIs from SUPI when needed or required according to policy, UE 100 may aggregate the user identification and sends registration request including said combined user identification that may trigger combined or separate primary authentication procedures.

In a related embodiment that may be combined with other embodiments or used independently, upon reception of a registration request with two or more sets of user identification (e.g., two SUCIs), the core network (e.g., home network) may decrypt them obtaining the SUPIs. The core network may then evaluate whether the registration request is allowed for a DualSteer device. This end, the core network may check whether the user subscription associated with said SUPIs allows the usage of a DualSteer connection. For instance, the core network may check whether the first user subscription associated to the first SUPI may allow for it, but the second user subscription may not allow for it. For instance, the core network may only allow a DualSteer connection if both subscriptions allow for it.

In existing specifications, during registration if AMF does not have a mapping between 5G-GUTI and SUPI, the AMF sends an Identity Request to the UE. However, the IDENTITY REQUEST message lacks any indication that could help a Dual Steer device determine for which SIM the identity request corresponds. Thus, in a related embodiment that may be combined with other embodiments or used independently, in order to perform a mapping between 5G-GUTI and SUPI in case of a DualSteer device with two SIMs, if the UE indicates or the AMF determines (e.g. based on subscription data) that the UE supports DualSteer, the AMF transmits an identity request message that includes an indication of the identity that it is requested or indication of the SIM for which the identity is requested, this may be, e.g., the position/index of the GUTI/SUCI in the registration request (e.g. in case for both SIMs an identity is included in the registration request), an identity of the SIM (e.g.

first/primary SIM or second/secondary SIM, or other identity assigned to SIM), or an indication of the order of the registration requests in relation to the SIM that is used for the registration request (e.g. first/primary registration or second/secondary registration), or it may include (part of) the GUTI itself or a function thereof.

### Scenario 2: Ambient IoT

In a second scenario that relates to supported authentication and communication of an ambient IoT device, the second UE 103 represents an IoT device such as a low power and/or low capability ambient IoT device trying to connect to the network. Connecting to the network may require several steps such as performing a kind of authentication, getting a network identity, sending some collected data, or receiving some data. This may be a challenging task given the potentially low resource capabilities of ambient IoT devices. At the same time, users may carry one or multiple IoT devices such as the second UE 103 and the combination of IoT devices carried by a user may be leveraged for the identification and authentication of the user. Here a key question is how to enable the identification and authentication of an ambient IoT device, and in general, the data exchanges.

In general, recall that there may be different types/classes of ambient IoT devices with very different capabilities and resources as described in TR 38.848 or TR 22.840, namely, Class A with backscattering capabilities and no energy storage means, Class B with backscattering capabilities and some energy storage means, and Class C with the capability of actively transmitting. Recall as well that ambient IoT devices may communicate in different communication topologies, e.g., direct communication between ambient IoT device and access device, or communication with ambient IoT tag enabled/through a UE. For instance, in reference to FIG. 2 an access device 106 may directly interact with an ambient IoT device 103 via link 122. Additionally or alternatively, access device 106 may use UE 100 to facilitate communication with UE (ambient IoT device) 103. For instance, in communication topology 2, the access device may use UE 100 as intermediate node and the intermediate node interacts/communicates with the ambient IoT device. For instance, in communication topology 3, the access device may send a request to 103 via link 122 and the ambient IoT device 103 backscatters its reply. The backscattered signal is received by UE 100. Access device 106 or UE 100 may act as a reader enabling communication to/from ambient IoT tags as described in TR 23.700-13.

In a variant of the previous embodiments related to FIG. 3, that may be combined with other embodiments or used independently, the second UE 103 represents an IoT device such as a low power and/or low capability ambient IoT device, e.g., as described in TR 38.848 or TR 22.840. In this case, the first UE 100 may facilitate the connection procedure by performing an initial protocol, such as, e.g., the random-access procedure, on behalf of the second UE 103 and/or forwarding authentication data and/or application data. The first UE 100 may distribute a signal (e.g., synchronization signals, a wake-up signal etc.) that indicates its capability to forward data of an ambient IoT device (e.g., the second UE 103). This signal may be a sidelink synchronization signal or a signal designed to wake up the device. This capability may be enabled by the network or by the user based on configuration or a policy. When the second UE 103 receives such a signal, it may exchange data with the first UE 100 that forwards it towards the first CN 109 or the AF 119.

In a variant of the previous embodiment related to FIG. 3, that may be used independently, the first UE 100 may facilitate the access of the second UE 103 to the network, wherein the first UE 100 may exchange data from/with the second UE 103 as in a container (e.g., data container). This data included/transported in the (data) container may be related to authentication data of the second UE 103 as required for the authentication of the second UE 103. This data may be application data of the second UE 103, e.g., once the second UE 103 has been authenticated. This allows using a generic approach capable of serving many different IoT applications and different types of ambient IoT devices that due to their inherently different capabilities may need different types of communication protocols such as different types of authentication procedures. Using a container-based approach may allow using different communication protocols, e.g., authentication procedures, wherein the protocol specific parameters are carried within generic containers. In other words, the technical standard defines some fields or containers that may be used by applications to transport specific (security related) data where the data may be used to perform a security protocol or achieve a given security property, e.g., tag identification or authentication.

In another variant of the previous embodiment related to FIG. 3, that may be used independently, the second UE 103 may represent an IoT device such as a low power and/or low capability ambient IoT device that needs to obtain a RAN identity to access the network. In this case, the first UE 100 may assist the RAN identity acquisition by performing the random-access procedure on behalf of the second UE 103 and/or relaying the RAN identity from the network to the second UE 103. The first UE 100 may broadcast a signal (e.g., synchronization signals) that indicates its ability to assist the RAN identity acquisition of an ambient IoT device (e.g., the second UE 103). This ability may be enabled by the network or by the user based on configuration or a policy. When the second UE 103 receives such a signal or based on a policy configured at the second UE (e.g. policy that provides an association between identity of a reader or type of reader with a set of capabilities), it may establish a link with the first UE 100 and may request a RAN identity. Upon receiving a request for a RAN identity from the second UE 103 or upon receiving a message/trigger from the network (e.g. Core Network or RAN) to communicate with the ambient IoT device (e.g. to perform inventory or send a command) or based on a policy configured at the second UE (e.g. when it meets certain conditions, such as being at a certain location which may be near a known ambient IoT device), the first UE 100 then performs the random-access procedure with the network and receives a RAN identity for the second UE 103. The first UE 100 then sends the RAN identity to the second UE 103, which uses it to transmit data to the network. The network may also use the allocated RAN identity to communicate with the second UE 103 at a later stage.

In a variant of the previous embodiments related to FIG. 6, that may be combined with other embodiments or used independently, the first UE 100 may be a UE acting as a reader/intermediate device to communicate with an ambient IoT device, and the second UE 103 may be an ambient IoT device, whereby all steps in the procedure illustrated by FIG. 6 may be optional, and whereby in step 600 the first UE 100 and second UE may communicate using backscattering and may use simplified communication protocols as described in other embodiments, and whereby in step 602 the first UE 100 may request a RAN identity for the second UE as per the previous embodiment.

In a further variant of the previous embodiments related to FIG. 6, that may be combined with other embodiments or used independently, the first UE 100 may be a UE acting as a reader/intermediate device to communicate with an ambient IoT device, and the second UE 103 may be an ambient IoT device, whereby all steps in the procedure illustrated by FIG. 6 may be optional, and whereby:
in step 600 the first UE 100 and second UE may communicate using backscattering and may use simplified communication protocols as described in other embodiments
in step 602 the first UE 100 may perform random access procedure and perform network registration procedure with RAN entity 106 and may perform PDU session establishment with the first core network 109. After the first UE 100 is registered, it may also request a RAN identity for the second UE as per the previous embodiment. It may also provide this identity to the second UE.
in an intermediate step 602b between step 602 and step 603, the first UE 100 may receive information about the second UE 103 (e.g. message from the first core network or RAN node to include a request to initiate communication with the second UE 103 (e.g. paging of the ambient IoT device or request to perform inventory of ambient IoT devices), whereby such request may include identity information, security related information, application specific information (e.g. command to be executed as requested by an AF) or other information (e.g. PLMN ID of the PLMN to which the second UE is subscribed) related to the second UE 103.
in step 603 temporary identifiers may be determined based on the information received about the second UE 103 in the intermediate step 602b.
in step 605, the first UE 100 may perform a registration procedure on behalf of the second UE 103 whereby it may include the (identification) information received from the second UE (e.g. SUCI, or a pseudo identifier). Additionally or alternatively, the first UE 100 may perform registration on behalf of the second UE 103 and/or may forward a message from the second UE 103, whereby it may include identity information related to the second UE 103 as received in the intermediate step 602b and/or whereby the first UE 100 may generate a SUCI by using the identity information related to the second UE 103 as received in the intermediate step 602b or identity information from the second UE 103 received in step 604 as input for generating the SUCI. Additionally or alternatively, the first UE 100 generates the SUCI partially based on information common to both the first UE 100 and second UE 103 (e.g. serving PLMN) and/or information received about the second UE 103 in intermediate step 602b and/or information received from the second UE. For example, the first UE 100 may include the Home Network Identifier as part of the SUCI based on the Home Network Identifier that it uses itself and/or include the SUPI type as part of the SUCI based on information received about the SUPI type in intermediate step 602b and/or include the ‘scheme output’ as part of the SUCI based on information received from the second UE 103 and/or add the ⊕realm part of the NAI that it uses itself or received in step 602b in case the SUCI in NAI format needs to be transmitted to the network.
in steps 609 and 610, the first UE 100 may perform computing of the RES on behalf of the second UE 103 by using the security related information that it may have received in the intermediate step 602b. The RES* that will be calculated in step 610 and transmitted to the network in step 611 may only be based on the RES that is computed on behalf of the second UE 103 (i.e. not related to the RES computed on behalf of the first UE since the first UE may already be registered to the network in step 602). If during these or other steps a NAS Security Mode Command message is received by the first UE and/or an (updated) NAS security context for the second UE is created by the first UE and/or a new KAMF is derived by the first UE (e.g. following the procedure in clause 6.7.2 of 3GPP TS 33.501), then the first UE may transmit the received NAS Security Mode Command message and/or information about the (updated) NAS security context and/or new KAMF to the second UE, which may use it to store/determine its own NAS security context and use it to protect subsequent communication with the network. The related message between the first UE and second UE may be protected based on a set of keys preconfigured or provisioned on the first UE and second UE for ambient IoT communication (e.g. as described in other embodiments). Additionally or alternatively, the first UE may send a message (e.g. NAS message using its own NAS security keys/context) to the CN or AF including information about the (updated) NAS security context of the second UE and/or new KAMF of the second UE with a request to encrypt and/or otherwise protect this information using CN or AF related keys, after which the CN or AF may respond with a message that includes the information in encrypted/protected form, which the first UE may then forward/transmit to the second UE.
In an additional step 613 the first UE 100 may receive a message (e.g. Registration Accept NAS message) from the AMF that may include a (temporal) identifier (e.g., 5G-GUTI) related to the second UE 103. The first UE 100 may store the 5G-GUTI related to the second UE 103 and/or transmit a message that includes the 5G-GUTI (or part thereof, e.g. x number of bits or e.g. only the part of the 5G-GUTI that uniquely identifies the UE within the AMF(s) that allocated the 5G-GUTI) to the second UE 103 (that the second UE may use in subsequent messages to the first UE 100 or to RAN node 106 or other UE/RAN reader), optionally including an expected lifetime of the 5G-GUTI indicating how long the 5G-GUTI is expected to be valid if no subsequent messages are transmitted by the second UE and/or transmitted on behalf of the second UE 103 or directly between the second UE and a RAN node 106, and/or before an updated 5G-GUTI is received or needs to be received or is expected to be received and/or indicating how long it is expected to take before the first UE 100 will deregister or will be deregistered from the network or before the first UE 100 is expected to deregister the second UE 103 from the network or before the second UE 103 is expected to be deregistered from the network. Additionally or alternatively, the first UE 100 will store a mapping between 5G-GUTI of the second UE 103 and a local temporary identifier (which may be based on a part of the 5G-GUTI (e.g. x number of bits) or separate value) the first UE uses to communicate with the second UE 103. For instance, it may be mapping between a short identifier exchanged over the air between the first UE 100 and the second UE 103 and further identification information, e.g., application ID, network function ID, PLMN ID, device metadata, etc. This example may be applicable to other steps even if not mentioned explicitly.
In an additional step 614, the first UE 100 may include the 5G-GUTI that it stored for the second UE 103 or the 5G-GUTI (or part thereof and based on which the first UE will construct the complete 5G-GUTI by adding the missing bits) that it may request and/or receive from the second UE (e.g. using similar procedure as in steps 603 and 604) or that corresponds to the mapping between a local temporary identifier used by the second UE in its communication with the first UE and a 5G-GUTI stored for the second UE in subsequent transmission to the network of uplink information received from the second UE 103 and/or transmitted on behalf of the second UE 103 (e.g. sensor data, location information, transparent payload). Additionally or alternatively, the first UE 100 generates the 5G-GUTI partially based on information common to both the first UE 100 and second UE 103 and/or information received about the second UE 103 in intermediate step 602b and/or information received from the second UE. For example, the first UE 100 may include as part of the 5G-GUTI the part of the 5G-GUTI that identifies the AMF(s) which allocated the 5G-GUTI) based on the AMF to which it is registered itself and/or information received about the AMF received in intermediate step 602b or extracted from the received 5G-GUTI value received in step 613, and/or include as part of the 5G-GUTI the part of the 5G-GUTI that uniquely identifies the UE within the AMF(s) that allocated the 5G-GUTI based on information received from the second UE 103. The AMF may include an updated 5G-GUTI for the second UE in the subsequent/response message to the first UE 100, which the first UE 100 may store and/or transmit to the second UE 103 as in step 613, after which step 614 can be repeated again.

The benefits of these steps, in particular step 614, are that this allows the AMF to easily find the UE context information related to the second UE 103 and allows the network to accept the uplink data received from the second UE 103 without having to perform a full (primary) authentication procedure again, and that it allows to reuse the same identifiers (e.g. 5G-GUTI and SUCI) to identify the ambient IoT device (i.e. second UE 103) and use the same related NAS procedures without the second UE 103 having to fully support NAS. It also may reduce the traffic between the first and second UE, since the first UE can perform certain actions on behalf of the second UE, which is important if the second UE is a very low power IoT device such as Ambient IoT device which may not always be reachable or have sufficient energy to transmit messages.

Additionally or alternatively, based on the lifetime information related to the 5G-GUTI the first UE 100 may include a SUCI related to the second UE 103 instead of the 5G-GUTI in a subsequent message to the network (e.g. if the time between such subsequent message and previous message took very long, e.g. beyond the lifetime information related to the 5G-GUTI). In an option, the SUCI is generated by the first UE given a plaintext ID provided by the second UE. In another option, the second UE may provide the encrypted part of its long-term unique identifier and the first UE may complete it to form a standard SUCI. In a further option, an ambient IoT device may lack the resources to perform certain operations (e.g., public key encryption), and the encrypted identifier may be encrypted using a different ciphering algorithm, e.g., a symmetric-key encryption algorithm.

Additionally or alternatively, if the first UE 100 was deregistered from the network or moved to a different network since last time it received a (fresh) 5G-GUTI related to the second UE, the first UE 100 may include a SUCI related to the second UE 103 instead of the 5G-GUTI in a subsequent message to the network. Furthermore, if the first UE 100 received a deregistration message related to the second UE 103 from the network, the first UE 100 may include a SUCI related to the second UE 103 instead of the 5G-GUTI or include/create a different SUCI (e.g. based on a different home network public key) or include a different 5G-GUTI (e.g. received from the different network in an earlier message) in a subsequent message to the network.

Additionally or alternatively, if the first UE 100 was deregistered from the network or moved to a different network since last time it received a (fresh) 5G-GUTI related to the second UE or received a deregistration message related to the second UE 103 from the network, then the first UE 100 may send a message to the second UE 103 that includes information about the deregistration and/or information about the PLMN from which it is deregistered and/or include an empty 5G-GUTI and/or indicate that the current 5G-GUTI is not valid anymore and/or indicate that next time a SUCI needs to be used and/or indicate a request for the second UE 103 to provide a SUCI instead of 5G-GUTI in a subsequent message. Additionally or alternatively, the second UE 103 may transmit a SUCI instead of a 5G-GUTI to the first UE 100 or RAN entity 106 (e.g. upon receiving a request similar as in steps 603 and 604) (e.g. if the time between such subsequent message and previous message took very long, e.g. beyond the lifetime information related to the 5G-GUTI). Additionally or alternatively, the second UE 103 transmits a SUCI instead of a 5G-GUTI to the first UE 100 or RAN entity 106, and/or creates/transmits a different SUCI (e.g. based on a different home network public key) or transmits a different 5G-GUTI (e.g. received from the different network in an earlier message), if the PLMN/NPN information as provided by the first UE (e.g. using a message similar as in step 603) indicates that the first UE has moved/registered to a different network (e.g. since last time it received a (fresh) 5G-GUTI).

Additionally or alternatively, between the first UE 100 and second UE 103, a separate security mechanism may be applied to authenticate the second UE with the first UE or vice versa and/or to protect the traffic between the first UE and second UE (e.g. based on a set of keys preconfigured or provisioned on the first UE and second UE for ambient IoT communication, whereby the set of keys may be identified by e.g. an identifier of the first or second UE or group identifier (e.g. to identify group credentials related to a group of trusted devices), e.g. as described in other embodiments). Additionally or alternatively, the first UE may send a message (e.g. NAS message using its own NAS security keys/context) to the CN or AF including information or message or message payload that the first UE needs to send to the second UE, with a request to encrypt and/or otherwise protect this information using CN or AF related keys, after which the CN or AF may respond with a message that includes the information in encrypted/protected form, which the first UE may then forward/transmit to the second UE.

Additionally or alternatively, the first UE 100 in the above procedures may be a RAN node (e.g. RAN node 106) capable of acting as a reader.

In some cases, the second UE 103 may represent an ambient IoT device that needs to authenticate (with) the core network or an application function. Many authentication algorithms may be feasible, e.g., based on symmetric keys, based on public-key cryptography, based on a physically unclonable function, etc., whose contents may be exchanged in a standardized manner in a data container to enable multiple use cases and/or applications and/or device types. Furthermore, certain fields may be required next to the generic containers for communication between the first UE, second UE and/or the RAN/CN/AF since they are applicable to multiple use cases. These fields may include, but are not limited to:
a random number or challenge sent from an access device/UE to a UE that can be used in an authentication procedure;
a random number or response sent from a UE to an access device/UE that can be used in an authentication procedure;
a time value or counter sent from an access device/UE to a UE and that can be used in an authentication procedure or to validate the freshness of the data;
a subsequent value or counter sent from a UE to an access device/UE and that can be used in an authentication procedure or to validate the freshness of the data;
an identity of the access device/UE or authentication service so that the device knows whether it has to react to the message or not;
an identity of a type of device or protocol type so that the access device and/or UE know how to handle the data included in the data container;
an identifier/indication indicating how frequently the device needs to communicate (e.g., once per hour, once per day, once per week, etc.) as well as a slot for communication (e.g., with a predetermined number of bits (e.g., 5 bits), it may indicate the hour of the day, the day of the week, the day of the month, etc., so that it allows to distribute devices in different communication slots to facilitate the communication with many devices);
an identifier/indication indicating the type of supported devices (by the access device) or the type of device (as announced by the device) so that both parties know whether they can communicate with each other, the types of devices may refer to devices of class A, B, or C as in TR 38.848;
an identifier indicating the type of supported communication topology (by the access device) so that devices know whether they can communicate with each other;
an identity of the device or UE.
   As a clarification, authentication service refers to the type of authentication supported by the device, e.g., based on symmetric keys, based on public-key cryptography, based on a physically unclonable function, etc.

The first UE 100 may send an initial message, e.g., an initial synchronization message (e.g., SSBs, or a message including a synchronization preamble) or wake-up signal or SIB, that may include one or more of those fields, e.g., a time value or counter. This first message may also include a data container that may carry protocol specific data, e.g., a data container may include a security challenge as used in an authentication handshake, e.g., based on a symmetric key or a PUF. The second UE 103 may then reply with the container and certain fields (e.g., time value/counter, identity, etc) and potentially a device and/or authentication method type. The reason for including fields such as a device and/or authentication method type field is to allow many different types of ambient IoT UEs and/or authentication methods. Such a type may be indicated explicitly or implicitly in the container itself or in the fields included in the reply message.

In another embodiment that may be used independently or combined with other embodiments described herein, the entity distributing the initial message, e.g., an initial synchronization message, or enabling the access or communication of an ambient IoT device (e.g., UE 103) via, e.g., a container-based approach as described in previous embodiments may also be an access device such as the RAN 106 in FIG. 2, where the communication link is 122. In this embodiment, access device and UE exchange data in data containers so that a generic protocol can support the needs of ambient IoT devices with very different features/capabilities. For instance, it may build on an uplink small data transmission (SDT), wherein UEs may multiplex a small uplink payload as part of a random access (RACH) procedure. In SDT, a UE may perform SDT via random access (RA-SDT) or via preconfigured radio resources (CG-SDT). The initial synchronization message may include the SSBs or a message including a synchronization preamble, whereby the SSBs may be particularly designed for ambient IoT devices. They may comprise an indication of a synchronization signal for ambient IoT devices (that may contain information for the ambient IoT devices), and they may comprise a wave capable of powering the ambient IoT device and/or a wave that can be used by the ambient IoT devices or a type of Ambient IoT device to communicate/backscatter information back. Since ambient IoT devices may be inactive most of the time, the synchronization message may be transmitted at any time to trigger the activation of the devices. To further reduce the energy consumption of the device, the synchronization message may already include information required by the device (e.g., a random value, an access device identifier, or a protocol identifier, or a service identifier, or a network identifier). Thus, upon reception of the synchronization message, the ambient IoT device may already determine whether it needs to react to the message or not. For instance, the ambient IoT device may only react to the message if it includes a protocol identifier it uses and/or a device identifier that belongs to it. The synchronization message may also comprise a potential configuration required for the later reply, e.g., the time and/or frequency resources to use with this connection end. This information may be included in SIB1, but it may not require the acquisition of the whole SIB (which is inefficient), and thus, only the required information may be included in the synchronization signals themselves, e.g., a potential delay in the answer, or a frequency shift and/or frequency resources to use in the answer. The answer may be constructed in a similar way as an initial message of a physical random access channel (PRACH) in a random access procedure and may include a data container. It may also include a protocol/device type/identifier so that the device receiving the message knows how to route the message. Note that this may require a network function (NF) or AF interested in retrieving data from ambient IoT devices in a given area to configure an access device (e.g., the RAN 106) or UE (e.g., the first UE 100) with the protocol/device identifier to be announced in the synchronization message and/or timing and/or schedule for those synchronization messages. Depending on the device type, one or more synchronization messages may be required for the device to be powered successfully or receive the message successfully or synchronize successfully, which may also be configured. Once a(n) (access) device has successfully distributed a synchronization message, it may also configure a periodic distribution of further synchronization messages to further retrieve data or information from ambient IoT devices. This may be based on an NF or AF configuration that determines this schedule. This may also be indicated by the ambient IoT device itself, which may indicate in its answer how long it requires until the next transmission, e.g., with two bits, “00” may indicate one hour, “01” may indicate one day, “10” may indicate one week, and “11” may indicate one month. The schedule may also depend on the device type that may involve a specific technique to harvest energy, e.g., solar-powered outdoor devices may be rather contacted at the end of the day, vibration powered devices may be rather contacted when they are subject to vibrations, etc.

Related to the configuration of periodic distribution of further synchronization messages to further retrieve data or information from ambient IoT devices, in an embodiment that may be combined with other embodiments or used independently, an Ambient IoT device may may be configured to to actively transmit (e.g., when they have the capability to harvest energy) data in a periodic manner (i.e., without requiring a message requesting the data to be retrieved). The reader (e.g., an intermediate device or a base station) may pre-empt the resources used for periodic transmission.

In another embodiment that may be used independently or combined with other embodiments, a reader (i.e., a UE or access device e.g., intermediate node, enabling access to ambient IoT tags) may announce its capability when connecting to the network (e.g., sending a registration request) or being commissioned as an access device of the network. This capability may indicate that it can be used to do one or more of:
transmitting ambient IoT data in data containers,
receiving ambient IoT data in data containers,
exchanging other parameters such as identifiers or security related parameters as per other embodiments that may be originated in the ambient IoT device or the core network or an application function.

A NF in the network or an AF or an AF through the network may provide the reader with request messages and/or parameters for the ambient IoT devices it needs to access. Some parameters such as a nonce may be included in specific fields used by the reader when sending a request message to the ambient IoT device. Other parameters may be included by the reader in the generic data container described in other embodiments. When the reader receives the replies from the ambient IoT devices, the reader may aggregate the replies/answers in a combined report. This combined report may be exchanged with/sent to the NF in the network or an AF or an AF through the network at a later time.

In another embodiment that may be used independently or combined with other embodiments, ambient IoT devices (e.g., IoT tags) are likely to operate in different operational conditions and the amount of energy harvested may differ per tag. The ambient IoT device may indicate in its answer to a synchronization message an amount of energy harvested, a time window and/or a period during which said amount of energy was harvested, type of energy harvested (e.g., solar, vibrations), a requested time/time period for sending a next transmission/message, and the minimum energy required for a transmission or a message exchange, such that the access device may adequately schedule the next exchange/synchronization message transmission.

In a related embodiment that may be used independently or combined with other embodiments, an ambient IoT device (or in general a UE that uses energy harvesting) may be capable of harvesting RF based energy from RF signals (e.g. illumination signals, carrier wave signals, downlink signals), and thus, the access device may redirect its beams or increase/decrease its transmit power for the RF signals directed towards the ambient IoT device or other UE that uses energy harvesting based on RF signals, based on the information received from the ambient IoT device or other UE that uses energy harvesting based on RF signals. Additionally or alternatively, the access device may instruct an intermediate node (e.g. UE acting as a reader), to redirect its beams or increase/decrease its transmit power for the RF signals directed towards the ambient IoT device or other UE that uses energy harvesting based on RF signals. Additionally or alternatively, the access device and/or intermediate node may report the amount of energy that they used for creating and/or boosting (e.g. by increasing the transmit power) the RF signals used for energy harvesting by the ambient IoT device or other UE that uses energy harvesting based on RF signals.

In a related embodiment that may be used independently or combined with other embodiments, the AMF or other network entity may collect the reports from the intermediate node and/or access device and/or information received from the ambient IoT device or other UE that uses energy harvesting based on RF signals about the amount of energy harvested by the device, and may use this to calculate a total amount of energy provided to enable communication with the respective ambient IoT device or other UE that uses energy harvesting based on RF signals and/or may provide this information to another core network function or application to calculate a total amount of energy provided to enable communication with the respective device and/or provide this information to a charging function, in which the costs related to the amount of energy may be calculated and/or be checked with the subscription for the particular device. The calculation on amount of energy provided may be done over a period of time, may be done in relation to a known/estimated distance between the source of the RF signal and the respective device and/or a known propagation loss and/or a known energy harvesting loss, and may be done based on averaging the amount of supplied energy amongst a number of respective devices in an area. The amount of energy provided may also be exposed to an application (e.g. via the NEF). Additionally or alternatively, similar to the amount of energy provided to enable communication, the communication time (e.g., transmission time and/or frequency resources and/or number of requests) may be calculated as well and may be provided to a charging function or exposed to an application.

In another embodiment that may be used independently or combined with others, the ambient IoT device (e.g., the second UE 103) may not have enough energy to reply to a request message from the reader (e.g., the first UE 100 or the RAN 106). In this case, the ambient IoT device may only feedback a signal indicative of its low-energy state, such as a short pulse or a backscattered bit. This may allow the reader to take appropriate actions, such as providing a signal powering the ambient IoT device, giving an indication (e.g., to the user) to get closer to the ambient IoT device, or switching to a different communication mode (e.g., from active transmission to backscatter communication). Additionally or alternatively, the reader may send a request message with a specific requested transmission mode, e.g., the first time may request active transmission and if it fails, then it switches to backscatter communication. Thus, in accordance with a general definition of this embodiment, it is proposed a method for operating a reader, comprising
receiving an indication of low capacity state from a target device,
selecting an alternative communication mode for communicating with the target device.

In a variant, the alternative communication mode includes one or more of the following:
requesting a user to reduce the distance between the reader and the target device,
activating an illuminating signal or a powering signal at the reader for the target device, or
switching to backscattering communication mode.

In another embodiment that may be used independently or combined with others, the first UE 100 and/or the RAN 106 (i.e., the reader) may exchange their capabilities to support ambient IoT devices. This may be done in an initial synchronization message (e.g., SSBs, or SIB1 (by the RAN 106) or in the initial PRACH message or registration message (e.g., by the first UE 100)). This allows both devices to determine how to communicate or how to enable communication with another (ambient IoT) device, e.g., the second UE 103.For instance, the access device may distribute in an initial message (e.g., synchronization signals, SIBI, an ambient IoT specific SIB, a wake-up signal, etc.) information related to the support of ambient IoT and/or carrier wave information (e.g., frequency, transmission power, duty cycle). This is beneficial because e.g. the first UE 100 may know which capabilities are to be used. For instance, the device providing access, e.g., sending the synchronization message, may indicate its support of communication capabilities for ambient IoT devices, e.g., carrier wave transmission.

In another embodiment that may be used independently or combined with others, a UE (e.g., the second UE 103) and a device providing access (e.g., the first UE 100 or the RAN 106) may need to exchange multiple messages. This may impose two requirements: (1) exchange a message identifier such as a counter to keep track of the exchanged messages and (2) allocate and/or generate and use a device identifier to identify sender and/or receiver. Regarding (1), a UE and access device may use an increasing counter for each exchanged message. For instance, a UE may use counter value “1” in a first message, the access device may use counter value “2” in a second message, the UE may use counter value “3” in a third message, etc. Regarding (2), the first message sent by the UE may include a random value. This random value may also be some data contained in the message or a function of it, e.g., a truncated hash of the data in a container. The answer from the access device may include this value or have it attached to the container of the answer message, so that the UE knows that the answer is addressed to it and that this value is valid. If the access device has determined a collision in the value, or part of the value, or that the value is replayed (i.e., it was previously received) the access device may not reply. The value or a subset of the value may be used as a network identifier for potential subsequent exchanged messages.

In another embodiment that may be used independently or combined with others, the device providing access (e.g., the first UE 100) to the second UE 103 may forward data provided by the second UE 103 including an identifier provided by the second UE 103 in an initial step, e.g., in the first message sent by the UE 103. This identifier may be added to the list of identifiers in the core network as tracked by the device providing access (e.g., the first UE 100). For instance, it may be included in the user profile of the first UE 100.

In another related embodiment that may be used independently or combined with others, the second UE 103 may report a measurement in the reply message, but the device providing access (e.g., the first UE 100) may not know where to route said data, e.g., to which PLMN in case the ambient IoT device is managed by a first network/PLMN and the access device belongs to a second network/PLMN. To this end, the second UE (i.e., Ambient IoT device) may need to include an identifier indicating the network and/or application and/or service where said message needs to be routed. The first message sent by the access device (e.g., a synchronization message) may include the identifier and a flag or field requesting the inclusion/replaying of such an identifier. This routing action may be done at the access device itself or by a network function (e.g., AMF).

For instance, the structure of the message sent by the second UE 103 may be:
Message=PLMNID, E{K_PLMN, Data_container_PLMN}
where E{K_PLMN, Data_container_PLMN} is the data container for an ambient IoT device so that the PLMN managing the ambient IoT may retrieve the data.
Then, the further structure of Data_container_PLMN may be Data_container_PLMN=E{K_App, Data_container_App}so that data of different applications and/or the network can be divided.

Note that this example illustrates a general embodiment in which the data can be carried in a “recursive” manner, or in other words, a container within another container wherein inner containers have multiple layers of protection and/or are protected using different security materials depending on which application/service they are associated with.

Note that in this embodiment and other embodiments, different devices/ambient IoT tags, may have different capabilities (e.g., depending on the device class as identified in TR 38.848), some devices may be able to run public-key encryption (e.g., ECDH, or Kyber), other devices may run symmetric-encryption only (e.g., AES or ASCON), other devices may be able to have only a physical unclonable function (PUF). These different capabilities may determine the features of E{ }. Depending on the capabilities, above functions E{ } may be implemented differently and the content transported transparently within the corresponding container may also differ.

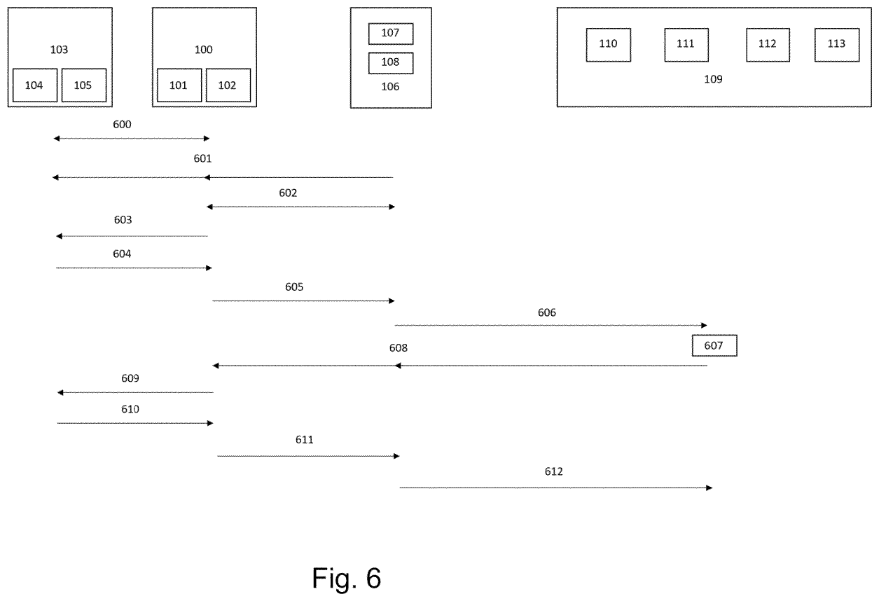

FIG. 7 describes a potential message flow including some features of the above embodiments. Similar to FIGS. 3 and 6, the diagram of FIG. 7 indicates the involved network entities (i.e., a UE 1401, a device 1402 for providing access and/or retrieving data from the UE 1401, and a NF/AF/application 1403 for interacting with the device 1402 to request access to data from the UE 1401) at the top, wherein the arrows below indicate successive message flows in time-dependent order with time passing from the top to the bottom of FIG. 7.

The device 1402 for providing access may be an access device such as a gNB or a powerful UE, e.g., similar to a UE-to-Network relay. The application 1403 may also be an application running on the device 1402 for providing access and/or retrieving data.

In step 1404, the NF/AF/application 1403 may request services from the access-providing device 1402 to provide access and/or discover devices (e.g., UEs) and/or retrieve data. Upon this request, in step 1405, the access-providing device 1402 may send a synchronization message to the UE 1401. Upon reception of the synchronization message in step 1405, the UE 1401 may check whether this synchronization message is intended for it or not, and if it is, it may reply in step 1406 with a data container. The access-providing device 1402 forwards the data container towards the NF/AF/application 1403 in step 1407. The NF/AF/application 1403 may reply to the access-providing device 1402 with any kind of further (data) request and/or an acknowledgment of receipt in step 1408. The access-providing device 1402 may confirm in step 1409 the correct reception of data transmitted in step 1406 and/or may forward the request received in step 1408 to the UE 1401.

In another embodiment, the synchronization message may be a groupcast and/or broadcast message intended for a group of UEs (e.g., UEs/Ambient IoT devices belonging to the same class e.g., class B devices) or all UEs within coverage, wherein a (group) identifier may be matched by UEs to determine whether the synchronization message(s) is/are intended for them and based on which the UEs either send a response message (e.g., containing requested data) or ignore the synchronization message. For a group of UEs with common features and/or from which the same type of data needs to be acquired, this has the advantage of reducing signaling overhead e.g. on the access-providing device 1402 of FIG. 7 and ensures (e.g., in groupcast) that only concerned UEs are addressed.

In the above embodiments, communication has been achieved by
receiving, by an ambient IoT device, a synchronization message comprising at least one of a random number or counter, an identity of the access device/UE or authentication service, or group of devices, or application or network, a supported message type, a supported device type, a data container, request to retrieve certain information, e.g., network ID, and a supported communication topology,
determining, by the ambient IoT device, whether the message is intended for an ambient IoT device (e.g., IoT tag), and
sending, by the ambient IoT device, a message including at least one of a data container, a random number or counter, an identity of the access device/UE or authentication service or application or network, a message type, a device type, an amount of energy harvested and the duration the energy harvest required, and a communication topology.

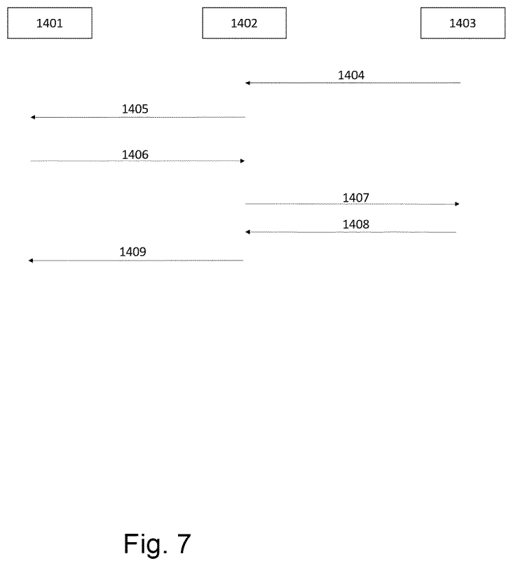

In another embodiment that may be used independently or combined with previous embodiments, an example illustrating how a container-based approach may be used is portrayed in FIG. 8, where 901, 902, and 903 represent Ambient IoT (AIoT) AIoT devices, which may or may not belong to the same class of AIoT devices (e.g., Classes A, B, or C), 904 playing the role of an Intermediate Node UE, 905 serving as an access device (e.g., gNB), while 906 and 907 represent the core network (i.e., a network function therein) e.g., AIoT Controller and an Application Function (AF) which may be within the Serving PLMN or outside of it (e.g., in the data network), a potential message flow is as follows where some steps may be performed multiple times, some steps may be performed in a different order, and not all steps may always be needed:
In step 910, the AF may decide to initiate a session to e.g., retrieve/read measurement data from AIoT device(s) in a certain location, or perform an inventory (i.e., determining the AIoT tags in the vicinity of (a) reader(s)), thus AF initiates the session by sending a message to the AIoT controller in the network (e.g., a NF within the CN) containing a (data) container or a set of (data) containers which include(s), but is not limited to the following: Identifier(s) of the AIoT devices to target/query, or a group identifier, or a more general identifier e.g., the class of AIoT devices to target/query, which may also be implicitly inferred from the identifier(s) of the AIoT devices, if included, a challenge or set of challenges (e.g., per AIoT device, per AIoT device class, or per group of AIoT devices), location (e.g., coordinates and radius) and timing (e.g., schedule or time value) information, and the AF identifier. Note that the AF identifier and location and timing information may be left outside of the data containers, or alternatively, if the AF is aware of a group of AIoT devices that is scattered e.g., in a 1 km radius of a certain location, it may aggregate the data containers relevant for these AIoT devices within one container (i.e., containers within a container) wherein location (e.g., coordinates and radius) information is understood to apply to the whole group of AIoT devices. Moreover, the supplementary information (e.g., timing, location) may be considered filtering information which the AIoT controller uses to determine the (sub-)set of AIoT tags to be targeted.
In step 911, 906 may verify whether 907 is authorized to initiate/communicate with and/or retrieve data from the AIoT devices it intends to query/command, then following the successful verification of AF's authorization, 906 may decide based on containerized data (e.g., filtering information e.g., location/timing information, and identifier(s)/challenge(s) provided by 907) and/or subscription data, the network entities to be engaged to monitor/log and/or communicate with the target AIoT device(s) e.g., which gNB(s) and/or readers the request(s) is/are forwarded to, and for each gNB whether to allow both topology 1 and 2 to be used. Note that this may also happen in an initial step in which those entities (gNBs or UEs (i.e., readers) are identified, authenticated, authorized and/or configured for a specific AIoT service. For data containers aggregated based on filtering information(e.g., location/timing information) 906 the AIoT controller (e.g., NF within CN) may extract and/or separate the data containers once a communication route and/or the serving gNB(s) to these AIoT devices are determined.
In step 912, 906 forwards the data container(s) to the relevant gNB 905; the message may further contain configuration settings such as, topology choice, timing schedule, etc.
In step 913, assuming topology 1, 905 broadcasts/transmits message 913 containing data container(s) wherein each container may include, but is not limited to, AIoT device ID and/or AIoT device class, a random value e.g., nonce serving as a challenge, a counter value to track exchanged messages and to ensure freshness, a timing value (e.g., a UTC counter value that could be used e.g., for key derivation and/or computing a response to the challenge e.g., HMAC value), an indication of an authentication procedure/protocol which may implicitly indicate the minimum security measures to take (e.g., at least integrity protect the response message), a key identifier (e.g., for instance a class C device may be provisioned with security materials that can be used to compute a response to the challenge and/or protect (e.g., ciphering and/or integrity protection) the response message, an indication of the type of data requested (e.g., for instance, assuming an AIoT device used in the context of logistics to keep track of temperature, humidity, pressure, shock and vibration, etc, the indication may be a bitstring where each bit is associated with a measurement, thus enabling the AIoT device to recognize the measurement data to provide), the requested data may further include power level and/or energy amount harvested since last illumination, etc.
In step 914, after the AIoT device receives message 913, it may determine based on e.g., AIoT device ID and/or class ID and/or group ID, and/or a preamble (e.g., in synchronization signal), and/or based on supplementary information (e.g., filtering information), whether the message is intended for it, and upon successfully checking that the message is intended for it, it may extract and process the data from/in the container e.g., extract indications/commands and determine the data to provide, identify the keying materials and/or authentication procedure to perform, identify the measurement data to be sent back in the response, etc. It may then compute a response based on the command/challenge received and the authentication procedure/protocol indicated, increment the counter value, then finally construct a response message which may include the following: AIoT device ID, or group/class ID, incremented counter value, a timing value (e.g., could be the same time value received replayed), a key indication and/or an indication of the authentication procedure/protocol used, the response to the challenge, and a data payload containing the measurement data requested, if any. Additionally or alternatively, the A-IoT tag may, in case the request/command received from 904 or 905 is for inventory purposes, send a simple response message which may contain, but is not limited to, its device ID, an incremented counter value (e.g., sequence number), a timing value (e.g., timestamp).
Steps 915, 916, 917, 918, 919, 920 assume Topology 2 wherein 904 is an intermediate node UE. In step 915, assuming the CN has location information of the intermediate node UE (IN UE) which happens to be located in proximity of AIoT devices 902 and 903, the AIoT Controller within the CN (e.g., a NF responsible for determining which network entities/proxies to engage to harvest data from AIoT devices) may forward (e.g., in protected NAS message(s)) data container(s), as described in step 913, to 904 in addition to a policy and/or a configuration e.g., timing schedule to periodically illuminate/trigger AioT devices to retrieve (measurement) data, and/or an indication of whether the IN UE is allowed to (locally) generate challenges and/or set conditions/parameters (e.g., time window, type of data/information to request, authentication protocols to use, etc) pertaining to subsequent/future exchanges with the AIoT devices. IN UE may also be configured with a time value (e.g., time window) to initiate/trigger forwarding responses back to 906 and/or 907 and an indication indicating to 904 whether to aggregate containerized responses from AIoT tags or to forward responses on a case by case basis (e.g., upon being received), depending e.g., on the estimated number of AIoT devices to be illuminated/triggered, illumination timing schedule, etc.
In step 916, the IN UE 904 broadcasts the message containing the data container(s) received from 906 according to the configuration settings provided to it in message 915. For instance, 904 may broadcast one message containing several data containers, each corresponding to a group of AIoT devices and/or a class of AIoT devices, and/or associated to an authentication protocol, wherein 904 may further include a reference/mapping table associating each AIoT device ID and/or group ID and/or authentication protocol ID to an index resolving the data container containing the information (e.g., challenge/command) corresponding to the associated identifier (e.g., device/group ID, class of AIoT device, or authentication protocol ID). 904 may as a result receive several responses from different AIoT devices (e.g., 902 and 903 as illustrated).
In steps 917 and 918, which correspond to responses received from AIoT devices 902 and 903 respectively, the processing of the received message 916 is similar to step 914, in addition to e.g., further processing, related to identifying the data container(s) corresponding to AIoT tags' identifier(s) (e.g., AIoT device ID, or group/class ID based) based on the mapping table included by 904. 902 and 903 compute the challenge responses and/or include it, along with (measurement) data, if any were requested, in a data container in the response message, then respond with messages 917 and 918 to 904.
In step 919, based on the configuration/policy provided to the IN UE 904, if any, the UE may, during a time window set by the configuration, receive and aggregate the received responses from the different AIoT devices that were queried/triggered, then based on e.g., the mapping table determine whether all response messages were received and/or whether there were failure cases, in which case it is indicated to 905, or 906 and/or 907 which AIoT device(s) were unreachable.

Furthermore, receiving all response messages before the time window is closed (e.g., timer runs out) may function as a trigger to forward the aggregated response messages to 905, 906, or 907; this is especially relevant when the number of devices queried (e.g., inventoried/commanded) is known to the reader UE, whereas when the number of devices is unknown, the reader UE may have to wait until the timer runs out.
In step 920, based on the configuration/policy provided to the IN UE in message 915, if any, the IN UE may (be instructed to) forward the received responses from the AIoT devices to the gNB e.g., for further aggregation, in case both topology 1 and 2 were leveraged to reach e.g., a group of AIoT devices within an area, and/or if 905 was communicating with the same, or a different, set of AIoT tags. Alternatively, 904 may forward the response messages to 906 e.g., through NAS communication as a response to message 915, or directly to the AF e.g., on an application layer level.
In step 921, assuming 905 received (e.g., in message 912) a configuration/policy defining topology type to be used, and/or whether 905 is permitted to choose the topology type(s) to be used to interact with the AIoT devices, 905 may choose, depending on said configuration and the communication scenario (e.g., number of AIoT tags, reachability, permission to use Topology 2, etc) to maximize its reach by using one, or more IN UEs, in which case, step 921 concerns the aggregation of response messages from the different AIoT devices, as provided by the IN UEs.
In step 922, the gNB forwards the aggregated responses to the AIoT Controller within the CN (e.g., NF within 906) which then performs checks and/or analytics data collection including, but not limited to: checks the validity of the challenge response(s) received, checks and logs (successful) response ratio along with the topology used, target AIoT device distribution (e.g., location data), etc (e.g., for optimization/scheduling purposes), collects network usage metrics (e.g., for billing purposes).
In step 923, 906 forwards the response data containers to 907 as a one-time response to message 910, or periodically e.g., based on a previously agreed upon timing schedule/configuration.

In another embodiment, in step 912, the gNB 905 may be allowed by the CN to decide (e.g., based on its resources and/or reachability) which topology to use and/or whether it may use both Topology 1 and 2.

In another embodiment, the approach described in step 916 which uses a mapping table to associate the AIoT device ID, or group/class ID, to an authentication procedure/protocol, and/or the corresponding challenge may also be used by 905 in e.g., step 913.

In another embodiment that may be used independently or combined with previous embodiments, 904, and/or 905 and/or 906 may be provided with one or multiple masked response value (e.g., output of a hash function taking as input the expected response to a challenge) such that the intermediate entities with the masked response value may evaluate whether a response provided by (an) AIoT device(s) is valid or not, and determine whether to exclude or aggregate the received faulty response with other valid responses to be forwarded to 907. For instance, an ambient IoT device may identify itself by means of a HMAC or a physical unclonable function or other cryptographic function that we may represent as H( ) where b=H(a) indicates that b is the result of evaluating H( ) with input a. The AF may know that given a challenge C, the result is R1=H(C), and R2=H(R1), and so on. If there is an intermediate verifying entity, the AF may provide to said intermediate verifying entity R2 and C. The intermediate verifying entity (e.g., 904, and/or 905, and/or 906) may transmit C to the AIoT device, and may return R2 (i.e., it requires two iterations of H). This allows the intermediate entity to verify the response. This approach may also be used in the case of a container based approach, even if in this case, the intermediate entity may also need to know which function H( ) it may need to use in the verification process. Additionally or alternatively, the first function (e.g., H( )) may be associated with an authentication protocol/procedure and/or the type/class of the AIoT device to be challenged, whereas a second function (e.g., V( )) may be a verification function such that R2=V(R1). The intermediate node may be provided with C and R2, and upon transmitting the challenge C to the AIoT device and receiving the response R1, the intermediate verifying entity verifies the response by computing V(R1)=R2′ and checking whether R2′=R2.

In another embodiment that may be used independently or combined with previous embodiments, different types of devices require or have different security needs or capabilities. For instance, a class B device may support a PUF and a class C device may have a secure element and may be able to run a standard hash function or a digital signature algorithm. Both a PUF and a secure element can be considered as two different types of tamper resistant modules and other options may exist. For instance, a class B device may be able to use 32 bit challenges/responses based on a hash function, but a class C device may be able to use 64 bit challenge/responses based on digital signatures. Identifying/authenticating the ambient IoT tags may in both cases involve sending a challenge, and checking that the response matches the expected value so that data containers may transport the downlink (e.g., from base station to ambient IoT tag) security information in a downlink security data container and the uplink (e.g., from ambient IoT tag to base station) security information in an uplink security data container. A technical specification may specify the downlink security data container and uplink security data container to transport security information without describing/entering into the details of the information exchanged. The uplink and downlink security data containers associated to an Ambient IoT tag may be exchanged between, e.g., the AF and the device interacting with the ambient IoT device, e.g., gNB or UE or end-to-end between the AF and the AIoT device(s).

In another embodiment that may be combined with previous embodiments or used independently, a UE (e.g., reader/Intermediate Node) providing access to ambient IoT tags may securely exchange data (e.g., data containers) with an application function in charge of the ambient IoT tags by means of AKMA (TS 33.535) or via the core network (e.g., AIoT Controller).

In another embodiment that may be combined with previous embodiments or used independently, a UE or gNB enabling communication with ambient IoT tags needs to be authorized by the core network (e.g., a NF therein) to communicate with the ambient IoT tags and use spectrum corresponding to this communication. This means, e.g., that the gNB needs to know that a UE is capable and authorized to be allocated certain communication resources (time/frequency) to communicate with the ambient IoT device(s). This requires a configuration in the gNB linked to the UE determining this authorization. For instance, a UE may exchange its ambient IoT capabilities in an initial registration request message so that the gNB/network is aware of these capabilities. If the UE (e.g., at a later moment) needs to send request messages to interact with ambient IoT devices, e.g., by means of a container based approach as described in other embodiments or the like, where this interaction may have been requested by an application either over the top (e.g., using AKMA for the authentication so that the communication runs in the user plane of the UE) or through the core network, the UE may send a request to the network/gNB. The gNB/network may record said request (e.g., for billing purposes), and may grant or reject communication resources to perform the communication with the ambient IoT devices. These communication resources may be only RAN resources (e.g., if the communication is over the top) or may be a communication session involving SMF configuration to route the data exchange.

In another embodiment that may be combined with previous embodiments, in case a gNB is allowed to choose the operational topology and it uses Topology 2 or combines both topologies, the containerized request/challenge messages and responses may be exchanged between IN UE and gNB protected using AS security materials.

In another embodiment that may be combined with other embodiments or used independently, a UE (e.g., 904) may undergo a provisioning/configuration phase whereby it may be authorized to play the role of a Reader (i.e., Intermediate Node) and enabled to communicate/interact with A-IoT devices when in or out of 3GPP coverage, whereby the Reader may be configured to perform periodic inventory and/or information retrieval from A-IoT devices and log/store responses from A-IoT devices to be delivered to the AF and/or AIoT Controller, e.g., once the Reader UE moves or is within 3GPP coverage. The provisioning/configuration of the reader UE may include a policy/configuration which determine aspects including, but not limited to, the following:
Whether UE is allowed to communicate with/trigger A-IoT devices when the UE is not being served by NG-RAN (i.e., UE is Out-of-Coverage (OOC));
Whether and how UE (self-)allocates communication resources to perform the communication with A-IoT devices when UE is OOC;
Conditions (e.g., configured/scheduled interactions by the AF), if any, under which the UE is allowed to communicate with A-IoT devices (even) when the UE is OOC;
Analytics/communication (meta-)data pertaining to communication with AIoT device(s) to be stored by UE when said communication occurs OOC;
Whether to store or discard responses received from AIoT devices and for which response verification fails;
Inventory periodicity (e.g., to allow the network to remain up-to-date with AIoT device(s) distribution); A-IoT device information retrieval periodicity (e.g., power storage levels, measurement data, etc)
Whether UE is authorized to service/operate as a Reader UE via an undirect path to the network (e.g., through UE-to-Network relay UE)

In another embodiment that may be combined with other embodiments or used independently, the AF and/or A-IoT controller may authorize a reader UE to interact (i.e., inventorize/command) only with a specific group of A-IoT devices. For instance, the reader UE may be mounted in a shipment container where it regularly collects and monitors measurement data associated with the shipment items through the A-IoT devices attached to the shipment items. The reader UE may further be configured to perform periodic or conditional inventorying, based e.g., on location information (e.g., before reaching, or after leaving a distribution center), the reader UE may also infer the number of AIoT devices (e.g., in the shipment), based on the responses received from a particular command (e.g., read/enable). Furthermore, the reader UE may be authorized to authenticate the A-IoT devices locally (i.e., without having to interact with the A-IoT controller or AF), whereby the reader UE may be configured with device specific pseudoIDs, device-specific security materials, group-specific security materials, and/or device-specific challenge(s)/response(s), and/or supported authentication methods and security algorithms, and/or device specific tokens/code (e.g., for resetting the A-IoT device), in addition to a configuration/policy determining the data to be collected and/or shared with the A-IoT controller and/or AF, schedules and/or the conditional triggers for running commands and/or inventorying, and/or the mode of operation (e.g., communication topology, data collection schedules, etc) based on reader UE's 3GPP coverage status (i.e., in or out of coverage).

In another embodiment that may be combined with other embodiments or used independently, the AF or A-IoT Controller may initiate a procedure for the purpose of inventory (i.e., detecting the A-IoT device(s) in the vicinity of an Access Device (e.g., gNB) or a Reader (e.g., UE) wherein the request sent by the AF/A-IoT Controller to initiate inventory procedure may include location/timing information and/or a class/group ID, and/or other supplementary information to be used as filtering criteria. Upon receiving responses from A-IoT devices in proximity, the Reader and/or gNB may, in an intermediate step, process the responses and verify whether the responding A-IoT devices match the filtering criteria, before forwarding the responses to the initiating entity (e.g., A-IoT Controller or AF). Additionally, where both gNB and Reader(s) are engaged in the inventory procedure, upon receiving responses from Reader(s), the gNB may verify whether the aggregated responses are unique (e.g., based on the Device ID in response), and ensure duplicates are discarded.

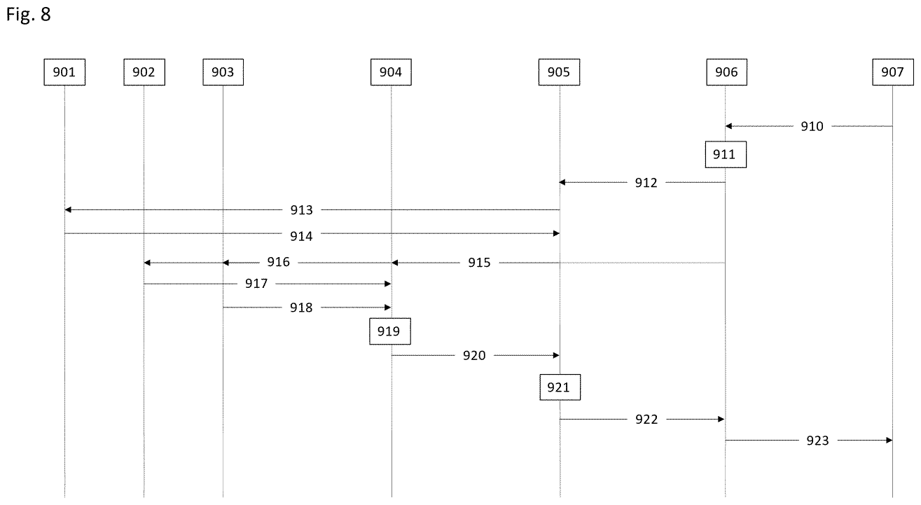

FIG. 9 describes a further example of a container-based approach where two tags (Tag 1 and Tag 2) are present, a UE reader, a core network (CN), application function 1 (AF1), application function 2 (AF2), and data bases for AF1 and AF2 (AF1 DB and AF2 DB, respectively). In this example, Tag 1 is served by AF1 and may use a PUF-based authentication procedure and Tag 2 is served by AF2 and may use an authentication based on HMAC. These are examples and show that tags with different capabilities may exist, another example refers to tags with a secure element as described in other embodiments, e.g., in the form of a eSIM/UICC. In a first step, AF1 may obtain challenge/response pairs from Tag 1 that may store them in Step 2. The AF1 and CN may agree on the service in Step 3. Tag 2, AF2, and CN perform similar steps in Steps 4, 5 and 6, involving security key provisioning and storage instead. The UE and CN may perform an authorization step to authorize the UE to interact with the tags in Step 7. In Steps 8, to 13, AF1 may retrieve challenges from the data base, forward them to the UE as a data container AUTH_CONTAINER specific for Tag 1 including three fields (ID, parameter, device info), and the UE then can distribute this data container as payload of the RAN protocol (e.g., in a request message). Tag 1 and Tag 2 can then check, in step 11, whether the message is intended for them, perform the security protocol triggered by the AUTH_CONTAINER request and reply with a new AUTH_CONTAINER response, as in step 12. The UE will then forward the AUTH_CONTAINER to AF1, in step 13. Steps 14 to −18 illustrate similar steps for AF2—Tag 2. In this example, it is possible that two applications use a container-based approach to interact with different types of tags supporting different authentication methods.

Note that in this figure and procedure, AF1_DB AND AF_DB are outside of the core network. In an option, AF1_DB and AF2_DB may be part of the core network, also in a single data base, e.g., in a data function such as the 5G UDM/UDR. In this case, the core network is enhanced to support devices with different authentication capabilities.

In an embodiment that may be combined with other embodiments or used independently, authentication (e.g., one-way authentication or mutual authentication) may be performed between an AIoT device and an AF (or CN), or between an AIoT device and a reader, which is pre-authorized by the AF (or CN) to carry out (mutual) authentication with the AIoT device(s). In both scenarios, the authentication procedure may be transparent to the CN; that is, when authentication is performed between the AF and the AIoT device, the authentication message(s) may be protected end-to-end between the two parties by means of pre-shared security materials and/or security materials derived from them. When performed between the AIoT device and a UE (i.e., Reader UE), any authentication parameters communicated to the UE (e.g., as part of the authentication request, or to locally generate said request, in addition to the authentication result (e.g., successful/failed), and/or authentication response from the AIoT device(s) may be communicated to the AF (e.g., in a container message) protected end-to-end between the UE (i.e., Reader UE) and the AF. In both scenarios, traffic may be transparent to the CN, however, supplementary data (e.g., network resources consumed, data consumed, etc) may be collected by the CN for billing/charging purposes.

In another embodiment that may be combined with other embodiment or used independently, instead of the AIoT device owner (e.g., AF) managing the AIoT devices (e.g., performing authentication and access control, security management, network connectivity management, power management, etc) themselves, the AF may have a service agreement with a mobile network provider (MNO) delegating the management of the AIoT devices to the MNO such that the AIoT device(s) owner (e.g., AF) only makes use of the AIoT devices e.g., by issuing commands e.g., read/write/disable or requests an inventory, and/or provide access right to use the AIoT devices to a 3rd party. The CN may provide the AF with periodic reports related to its AIoT assets (e.g., network resources/data consumed, AIoT device(s) reachability rate, authentication success rate, etc). Additionally, the AF, as part of the service agreement, may provide the CN with information associated with the AIoT devices (e.g. security materials such as long-term credentials, permanent identifier(s), challenge(s)/response(s), etc) to enable the CN to manage the AIoT device(s).

Given the varying device capabilities supported by the different AIoT device types, as discussed in other embodiments, some AIoT device(s) may support being equipped with a UICC (e.g., in general, a type of secure element) and other devices may not support it. When a device supports the usage of a UICC, these AIoT device(s) may have the capability to perform a primary authentication-like procedure with the CN. A primary authentication-like procedure may refer to a (mutual) authentication handshake between an AIoT device and CN where the secret used to perform it resides in a secure element such as an UICC. This primary authentication-like procedure may exchange fields required for authentication/key establishment in containers whereby other more resource-constrained tags may use those containers to exchange authentication/key establishment data obtained without a secure element. Thus, in an embodiment that may be combined with other embodiments or used independently, and in accordance with the container-based approach described in other embodiments, a primary authentication-like procedure may be performed using containers, such that the authentication request message parameters are carried in a container, where the container (e.g., in its header field) has an indication that the payload contained is a primary authentication-like request (i.e., including a RAND, AUTN, ABBA), and upon successfully verifying the SQN and MAC, an AIoT-device may compute an authentication response (e.g., RES), which is then sent back to the CN in a container. Additionally, or alternatively, instead of the SQN, the authentication request may contain an Internal State (IS) parameter associated with the to-be-authenticated AIoT device, which may be updated after each primary-authentication attempt.

In an embodiment, there are different types of Ambient IoT devices that are managed by the core network, e.g., some devices rely on a secure element such as a UICC and some devices rely on a PUF. A network function in the core network, e.g., a data function such as 5G UDM may store the type of device, e.g., by means of an identifier, and this may be used to determine the type of authentication procedure to run. This may be an entry in a data base in the core network. They may be a list with different types of devices and the security capabilities. The contents of the authentication procedure may be contained in generic containers, e.g., a freshness parameter for a device using PUF based authentication scheme may be a fresh challenge that has not been used (as managed by the core network) and a freshness parameter for a device using a secure element may be a counter.

In a further embodiment associated with the primary authentication-like procedure for AIoT device(s), and unlike UICC-less AIoT devices that may be able to carry out (mutual) authentication during the random access-like procedure with the gNB/Reader, the UICC-based AIoT device requires to be initially identified by the CN, and only then can the primary-authentication request, corresponding to said device, be generated. Thus, during the random-access procedure, the AIoT device may provide its permanent identifier (e.g., SUPI/IMSI), or a device-specific identifier (e.g., long term identifier), which is protected/concealed (e.g., following a SUCI like procedure) as a response during the RA procedure. The access device (e.g., Reader UE or gNB) may then forward the concealed identifier to the CN, where it is de-concealed and verified, and upon successful verification of the device (subscription) details, the CN generates an authentication vector corresponding to the AIoT device, that is then communicated to the gNB (or reader UE), along with an interim authentication result (RES*) for verification purposes (e.g., verification of the authentication response when received by the gNB/Reader UE). Additionally, or alternatively, if the AIoT device is a static device and its location is known to the CN, the latter could generate the authentication vector prior to the device identification, and provide the authentication vector along with a pseudoID to the gNB (or the Reader), such that the gNB (or Reader) could initiate the (mutual) authentication (i.e., primary authentication) during the RA procedure, or following the RA procedure without having to involve the CN; for instance, the gNB (or Reader UE) may provide the authentication request container to the AIoT device in the initial synchronization/trigger message. For instance, the gNB (or Reader UE) may send the authentication request container in the RA response message to the AIoT device. For instance, the gNB (or Reader UE) may send the authentication request container upon verifying that the AIoT device has sufficient energy to perform primary authentication (e.g., protect its identifier, and perform verification of SQN/IS and MAC, and generate the authentication response); that is, when performing RA, the device may indicate to the gNB/Reader UE its energy level, such that (mutual) authentication procedure is triggered only if the device's energy level is above a certain threshold, which may be device type/class dependent and be pre-configured by the AIoT management function (AIoT MF) (e.g., NF in CN or AF). Additionally, or alternatively, the gNB (or Reader) may indicate in the trigger/synchronization message to the AIoT Device to protect its identifier (e.g., pseudoID) using a specific scheme; for instance, the pseudoID may be the output of a cryptographic function e.g., hash function, taking as input parameters the AIoT Device identifier, and a random value (e.g., to be used as a salt in the cryptographic function) as provided by the access device (e.g., gNB/Reader). This allows the gNB/Reader UE to verify the AIoT device identity, by comparing the pseudoID received from the AIoT MF to the one received from the device, without having access to the identifier; the access device may further be provided with an expected RES (e.g., for authentication response verification), and the authentication request by the AIoT MF, such that the gNB (or Reader) first requests device identification (e.g., during RA procedure), verifies the identity of the AIoT Device, then perform the authentication procedure by sending the authentication request container to the device, and upon receiving the authentication response container message, verifies it against the expected RES, and if the checks are successful, the access device may forward the authentication response to the AIoT MF for further checks, or simply indicate to the AIoT MF that the authentication was successful. Additionally, or alternatively, the container message sent to the gNB (or Reader), may further contain a command and/or supplementary data (e.g., data to read/write) to be sent, or requested from the Ambient IoT device, such that the gNB/Reader, performs device identification, carries out mutual authentication, and then send the command to the AIoT Device. The gNB (or Reader) may only interact/engage with the AIoT MF upon receiving a response for the command (e.g., ACK, if the command is a “write”, or “disable” command, or data if the command is a “read” command) and concluding the interaction with the AIoT device. Then, the access device (i.e., gNB (or Reader)) provides the ACK/requested data to the CN, along with the authentication result and/or device pseudoID. This has the advantage of allowing the access device to operate with more autonomy, thus minimizing signaling traffic between the access device and the AIoT MF.

In a further embodiment related to AIoT Device authentication, that may be combined with other embodiments or used independently, for UICC-less AIoT devices, authentication may also be performed between the AIoT device and the CN, where the CN is provided with device specific parameters (e.g., security materials, IS parameters, etc) by the AF, as described in previous embodiments. The CN may generate device specific, or group specific, or authentication method-specific challenges directed at single device, group of devices e.g., devices sharing the same group ID, or devices sharing the same authentication method, or devices of the same class. Depending on the use case (e.g., command, or inventory), the authentication request payload may include different parameters, and/or require different security processing procedures (e.g., MAC verification, payload protection, security key derivation, etc). For instance, during an inventory procedure, the AIoT device may receive a container including an authentication method indicator, and other authentication parameters, such as a challenge (e.g., to authenticate the requesting party (e.g., CN/gNB/Reader UE)) where upon successfully verifying the requesting party's legitimacy and the device's capability to support the indicated authentication method, the device protects its identifier and sends a response to the challenge, containing only its pseudoID, or including a pseudoID, in addition to an authentication response (e.g., challenge response based on a cryptographic function (e.g., hash function taking as input e.g., the device's IS), or based on a PUF, etc). For instance, if the device receives a container including a command (e.g., read command), a command indicator/flag, an authentication method indicator, authentication and/or authorization parameters (e.g., a challenge, a token, etc), and upon verifying that the request is coming from a legitimate requestor, as described previously, the UE may further verify whether the requesting party is authorized to issue the received command and to read the requested data, and only if the verifications are successful, the AIoT device may generate an authentication response, generate security keys for data protection, and based on its configuration/policy, protect the confidentiality and/or the integrity of the data requested. For instance, if the device receives a container including a command indicator/flag indicating a write command, the container may further include an authentication method indicator, authentication and/or authorization parameters (e.g., challenge/token), security protection indicator/flag (e.g., indicating how the data is protected), the payload data including e.g., data to be written, and a MIC; the device may initially start by verifying the integrity of the container message, and upon successfully message verification, the device may perform similar verifications to the ones described for the read command, and then undo the confidentiality protection of the payload data. It is worth noting that the whole container (e.g., including the header fields i.e., indicators/flags) may be integrity protected, whereas only the payload data may be confidentiality protected. Additionally, the AIoT device which supports read/write commands may be pre-configured (e.g., by the manufacturer/vendor) with message-specific confidentiality (downlink and uplink) masks, which indicate to the AIoT device(s) which parts of the container message are confidentiality protected e.g., when receiving a write command, and which parts of the message ought to be confidentiality protected e.g., when receiving a read command.

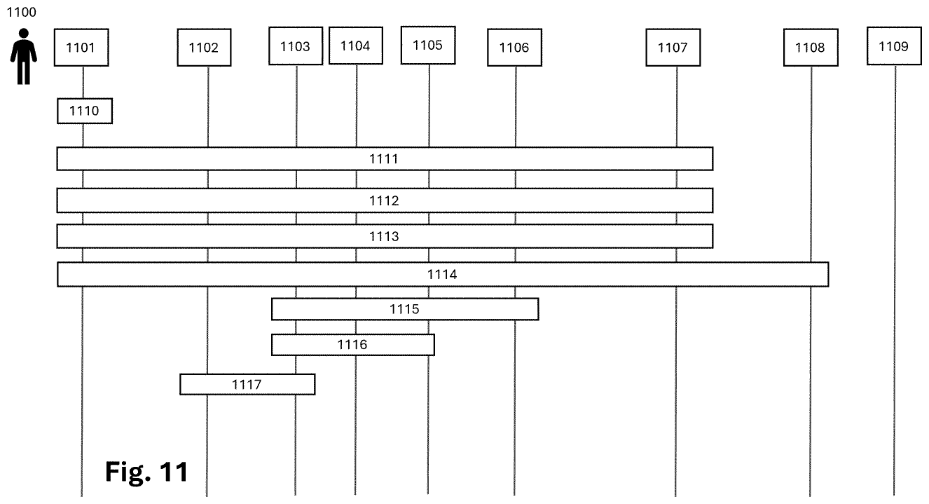

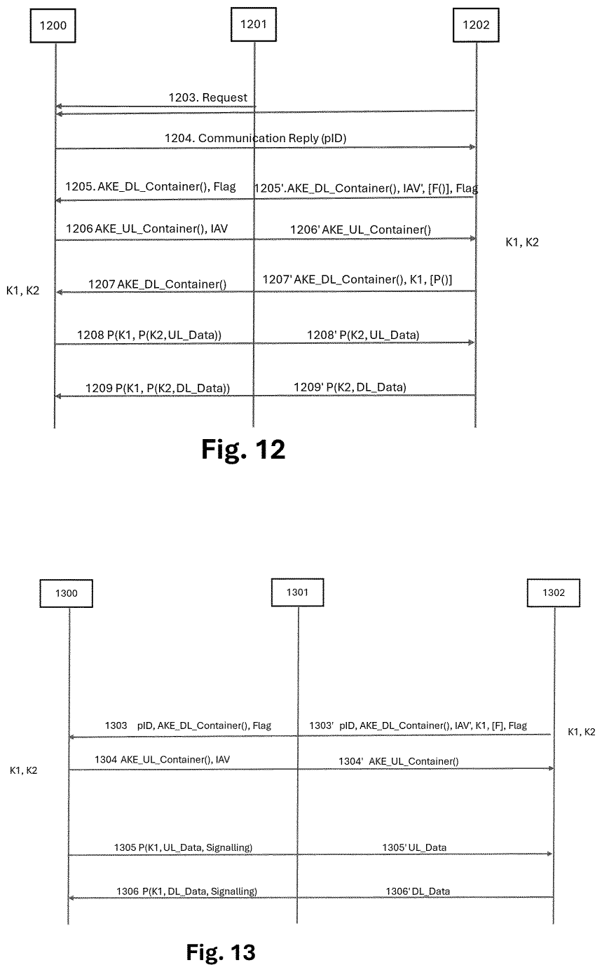

FIGS. 12 and 13 represent two additional procedures using a container-based approach to enable the secure communication between a tag (entity 1200/13 in FIGS. 12/13) and an AF/NF (entity 1202/1302 in FIGS. 12/13) over a reader/NF (entity 1201/1301 in FIGS. 12/13). In FIG. 12, entity 1201 or 1202 may initiate the communication in step 1203 by sending a request to 1200. Entity 1200 may reply or initiate the communication in step 1204 by sending its identity or pseudoidentity (pID). Entity 1202 may use in steps 1205′, 1205, 1207′, and 1207 a container denoted exemplary here as AKE DL_CONTAINER (Authentication and key establishment downlink container) to carry information required to perform, e. g,. the authentication and key establishment. Similarly, entity 1200 may use in steps 1206′ and 1206 a container denoted exemplary here as AKE_UL_CONTAINER (Authentication and key establishment uplink container) to carry information required to perform, e. g,. the authentication and key establishment. Uplink messages may carry AKE_UL_CONTAINER and Downlink messages may carry AKE_DL_CONTAINER. These containers may be transparent to 1201. A container-based approach may however give 1201 the means to check whether the traffic is allowed, and thus, message 1205′ may provide an authentication tag IAV′ and an authentication function F( ). Messages 1205 and 1205′ may also include a flag indicating to entity 1200 that it needs to compute/use IAV (and key K1 described below). Entity 1201 may use IAV′ and F( ) at a later stage, e.g., step 1206, to check whether F(IAV, IAV′) is true. For instance, F( ) may represent the equality check, or F( ) may represent whether the output of a cryptographic function e.g., Hash(IAV′)=IAV. Similarly, subsequent uplink messages may be verifiable by means of a key K1 provided by 1202 to 1201. In addition to K1, entity 1202 may also provide entity 1201 with function P( ) or an identifier of P( ) that indicates how (e.g., with which function) those subsequent messages are protected. Some of these values (IAV, F( ), K1, P( )) may only be provided if supported by entity 1200. Some of these values may only be used if required by entity 1201 (e.g., this may be indicated to 1200 by 1202 after notification from 1201). Some of the functions (e.g., F( ), P( )), if supported, may be (pre-)configured in 1201 such that 1202 only indicates which function(s) are to be used.

FIG. 13 shows another possible instantiation of a container-based approach wherein the communication is initiated by entity 1302 knowing the entity 1300 it is addressing in messages 1303′ and 1303. Values IAV', K1, F( ), P( ), Flag play a similar role as that described in relation with FIG. 12. The check F( ) of IAV and IAV′ is done in this case upon reception of message 1304. Messages 1305 and 1306 are protected by means of key KI using e.g., function P( ).

In general, it is proposed an apparatus for managing a connection, wherein the apparatus is configured to:
select one of a plurality of authentication procedures;
perform the selected authentication procedure with and/or through a core network; and
set up a connection with and/or through a core network when the selected authentication procedure succeeds.

This apparatus is further adapted to:
receive, from a first entity, a first message with a first authentication and key establishment container and optionally an indication of at least a first security value to be generated for authentication with a second entity,
compute the first security value,
transmit, to the first entity through the second entity, a second message with a second authentication and key establishment container wherein the second message includes the first security value or a message authentication code computed using as key the first security value.

In general, it is proposed an apparatus for managing a connection, wherein the apparatus is configured to:
receive, from a first entity, a first message with a first security value, security keying materials, and optionally an indication of at least a function to be used for subsequent security value verification to authenticate a third entity,
extract the first security value, security materials, and indication from the first message and forward the first message to a third entity,
receive, from a third entity, a second message containing the first security value or a message authentication code computed using as key the first security value.
Verifying, based on the indicated verification function received in the first message, if any, whether the first security value(s) received in the first and second messages match, or whether the message authentication code, computed using as key the first security value, matches the message authentication code received in the second message.

### Third Scenario: Additional Details on Multi-Factor Authentication (e.g. Based on Biometrics)

The following embodiments relate to a third scenario of enhanced identification and/or authentication and/or authorization and home-network triggered multi-factor identification and/or authentication.

Existing methods for (primary) authentication in cellular networks are solely based on cryptographic keys stored in the UE/SIM and core network. However, these keys may not be sufficient in some scenarios, e.g., when a user wants to access specific resources of a network. E.g., in a non-public network, it may be beneficial to enhance such authentication procedure with additional information, e.g., biometrics as a service or multi-factor authentication as a service. For instance, such additional information can allow identifying specific users. For instance, this information may be biometric information, but it may also be a user-specific PIN, password, or cryptographic key. For instance, it may allow for user identification and/or also for user authentication or authorization.

In the system described in FIG. 2, we observe that the first UE 100 (e.g., a standard smart phone) may rely on own sensors or on sensors of a close-by device, e.g., the second UE 103 (e.g., a smart watch) to obtain some biometric information. Note also that the fact that the second UE 103 is close to the first UE 100 can be considered as a multi-factor authentication procedure. For instance, a camera in the first UE 100, which may be used to obtain the biometrics of the user, and/or sensors in the second UE 103, which may be used to obtain features of heart rate and/or movement of the user and/or the fact that the first UE 100 and the second UE 103 are close together, can be considered a multi-factor authentication. In the system described in FIG. 2, the first UE 100 and/or the second UE 103 may be capable of sensing, e.g., wireless sensing, to obtain biometrics of the user, e.g., heart rate and/or breathing rate of the user. In the system described in FIG. 2, the authentication procedures of the first and second UEs 100, 103 may be performed in a combined manner as described in previous embodiments (e.g., related to FIG. 6).

The scenario and the system described in FIG. 2 may also refer to a first device 100 (e.g., a UE or a gateway) that provides access to another device, e.g., the second device 103. It may be needed to determine what kind of device the second device 103 is, e.g., to provide a better service, e.g., identifying the second device 103 as AR/VR glasses may allow for optimization of the user experience.

The scenario and the system of FIG. 2 may also refer to a combination of both. For instance, multiple users may access the system by means of second device(s) 103 that connect(s) to the first device 100 (e.g., a UE or a residential gateway, RG). It may therefore be needed to identify both second device 103 and the user making use of it. For instance, the second device 103 may be AR/VR glasses or a tablet used by multiple users.

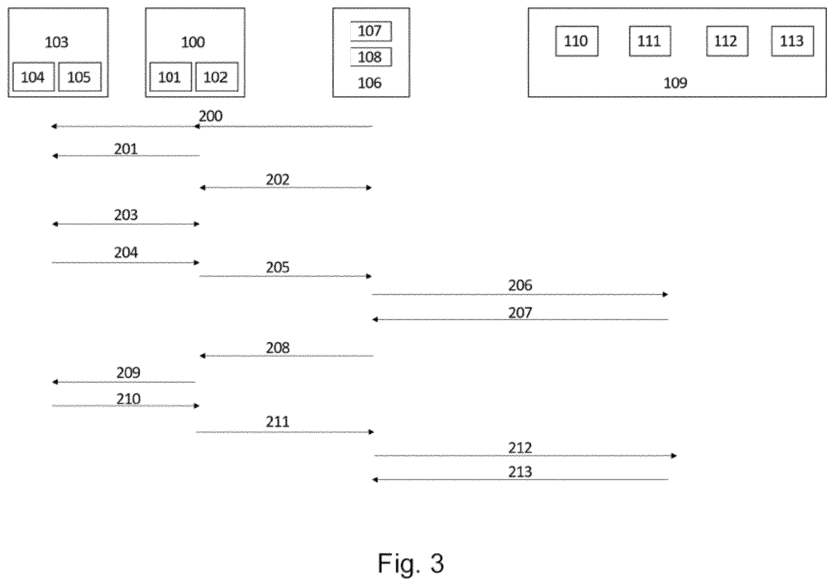

FIG. 4 schematically shows another procedure of an enhanced primary authentication procedure involving multiple user equipment devices.

In the embodiment of FIG. 4, that may be combined with other embodiments or used independently, a first UE 100 (e.g., the first UE 100 of FIG. 2 with the first and second SIMs 101, 102) may use sensing means 126, e.g., wireless sensor to sense the presence of a user 402 holding the phone and/or a camera to obtain an image of the user 402 holding the first UE 100 (e.g., a phone). This is, e.g., illustrated by means of FIG. 4 where the sensing means 126 may refer to those sensors (wireless sensor and/or camera). The fact that the first UE 100 can sense the user 402 allows to confirm that the user 402 is present. In particular, since the user 402 is holding the phone or is standing/sitting next to the phone, the phone may sense (e.g., wirelessly sense) the distance to the user's face and this distance may not be static but may vary over time due to the movements (head, hand, etc.) of the user 402. Similarly, the camera of the UE may capture the head/face of the user 402. Similarly, the camera may extract biometrics of the face, but may also keep track of the relative distance between face and camera, while as per the same reasons as above, the distance face-camera may change over time. The phone may then check that the real-time distance between the first UE 100 and the user 402 as measured through the sensing means 126, e.g., wireless sensor and/or camera, are correlated/identical so that the first UE 100 can verify that the user 402 is actually next to the first UE 100.

The same sensing capability may be provided at a second UE 103 (e.g., the second UE 103 of FIG. 2 with the first and second SIMs 104, 105) with sensing means 127 and a second user 403. The RAN 106 and the core network 109 with their components 107, 108 and 110 to 113 correspond to those of FIG. 2 and are not explained again here.

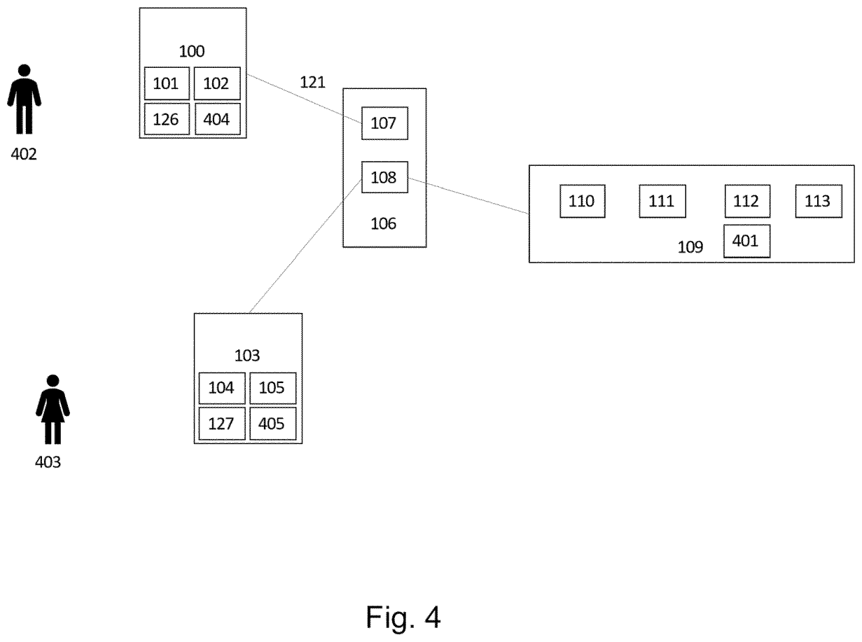

Exemplary sensing results are illustrated in time diagrams of FIG. 5 where the top diagram represents, e.g., the distance d between the first UE 100 and the user 402 over time t, as measured by means of wireless sensing, while the bottom diagram represents, e.g., the distance d between the first UE 100 and the user 402 over time t, as measured by means of a camera. Since both measurements are correlated over time, it can be concluded that the user 402 is present and operating the first UE 100.

Thus, the waveforms of FIG. 5 can be used to perform a similarity check between measurements of two different sensing means on a single device (e.g., the first UE 100) or on respective different devices (e.g., the first and second UEs 100, 103).

When wireless sensing is not available, other sensors in the first UE 100 or the second UE 103 may be used to perform a similar correlation check, e.g., accelerometers of the first and second UEs 100, 103 may be used to check a correlation in the user hand/body movement comparable to an estimated user hand/body movement as measured when recording the user's face and/or body with e.g. a camera of the first UE 100. Other biometric parameters may also be measured by the sensing means 126, 127, e.g., both camera and wireless sensing making the verification stronger (examples of those parameters may include heart rate or breathing). This ensures that an actual user 402, 403 is in front of the respective first/second UE 100/103 (e.g., phone) (and not a picture of the user).

In an embodiment that may be combined with other embodiments or used independently, sensors of different devices are used to perform the biometric verification. For instance, if the first user 402 is holding the first UE (e.g., phone) 100 and also wearing a smart watch (e.g., the second device 103 of FIG. 4), and the smart watch is monitoring certain features (e.g., sound and/or health features of the user with biometric properties), the system may check whether:
a) The biometric features measured by the smart watch match biometric features stored in the core network, and/or
b) The measurements (e.g., sound, movement (when the user is holding both devices for the call), etc.) of the smart watch and the first UE 100 are correlated.
This allows using multiple devices bound to or associated with a user to provide enhanced user authentication.

In an embodiment that may be combined with other embodiments or used independently, the first UE 100 and the second UE 103 may be connected through a wireless communication link, e.g., a PC5 link. The fact that the first and second UEs 100, 103 are connected serves as proof that they are close together, e.g., if the first UE can manage to establish a secure direct PC5 connection with the second UE. This proof can be further enhanced if the first and second UEs 100, 103 are both able to sense a correlated measurement, e.g., the ECG or heart/breathing rate of the user.

In an embodiment that may be combined with other embodiments or used independently, the first UE 100 and the second UE 103 may wish to perform a biometric measurement and this may require a user action to allow for it. For instance, the user may need to first enable or confirm the feature in the UE options. The UEs 100 and 103 may also record the confirmation as a proof of consent and the proof of consent may be uploaded to the core network 109, e.g., to a NF in charge of identification and sensing.

In an embodiment that may be combined with other embodiments or used independently, one of the first and second UEs 100, 103 may record biometric features of a user such as face or perform an iris scan and check it against a fingerprint in the core network 109. This action may be performed during an initial user configuration of the device/UE. This may be an optional authentication layer that may be offered by the cellular system to enhance the authentication procedures.

In an embodiment that may be combined with other embodiments or used independently, the core network 109 (e.g., AUSF/UDM/UDR/PCF) may store a configuration/policy determining whether biometric-enhanced authentication is supported and/or required when performing the initial primary authentication of a UE 100, 103 and/or user 402, 403.

In an embodiment that may be combined with other embodiments or used independently, the user 402, 403 may indicate and/or configure through the UE 100, 103 whether biometric-enhanced authentication is required in subsequent authentication and/or communication and/or sensing procedures when using the UE(s) 100, 103.

In an embodiment that may be combined with other embodiments or used independently, the user 402, 403 may indicate and/or configure through the respective UE 100, 103 whether biometric-enhanced authentication is used in subsequent authentication, communication and/or sensing procedures when using different UE(s) 100, 103. This can allow a user to use his subscription even if he is not using his own UE. The user may need to select a network when using the phone so that the phone can use the correct public key of the network (e.g., PLMN) to protect (e.g., encrypt) the biometric information. If the biometric information matches with the biometric information stored in the network, the user is authenticated and the network may check whether its user profile allows for the usage of the network. If allowed, the network may allow access.

In a related embodiment that may be combined with other embodiments or used independently, since access is required and allowed, a root key may be derived from the secret biometric information, e.g., by applying a key derivation function. This root key can be used to derive other keys in the key hierarchy (such as K_SEAF, K_AMF, or K_gNB as described in TS 33.501).

In a related embodiment that may be combined with other embodiments or used independently, since access is required and allowed, a user identifier or pseudo-identifier may be derived from the secret biometric information, e.g., by applying a key derivation function. This user identifier may play the role of a SUPI, although in this case, it may be called biometric-based subscription permanent identifier (Bio-SUPI) or user-based subscription permanent identifier (USUPI).

In a related embodiment that may be combined with other embodiments or used independently, a user may have a subscription allowing for the usage of a number of UEs, e.g., two UEs (such a smart phone and a smart watch). In an example, the user may then access a first UE with the profile of a smart phone and authenticate with the core network through the smart phone so that that smart phone is then linked to the user's subscription. The user may then access a second UE with the profile of a smart watch and authenticate with the core network through the smart watch so that the smart watch is then linked to the user's subscription. The authentication through a smart device may be based on the user's credentials such as the biometric data of the user. If the user then tries to use a third smart device, e.g., a second smart watch, the network detects that a device is already active, and it will not allow the usage of the second smart watch. Alternatively, the network may allow access to the third smart device e.g., a second smart watch, provided that the user's credentials (i.e., biometric data provided through the third smart device) matches the user's biometric credentials stored by the network. The network may set as part of the user's subscription the number of devices that a user is allowed access from and under which conditions (e.g., device types, number of concurrent/simultaneous links); furthermore, the network may verify, as described in previous embodiments, how correlated are different sensing data from the different devices, and/or whether the devices were part of a multi-authentication procedure or were authenticated separately, and/or whether devices are co-located, such that the network ensures that the third smart device (e.g., the second smart watch) is handled by the user itself.

In a related embodiment that may be combined with other embodiments or used independently, this option may also be applicable to emergency situations wherein a UE may scan the biometrics of a user, protect them (encrypt them) with a public key of the home network, and transfer them to the network. This can allow identifying the user performing the emergency call. The user may have the option to select the network before performing the emergency call so that his biometric information is encrypted with the corresponding public key, and it can be decrypted and matched. This has the advantage of facilitating the match, although it may not always be feasible in emergency situations. Additionally or alternatively, biometric information may be protected with a key of the serving network. The serving network may decrypt and encrypt the received data with a key of other networks so that it can be securely exchanged. The protected biometric information may be routed to multiple networks (e.g., by the serving network) so that a potential match is established. The message including the protected biometric data and emergency request may include a field indicating whether the data needs to be routed to one or multiple home networks (e.g., PLMNs). The serving network may route the biometric information to other networks if it cannot find a match. Finding a match serves the purpose of identifying the user who is performing the emergency call.

In a related embodiment that may be combined with other embodiments or used independently, the user may encrypt the biometric data and may send the encrypted data to the core network. The verification of the biometric data may happen in the encrypted domain, i.e., it may be performed homomorphically similar to “Hyunmin Choi et al., Blind-Touch: Homomorphic Encryption-Based Distributed Neural Network Inference for Privacy-Preserving Fingerprint Authentication” (available online at https://arxiv.org/pdf/2312.11575.pdf). To achieve this, the UE may need to be configured with a public key to encrypt the biometric data. Furthermore, the entity performing the matching may need to be configured with an evaluation key that allows performing the matching or comparison of the biometric data in the encrypted domain. The UE may share the evaluation key with the entity performing the matching as well as a list of potential reference protected biometric data. This can allow a less trusted party, e.g., a serving PLMN or an AF or a sensing NF, to perform the matching of the biometric data in the encrypted domain. The encrypted biometric data provided by the UE to the entity performing the evaluation may include an identifier of the encryption algorithm used, and/or a key identifier used.

In an embodiment that may be combined with other embodiments or used independently, the goal may not be to uniquely identify a user, but to just identify users using a UE without needing to know the actual identity of the user. For instance, the goal may be to ensure that the user is authorized to use the UE and/or particular service(s) and/or to identify the user to optimize the service. This may be considered a user profiling and may be used to learn which type of services the user requires and optimize the provisioning of services. A service may refer to the type of traffic the user requires (e.g., accessing small or big websites, gaming, streaming, emails, VR/AR communication etc.). Given the knowledge of the user behind the UE, the network can optimize the provisioning of services. For instance, two users using the same UE for the same service (e.g., IMS-based VR/AR services extending TS 23.228 Annex AC. 9) may typically communicate with other users that are closer or farther away. Thus, if the network is informed about or is aware of the user ID, the network can provide a better parameter configuration, e.g., an initial predicted end-to-end communication latency that can be used to optimize the user experience by means of predictive models that take into account this latency. From this point of view, a UE may gather biometric information of a user, e.g., by means of the camera, or by means of how the user handles the UE (e.g., based on accelerometer data, or how the user touches the touchscreen), or the type of applications or services used by the user. Once the UE has determined the user behind the UE at a given instant of time, the UE may provide a NF (e.g., AMF or AUSF or session management function (SMF)) in the CN with such information. The network may also provide this information to an AF so that the AF may adapt its operation, e.g., select a user account based on the identified user. In the case of the SMF, the SMF may then adapt the service provisioning and resource provisioning based on the user. The AMF may also provide the gNB providing access to the network with a user profile configuration to optimize the traffic. The UE may generate and assign a pseudonym to the user and use it to identify the user over a period of time/session.

It is to be noted that in the above embodiment as well as other embodiments, a pseudonym or biometric data or other user specific credentials may be used as part of an authentication procedure. This authentication procedure can also be considered as an identification procedure that allows identifying a given user.

It is to be noted that the identifier assigned to an identified user may be generated at random and may be rotated and/or changed according to a policy to avoid tracking, e.g., tracking by the serving network.

It is to be noted that a UE may keep a record of users that used the UE and the way the UE was used. This information may be kept locally or may be shared with the core network in a secure way. Each of these users may be assigned a pseudo-identifier. Additionally, the home network may be enabled to link users' pseudo-identifiers to users' subscriptions e.g., for billing purposes. Note that a user may not have a subscription with the network providing connectivity services to the UE, in which case the network may charge the user associated with the UE according to the subscription profile maintained by the network.

In a further embodiment that may be combined with other embodiments or used independently, a user may have the option to use a UE in incognito mode, i.e., without applying his/her user profile. This may be an option that may be entered in the UE, and shared with the core network, e.g., AMF/SMF, e.g., in a NAS message.

In a further embodiment that may be combined with other embodiments or used independently, the UE/device manufacturer may be able to determine the user accessing the UE, e.g., in a way as an iPhone can be unlocked with the biometrics of the face. This information may be kept local in the phone, or it may be shared with the backend/service of the device manufacturer. The UE/device manufacturer may also profile the user and the type of networking/communication needs. However,
the UE may be able to send an indication to the network about the type of user who is currently using the network. This indication may be sent to the network, AMF/SMF, that may then use this information to optimize the service, additionally or alternatively,
the UE may also provide a pseudo-identifier so that the network, e.g., AMF/SMF, can profile the current user, and use this information to, e.g., optimize the service.

This indication or pseudo-identifier may be exchanged in a NAS message. Additionally or alternatively, it may be shared securely end to end with the home network, e.g., protected with a key derived from a root key shared between UE and the authentication function in the home network. The home network may then decide whether the identity/profile of the user managing the phone/UE may be shared with the serving network or not.

In a further embodiment that may be combined with other embodiments or used independently, a user's biometric data or pseudonym may be exchanged with the AMF via NAS communication. Alternatively, it may be exchanged with the home network e.g., with the UDM, end-to-end protected. The procedure may be similar to Clause 6.15.2 in TS 33.501 (Procedure for UE Parameters Up-date), but the procedure could rather be from UE to UDM, i.e., information flows from the UE to the UDM, so that only the UDM can determine the user behind the UE, and based on the user, optimize the provisioning of services, e.g., as in previous embodiment.

After primary authentication, the home network may share with the AMF the identity (e.g., SUPI) of the device used for primary authentication. In a further embodiment, if user identification is feasible, the identity of the user and/or a user profile may be shared with the AMF (e.g., in a serving network) so that the AMF, interacting with the SMF, can optimize the service, e.g., by provisioning sufficient resources. The user profile allows decoupling a given user identity from the traffic features that are required for the user, for instance, a user may be identified as a first user and the home network may know that this user usually visits social media and watches videos between e.g. 7 and 8 pm, and thus, it may provide the AMF with a user profile related to social media video so that the communication network is optimized for it.

In a further embodiment that may be combined with other embodiments or used independently, the user identification may be done locally at the UE. Once a user is identified, the profiling may also be done locally, e.g., based on historical data or and/an artificial intelligence (AI) or machine learning (ML) model that allows predicting the type of traffic that the identified user will likely generate. Afterwards, the UE may inform the network (e.g., AMF via NAS) about the user/traffic profile that is required. This embodiment is advantageous because it does not require the UE to keep sending the identity of the identified user to the home network, but it allows more local operation. Furthermore, it does not require sharing the identity of the user. For instance, if user 1 is using the phone, the phone may determine that the user will be using social media with video streaming for 15′ and then user_1 will do web browsing for 1 h whereas if user 2 is using the phone, the phone may determine/predict that the user will be reading for 30′ before watching a movie for 45′. The phone may then share the user/traffic profile, namely:
15′ video streaming, 1 h web browsing
30′ reading, 45′ movie watching
This allows the network to provide a better service by tailoring it to users' needs and enables better resource management.

In a further related embodiment that may be combined with other embodiments or used independently, a UE may provide the network (e.g., home network) with information regarding the usage of a UE by an identified user. This allows the network to gather usage statistics related to the identified user and may allow obtaining a user profile model, e.g., an AI/ML model capable of predicting future usage of the UE and UE services/network services by the user. The network may provide the UE with the determined user profile model that the UE may then use to obtain a user profile/predict the required UE/network services when the user is identified. Additionally, or alternatively, the user profile model may be provided to a network function (e.g., AMF or SMF) so that the network function can predict the user profile/the required UE/network services for the identified user. In this case, the UE may need to provide the identity (or pseudo-identity) of the identified user to the network function (e.g., via NAS communication).

In a further embodiment that may be a variant of previous embodiments or combined with them, a device (e.g., the first UE 100 in FIG. 4, that may be a UE or residential gateway) may provide the network with an identity of a device (e.g., the second UE 103 in FIG. 4) connected to it. A residential gateway, RG, may be a device located somewhere, e.g., at a home, and configured to provide access to one or more devices in the deployed location. The identity may be based on an identity of a wireless interface between e.g. the first UE 100 and the second UE 103 in FIG. 4. This identity may be similar to the identity of the identified user in previous embodiments since depending on the identified device (e.g., AR/VR glasses, TV, smart phone, or smart speaker) the provided service can be adapted or optimized, e.g., in terms of latency, bandwidth, or Quality of Service. Therefore, this embodiment can be considered as a variant of or addition to previous embodiments related to device identification.

In a further embodiment that may be a variant of previous embodiments or combined with them, a device (e.g., the first UE 100 of FIG. 4, that may be a UE or residential gateway) may provide the network with an identify of a device (e.g., the second UE 103 in FIG. 4) connected to it plus the identity of the user (e.g., the user 403 of FIG. 4) using the device. For instance, the first UE 100 may use e.g. wireless sensing or a camera to identify the user 403 and may identify the second UE 103 by means of e.g. the identity of a wireless link or by extracting it from the signature of the wireless interface with the second UE 103. The pair of identifiers (i.e., of the second UE 103 and the user 403) may be used to adapt or optimize the service to the identified user 403 via the second UE 103. For example, the first UE 100 may determine that a first user (e.g., Bob) is using AR/VR glasses and share (pseudo)identifiers linked to that user and/or device, and/or user and/or device profiles to the core network to adapt and/or optimize the provided services.

In an embodiment which may be combined with other embodiments, the user may indicate/configure through the UE whether a joint authentication procedure is required when connecting to the network or using a service of the network (e.g., IP multimedia system (IMS) communication) wherein multiple UEs may need to be connected to provide the user with all (a subset of the) requested services. For instance, a metaverse session may involve multiple devices (e.g., glasses, sensors attached to the body, etc). The process to join the network may be by means of a joint authentication procedure as described in previous embodiments.

In an embodiment, the network or an application may indicate and/or configure whether biometric-enhanced and/or multi-factor authentication is required in subsequent authentication and/or communication and/or sensing procedures and the procedures that may be used to enable it.

In an embodiment, the network and/or UE may trigger a configuration step in which the biometrics and/or multi-factor authentication settings of the user are scanned and/or obtained (e.g., by means of wireless sensing or other sensors) by the first UE 100 and/or the second UE 103 of FIG. 4, and securely retrieved and stored in a database 401 (e.g., UDM/UDR) in the core network 109 and/or in a database 404 (e.g., UDM/UDR) of the first UE 100 and/or in a database 405 (e.g., UDM/UDR) of the second UE 103. This information may include a duration for which such biometric information and/or multi-factor authentication settings are valid, e.g., biometrics extracted from the face may be valid for a longer period of time, and/or biometrics related to the current heart rate may be valid for a limited amount of time, or may be context dependent. This information may also indicate whether such biometric information may be used standalone to enable user access through a different UE, or a UE without a SIM. This information may also indicate whether such a biometric information may be used for identification in a wireless sensing system, and the context (e.g., time, location, etc.) where such information may be used with this purpose.

In an embodiment variant, where multi-factor authentication based on multiple (biometric and/or sensed) information elements is performed, the core network and/or UE may perform initial (or extra) checks to verify whether the information elements match and are consistent with a given context. For instance, a user that is performing a demanding physical activity may have an elevated heart rate. This (sensed) biometric information may be matched against data from device sensors (e.g., gyroscope sensor data over a period of time) and the multi-factor authentication information may only be verified upon passing such initial consistency and/or matching checks.

In an embodiment variant, the network and/or UE may look up a local configuration (e.g., from the databases 401 or 404 or 405 in FIG. 4) to verify whether a biometric-enhanced primary authentication/procedure is required, and if so:
first, once the normal primary authentication procedure is performed, the network may optionally request from the UE(s) 100, 103 and/or RAN 106 the performance of biometric scanning, the UE(s) 100, 103 and/or 106 RAN may then perform the biometric scanning, and the UEs 100, 103 and/or RAN 106 may send the biometric data to the core network for validation against the stored and/or authorized biometric data, and/or
second, the UE(s) 100, 103 may trigger a biometric-enhanced authentication and/or authorization process and share the authentication data as soon as the primary authentication process is successful and a secure channel has been established.

Note that the biometric data may also be shared earlier, e.g., if protected with the public-key of the network (e.g., PLMN). This sharing may be done, e.g., during the primary authentication. Note that multiple UEs (e.g., the first and second UEs 100, 103) may cooperate to perform the biometric scanning.

Note also that the biometric data may include raw (e.g. picture of face) and/or processed sensor data (e.g. facial recognition pattern/point cloud) and/or a resulting identifier of the user matching a user authentication method based on biometric scanning locally performed at the UE.

Note also that the same biometric scanning may be used for both local user authentication at the UE and for user authentication with the network. For example, the camera for face recognition could be used to unlock the phone and then whilst camera still on use face recognition e.g. after primary authentication or after specific time period (e.g. 2 seconds later) again to generate key or provide biometric data to authenticate to the network.

In an embodiment, the network and/or UE may look up a local configuration (e.g., from the databases 401 or 404 or 405 in FIG. 4) to verify whether a multi-factor authentication-enhanced primary authentication/procedure is required, and if so:
perform a multi-factor enhanced primary authentication procedure, e.g., similar to FIG. 6, wherein the multi-factor may refer to the fact of using two or more devices in the primary authentication procedure, and/or
the network may trigger a network-triggered multi-factor authentication procedure where the network requires the first and/or second UEs 100, 103 to reauthenticate as a means to revalidate the user by using a multiple-factor authentication procedure and/or biometric information.

In an embodiment which may be combined with other embodiments or used independently, the biometric-enhanced and/or multi-factor enhanced primary authentication (e.g., as in previous embodiments) or user identification/authentication may be required to be executed in a periodic or random manner, e.g., every 15 minutes, or once per time interval (e.g., 1 h) at random points of time, wherein this configuration may be stored in the network, e.g., in the database 401 of FIG. 4 which may be a 5G UDM, or every time the UE(s) are used and/or touched. This ensures that the network knows which user is handling the UE.

In another embodiment that may be combined with other embodiments or used independently, the periodicity of re-authentication/re-identification may be based on the user's preference. For instance, a user with a UE/subscription that is associated with one user identity (i.e., belonging to said user) may not require user re-authentication/re-identification during a connectivity session, whereas a user with a UE/subscription that may be associated with multiple user identities may require re-authentication/re-identification more frequently. This may be configurable by an AF or the core network. It may be configurable as part of a configuration, policy, rules, etc.

In another embodiment that may be combined with other embodiments or used independently, the periodicity of re-authentication may further depend on the UE's local authentication capabilities/method. For instance, a UE performing local user authentication through biometrics e.g., using facial recognition, does not require an action to be performed by the user and re-authentication may be performed much more frequently, whereas fingerprint-based biometric authentication or credentials (username/password) based authentication require the user to provide its fingerprint/credentials, in which case re-authentication may be performed less frequently.

In another embodiment that may be combined with other embodiments or used independently, in the event that a re-authentication/re-identification of a user fails (e.g., due to user change), the UE may send an authentication error message to the network indicating user change e.g., that the authenticated (e.g., through biometrics) user is different from the user for which the connectivity session was established. Additionally, or alternatively, in the event that a re-authentication/re-identification of a user fails due to UE malfunction (e.g., fingerprint sensor/facial recognition malfunction), the UE may send an authentication error message to the network indicating that the UE no longer supports the local (biometric) user authentication capability which malfunctioned. Additionally, or alternatively, in case of failure/malfunction of a local authentication method, the UE may perform re-authentication using an alternative local authentication method (e.g., based on credentials) and provide the authentication result to the network, in addition to an indication of the switch from one local authentication method to another (e.g., instead of sending an authentication error message). Additionally or alternatively, a failure of local identification/authentication may also trigger an identification/authorization procedure in which the core network and/or AF are involved. Additionally or alternatively, the identification/authentication may also be performed with a NF in the core network and/or AF (e.g., an AAA server). In case that the identification/authentication succeeds, the AF may provide the NF with the corresponding identity. However, if the identification/authentication fails, the AF may provide a failure message. The core network and/or UE and/or UE may log the event. The core network may have a policy determining the actions to perform, e.g., request the re-identification of the user, fall back to a generic user profile, etc

In an embodiment, which may be combined with other embodiments or used independently, that aims at avoiding periodic enhanced user re-identification re-authentication, the network may configure the UE with a policy to perform a local check based on biometric data that was used in the last successful biometric-enhanced authentication procedure. In case of a local check, the user data may be stored in a secure manner in the UE, e.g., protecting it with a key, e.g., derived from a PIN configured by the user after the last successful biometric-enhanced authentication procedure. The user may then need to enter this PIN to re-perform the local-enhanced authentication procedure (e.g., based on the PIN, the stored user biometrics may be decrypted and the stored user biometrics may be compared with the currently measured user biometrics).

In a related embodiment that may be combined with other embodiments or used independently, this policy may determine one or more of how many attempts may be allowed, how long that data can be stored on the UE with the purpose of this local check, or a context the UE needs to be in to avoid the (local or not) enhanced user authentication. In some cases, the context the UE needs to be in may refer to measurements that are indicative that the same user is using the UE, e.g., if sensor (e. g, accelerometer) measurements at the UE are indicative that the same user is or keeps using the UE.

In general, it is described a method for user re-identification and/or re-authentication that can be implemented in a user equipment wherein the method is adapted to:
monitor an event that may trigger the (re-)identification and/or (re-)authentication of the user,
obtain information to (re-)identify and/or (re-)authenticate the user,
perform a local (re-)identification and/or (re-)authentication of the user based on:
   a local procedure wherein the obtained information is checked against a local data base;
   a remote procedure with a core network or application wherein the obtained information is shared with the core network or application.

In a related embodiment which may be combined with other embodiments or used independently, the UE may perform primary authentication with the core network and depending on, e.g., the outcome of the primary authentication and/or the user subscription in the UDM and/or information gathered from the UE (e.g., UE capabilities) and/or information about the trust level on the UE (e.g., based on device attestation as per other embodiments), the core network or application function may determine whether it may trust a user identity or user authentication result provided by the UE (based on local operation) or whether it requires an additional identification/authentication/authorization procedure through and/or with the core network and/or AF. In this second case it may trigger the identification/authentication/authorization procedure that may be based, e.g., on the Extensible Authentication Protocol (EAP), and run between UE and a network function in the core network or an application function.

In an embodiment which may be combined with other embodiments or used independently, user identification/authentication, e.g., biometric-enhanced authentication, may be required (e.g., triggered by an end user and or by an entity in the core network, e.g., the database 401 of FIG. 4, based on a policy) before/while providing a given service, e.g., performing a call over a cellular system between a local user and a remote user (e.g., the local user 402 using the first UE 100 and the remote user 403 using the second UE 103 as per FIG. 4). The user identification/authentication may also be done periodically based on a network policy. In a particular example, if the call is avatar-enhanced so that local user 402 and the remote user 403 only see/observe their avatar representations, and not their physical presence, the users may lack means to actually verify the other user as it is done in standard video/calls, i.e., by seeing the other person or by listening to the voice of the other person. This embodiment is therefore advantageous to ensure/provide a means to verify that the local user 402 and the remote user 403 are who they claimed to be, and not a different user (or attacker) faking one of them. In this embodiment, the provided service may refer to an IMS-based call or a call based on a real-time communication service, e.g., using an avatar, e.g., extending the AR/VR framework in TS 23.228 Annex AC.9. In this embodiment, a user (e.g., the local user 402 or the remote user 403) may request the core network 109 (e.g., based on information (a policy) stored in the database 401) to perform the biometric-enhanced authentication of the remote user before/while performing the call, or the core network 109 may trigger such a verification process based on a configuration. The following steps may apply:
in a step, the local user 402 may receive an incoming call from the remote user 403.

In an additional step, the local user 402 (and/or the remote user 403) may have subscribed to a service for biometric user verification, so that the core network 109 (e.g., based on information stored in the database 401) triggers the biometric-enhanced authentication by requesting the remote UE (e.g., the second UE 103) to perform such biometric-enhanced authentication, wherein the handling of such a biometric-enhanced authentication may be done locally, e.g., based on information stored in the database 405, e.g., as described in above embodiments. Note that multiple UEs may also be involved in the biometric user verification as explained in other embodiments.

In an additional step, the remote UE (e.g., the second UE 103) may then securely share the biometric data of the remote user 403, e.g., through the database 405, with the core network 109, e.g., with the database 401 which can then analyze whether there is a biometric match and perform one or more actions based on a policy, e.g.: (1) provide the local user 402 with feedback with regard to the biometric verification, and/or (2) control the connection, e.g., drop the connection if the biometric authentication fails, and the policy requires it.

It is to be noted that the above procedure enabling an avatar-based communication may refer to AR/VR communication or metaverse communications. This may also apply to the provisioning of other services, e.g., establishment of a given data communication.

In a further embodiment, the user identification and/or authentication procedure may be performed every time the UE gets in a given state (e.g., a connected state) or is about to perform a given action (e.g., start transmitting data for a new data session). This may be based on a configuration selected by the user (e.g., dependent on the user subscription) and/or network. This may be a configuration stored locally in the UE. This may also be done on request by the network (e.g., the AMF) when the network detects that the UE becomes active and/or starts transmitting data.

In a further embodiment that may be used independently or combined with other embodiments, the user identification may also be enhanced with user authentication to further increase the security level of a UE. For instance, the home network may request a UE to lock itself if the user handling the UE is not recognized. The home network may also request capturing user data, e.g., biometric data such as a picture of the user face, in case that a user cannot be identified.

In a further embodiment that may be used independently or combined with other embodiments, the user identification may also be enhanced with user authorization to further increase the security level of a UE. For instance, the home network may request a UE or network function (SMF) to only allow certain actions by certain users. For instance, a user identified as a kid may not be allowed to make usage of certain services or access data from certain websites.

In an embodiment, the user biometric authentication of a first user using a first UE may be performed by a second user using a second UE. However, in this case, the second user and/or UE needs to have access to the actual information of the first user, e.g., the actual image of the user's face to perform facial recognition. Thus, the second user may request the first user and/or UE to perform the encoding of the first user's biometrics' information, e.g., face, in a way suitable for biometric recognition, e.g., it may not apply any type of encoding or compressing, e.g., AI/ML based, e.g., generative AI based, approach to the face. This may imply a request sent by the second user and/or UE to the first user and/or UE and/or the core network. This may require the configuration of a policy in/for the first user and/or UE specifying which information should be exchanged in a biometrics friendly manner, when, and how, i.e., which information should be exchanged to enable the biometric verification of the user.

Some of the embodiments and embodiment variants show that the authentication and/or authorization capabilities go beyond what is feasible in current cellular networks where multiple types of authentication/authorization procedures are performed including one or more of:
subscription authentication (e.g., the serving network shall authenticate the subscription permanent identifier (SUPI) in the process of authentication and key agreement between UE and network),
serving network authentication (e.g., the UE shall implicitly authenticate the serving network identifier where the meaning of ‘implicit’ here is that authentication is provided through successful use of keys resulting from authentication and/or key agreement in subsequent procedures),
UE authentication (e.g., the serving network shall authorize the UE through the subscription profile obtained from the home network and UE authorization is based on the authenticated SUPI),
serving network authorization (e.g., assurance shall be provided to the UE that it is connected to a serving network that is authorized by the home network to provide services to the UE), or
access network authorization (e.g., assurance shall be provided to the UE that it is connected to an access network that is authorized by the serving network to provide services to the UE).

In particular, the user identification and/or authentication, e.g., biometric based user identification and/or authentication, may be used to enable user authentication and/or authorization when using one or more services. Which services may be allowed may depend on a policy configured in the core network, wherein the policy may be bound to the subscription or may be configurable by the user. A user may for instance configure which services may be accessible to anyone using the UE (e.g., emergency services, phone calls in the city, etc.) and which services may not be accessible to certain users using the UE (e.g., internet access or IMS calls to kids disallowed).

In a further related embodiment that may be combined with other embodiments or used independently, a UE and/or a user using the UE may have been identified and/or authenticated and/or authorized as a specific device and/or user, and/or specific device and/or user type. For instance, a user/UE may have been identified as a user requiring a specific type of service, and the service being in the user subscription. In this event, the core network may inform the service network (e.g., a network function such as AMF or SMF or UPF) about the specific type of device/user and a specific service profile that should be enabled or provided. For instance, the AMF may receive the user identity or device type or service profile, e.g., after successful primary authentication and user identification as in other embodiments. This can be used by a network function to adapt the service and optimize the service. For instance, the AMF may share this information with the SMF. Similarly, the access network may also be informed about the user/device and the specific service profile that should be enabled or provided. For instance, the AMF may inform the RAN that about the current service profile. The RAN may use this information to optimize the RAN services (e.g., communication or sensing services, e.g., to optimize the communication service to guarantee very low latency for a user). For instance, the RAN may store a mapping between the UE (used by the user) identity (e.g., RNTI) and the service profile. The service profile may then be used to optimize radio resource allocation to fulfil the service requirements. For instance, the service profile may be used to set a specific target Quality of Service in the RAN. For example, if the user is profiled as usually keeping his phone at a fixed position, RAN may use it to optimize how beam management is performed. Similarly, a UE may be informed about the user profile. The UE may use this information to optimize its performance, e.g., RAN communication such as beam management. The reason is that once users are identified, it is possible to analyze how the users use their mobile devices (e.g., how static the devices remain, where and for how long they are likely to be located, etc). This information that can be considered as a “UE usage profile” can be used to adapt communication parameters, e.g., how frequently measurements reports are performed and/or behavior e.g., a phone that is usually kept in a fixed position, if moved, may be triggered to send a message (or several (periodic) messages) to provide the network with supplementary information e.g., about its movement and/or location information. For instance, given the “UE usage profile” it may be possible to use it together with an AI/ML model and/or other techniques to predict how the UE will be used, and which RAN actions may be needed. For instance, if a UE (e.g., car) is being used by User 1, and User 1 usually goes to work by car, a paging message may be routed to a base station close to the work of User 1.

In general, it is described an apparatus for managing a connection, wherein the apparatus is configured to:
select one of a plurality of authentication procedures;
perform the selected authentication procedure with a core network; and
set up the connection when the selected authentication procedure succeeds.

In general, the apparatus for managing a connection is adapted to:
receive a configuration, from a network function, in a configuration message indicating a user profile and optionally a UE usage profile,
store the user profile and optionally the UE usage profile and a RAN identity,
adapt, based on the configuration, the selection of communication parameters associated to the RAN identity wherein the communication parameters are used in a communication link between RAN and UE.

In a related embodiment that may be combined with other embodiments or used independently, the user identification and/or authentication and/or authorization may be linked to the usage of a given service (e.g., IMS), or it may be provided as a service to a function, e.g., an application function.

For instance, an architecture for authentication and key management for applications (AKMA) (such as the one described in TS 33.535) may be extended to request guarantees on enhanced user identification/authentication (e.g., biometric-based user authentication). For instance, when an AF, e.g., a bank, uses such an AKMA, the AF may request performing enhanced user authentication to the core network, e.g., an AKMA anchor function (AAnF). The AAnF may then either retrieve the current user using the UE and/or trigger/request an enhanced user authentication procedure to verify that the “target” user is currently using the UE. The AAnF may eventually provide a user confirmation to the AF (in the case of AKMA, together with the corresponding K_AF as per TS 33.535). When the AAnF triggers or requests a user authentication procedure, this process may signal a request to trigger the authentication information of the current user. This authentication information may be related to the biometrics of the user (e.g., face, way of handling the UE, etc.) or may be based on something known to the users (e.g., a password) or may be based on something owned by the user (e.g., another UE such as an ambient IoT tag or a smart watch). This provides enhanced guarantees on the user that is using the UE when a specific application is used.

For instance, a service, e.g., IMS, may involve a UE sending a message such as the SIP INVITE message may include a request for remote user identification. This message may also include information (biometrics, password, etc) about the current user handling the UE/using the service/requesting the service. This information may facilitate the identification of the user. This information may be used by the service (e.g., IMS network) to negotiate and/or facilitate the user identification whereby information used to verify/authenticate the user identity. The service may request the core network to validate/authenticate the user identity, e.g., may share information received in the message to validate it. For instance, it may request an AF/identity provider (e.g., Google, Apple, etc) to support the validation of the user identity. Once user identities are validated, the service may progress or other actions may be taken, e.g., the authorization of the storage or usage of Avatar models in the IMS communication as described in other embodiments.

In a related embodiment, the user may also trigger the enhanced user identification/authentication. For instance, an initial AKMA message (e.g., an application session establishment request, such as the one defined in Clause 6.2.1 in TS 33.535) may be sent by the UE to the AF and may include either a request for the enhanced user authentication or data that may allow for the enhanced user authentication. In other words, the initial service request may include some user specific identification information (e.g., biometrics captured by the UE or a user PIN), e.g., if the UE allows it (e.g., based on a policy) and/or the application/service requires it. This allows performing the user identification/authentication check as soon as the request is received without involving any later protocol interactions.

Some scenarios may involve a multi-user authentication scenario, in which two or more users need to communicate with each other and verify their identities, e.g., biometric identities, to access a shared resource or service. For example, a bank account may require the biometric authentication of both the account holder and the authorized user to perform a transaction. In this case, the first user and/or UE may encode and transmit the biometric information of the first user to the second user and/or UE, and the second user and/or UE may perform the biometric authentication of the first user using the received information. Alternatively, or additionally, the second user and/or UE may encode and transmit the biometric information of the second user to the first user and/or UE, and the first user and/or UE may perform the biometric authentication of the second user using the received information. Additionally, or alternatively, both users and/or UEs may encode and transmit their identification information, e.g., biometric information to, e.g., a NF in the core network that may perform the identity verification, e.g., biometric authentication, and if successful, give an indication to, e.g., the users or a network function, or an application function (e.g., representing the bank service in this example). In either case, the biometric authentication of both users may be performed locally or remotely, depending on the policy and the availability of the network.

In some scenarios, a user receives a one-time authentication code via SMS to have access to some resources. For instance, a UE may unlock when the face of a user registered by the camera of the UE is detected. However, this is not sufficient when multiple users need to be authenticated to perform an action or when the security requirements need to increase. In a related multi-user authentication, multiple UEs may be required to be involved in an authentication procedure to perform an action. This multiple user and/or UE authentication procedure may be coordinated and/or signaled by the communication network. For instance, a real time communication (e.g., IMS call) between multiple users may only start once all users are (biometrically) authenticated. For instance, in a multiple-user real-time communication (e.g., IMS call) when two or more users are collocated, their biometrics may be jointly verified to reduce the risk of user impersonation or misuse of resources. In an embodiment that may be combined with other embodiments or used independently, a UE may have a (U)SIM that may contain UE information related to the credentials required for the UE to register in the network (e.g., SUPI) and User information required to determine how the user can be identified, authenticated, and authorized. A user may unlock a SIM card/USIM with a first PIN code that may be provided by the user or stored in a user equipment (UE) and may access certain user specific information in the SIM card with a second PIN code that may be different from the first PIN code and may be provided by the user. This may enable the user to use the same SIM card for different purposes without compromising the security or privacy of the information stored in the SIM card. In some cases, the UE information may be in a UE SIM and the user information may be in a User SIM. For example, the user may insert the SIM card into the UE and power on the UE. The UE may then request the user to enter the first PIN code or may retrieve the first PIN code from its memory, and may send the first PIN code to the SIM card. The SIM card may compare the received PIN code with the one that is stored in the SIM card and, if they match, unlock the SIM card and UE information and allow the UE to access the basic services of the network, such as voice calls, SMS, or data connection. The UE may store the first PIN code securely in its memory, e.g., using encryption or hashing techniques, or may not store it at all and may request it from the user every time the UE is powered on, or the SIM card is inserted. The user may wish to access some additional User information or enable user specific functionalities (e.g., optimize traffic based on the user identify) by means of user information that is stored in the SIM card, such as user credentials, biometrics, or certificates. This user information may be sensitive or confidential, and may be used for an user authentication and authorization procedure with/through the core network, and the user may not want to share it with anyone else who may use the same UE or SIM card. Therefore, the user may set/use a second PIN code, which may be different from the first PIN code, and associate it with the User information that the user wants to protect, such user specific identification, authentication, and/or authorization information. The user may also specify the conditions under which the second PIN code is required, e.g., every time the user accesses the information, after a certain period of inactivity, or when the UE or SIM card is changed. This User information may also be in a different User SIM.

When the user tries to access or use the protected user information, e.g., to enable a given user specific service, the UE may prompt the user to enter the second PIN code that is associated with the information. The UE may then send the entered PIN code to the SIM card, which may compare it with the one that is stored in the SIM card and, if they match, allow the UE to access the information instead of a PIN, the SIM card may unlock itself based on the biometrics of the user. Alternatively, the second PIN may be based on the biometrics of the user (e.g., a function of the biometric data), such that upon UE successfully checking the biometric data (e.g., fingerprint, face, etc.) to the stored user biometric data in the UE, the UE may generate the second PIN and then send it to the SIM which compares it with the one it has in store. The UE may not store the second PIN code that is entered by the user or generated based on the biometrics of the user and may erase it from its memory as soon as the transaction is completed. Alternatively, or additionally, the UE may encrypt the second PIN code that is entered by the user and store it temporarily in its memory and decrypt it only when it is needed to access the information.

The User information in the SIM may also be stored in a database in a cellular system such as the UDR.

A UE may for instance have a UE SIM having UE credentials, e.g., SUPI and related keying materials, and one or more user SIMs (including eSIMs), each of them having user credentials, e.g., user identity, user identifier, user identification profile, and/or keying materials and/or biometrics associated to a user.

When a UE is powered on, the UE may check for the presence of a UE SIM, and if available, ask the user to unlock it, and perform the network registration, and primary authentication. Furthermore, the UE may check for the presence of a User SIM, and if available, ask the user to unlock it, and perform the corresponding user identification, authentication, and/or authorization procedure.

In some cases, the UE SIM may only be unlocked and/or certain functionalities may be available, if the user SIM is available and/or unlocked.

In some cases, the user SIM may only be unlocked and/or certain functionalities may be available, if the UE SIM is available and/or unlocked.

In some cases, if a cellular subscription is extended with a new user, a new User SIM may be configured in the UE, and/or the SIM may be updated to contain information about the new added user.

In some cases, the User SIM may lock itself if it detects that the user handling the UE has changed and/or some time has elapsed. This locking action may lock information, e.g., secrets, that may be required to control the connection.

In some cases, when the User SIM is unlocked, the unlocking procedure triggers an identification/authentication/authorization procedure with the core network to authenticate the user.

The authentication procedure may be:
A normal authentication procedure in which the User SIM needs to authenticate itself and authenticate the core network when no security context is present. For instance, it may perform an authentication procedure similar to primary authentication; and/or
A fast authentication procedure in which the User SIM/UE identifies/authenticates itself when a security context is present. For instance, the user may be identified by a temporary identifier (e.g., GUTI) that may be stored at the AMF. The User SIM may send the current GUTI to the AMF.

Which identification/authentication/authorization procedure is performed depends on the available (e.g., security) context available/stored in the User SIM/UE.

In some cases, the user identity may be a SUPI. The User SIM may include an indication, e.g., a flag, indicating that it is a user identity and/or a UE. The User SIM may only be unlocked if it is used in a specific device or in combination with a specific UE SIM. Thus, the User SIM may include the identity of the UE SIM (e.g. SUPI) it is allowed to be used with and the User SIM may check whether an allowed UE SIM is in the same mobile equipment before performing the User identification/authentication/authorization procedure.

In an embodiment aimed at enhancing Emergency services that may be combined with other embodiments or used independently, a UE capable of taking biometric measurements (e.g., fingerprint, face, heart/breathing rate, etc) and/or supports a User SIM, may provide user information to the network during an emergency session to assist emergency services providers (e.g., dispatchers/rescuers) in identifying the person in need of help and/or provide them with emergency supplementary information (e. g, medical information such as blood type, allergies, etc). Such information may be provided by the user to the network during a setup stage (e.g., configuration of the User SIM), and preferences for when such information, or which type of information may be used (e.g., sent to the emergency services providers) may also be indicated by the user as part of their preference and/or upon request (e.g., during emergency communication establishment). Upon receiving an emergency request, which may contain protected user information and/or protected user identity and/or protected emergency supplementary information, the network may try to retrieve the emergency supplementary information (e.g., medication information such as blood type, allergies, etc), if any and if not provided in the request, and include it in the emergency message sent to the emergency services providers (e.g., emergency responders).

In an embodiment that may be combined with other embodiments or used independently, the UE may be (pre-)configured (e.g., by the User and/or the network) to attach the User Identity of the user requesting emergency services to the emergency request by default, or under certain conditions. For instance, the UE may perform biometric measurements (e.g., face) to try and identify the user requesting emergency services, and depending on an emergency policy e.g., only if the biometric check is successful (e.g., against biometric data stored on the UE and/or on the USIM, the UE may include the User Identity in the emergency request. For instance, the UE may be configured to perform biometric measurements and try to identify the user, but regardless of whether the biometric check is successful or not, the UE may still include the biometric measurement, or a function thereof, in the emergency request, such that when received by the network, this latter attempts to identify the user to whom the biometric measurements may belong. This has the advantage of making it possible to identify the User requesting emergency services regardless of whether the device used to request emergency services belongs to them or not.

In an embodiment that may be combined with other embodiments or used independently, the User Identity and/or biometric measurements, if included in the emergency request, may be protected using the Home Network's public key, or a long-term key associated with the User SIM, or a key derived from it, or an emergency specific key (pre-)configured/provisioned at the UE. In case the UE has neither a User SIM, nor a UE SIM, nor an emergency specific key, it may be left to an emergency policy and/or user preferences whether it is allowed to send the User Identity and/or biometric measurements with null ciphering/integrity protection. For instance, during emergency communication link establishment, the user may be prompted with a message which asks for the user's permission to share the User Identity and/or biometric information/measurements with the network unprotected. If the user permits it, said information may be sent unprotected, and if not, the emergency request may be a generic one (i.e., user agnostic).

In an embodiment that may be combined with other embodiments or used independently, the User SIM may store user specific emergency information for emergency situations, e.g., emergency contact or medical data. This specific emergency information may be shared in emergency situations. Additionally or alternatively, the User SIM may store information (e.g., a secret or an identifier) that may allow accessing certain specific emergency information that may be stored on the mobile equipment where the User SIM is installed. For instance, the User SIM may include a secret that can be used to decrypt certain specific emergency information such as the medical history stored in the mobile equipment. For instance, the User SIM may include the identify of an emergency contact whose information is located on the mobile equipment.

In general, it is described an apparatus for managing a connection, wherein the apparatus is configured to:
select one of a plurality of authentication procedures;
perform the selected authentication procedure with a core network; and
set up the connection when the selected authentication procedure succeeds.

Above apparatus is further adapted to identifying and authenticating a user by:
receiving a SIM, prior to the selection of one of a plurality of authentication procedures, wherein the SIM is adapted to store user identification and authentication information,
supporting, prior to the selection of one of a plurality of authentication procedures, the unlocking of the SIM using a user specific PIN and/or user specific biological measurements or physical characteristics (e.g., biometrics), and
using the user identification and authentication information, when performing the selected authentication procedure, to identity and authenticate the user with a core network.

In some scenarios, the core network and/or an AF may rely on the UE to perform the identification/authentication/authorization of a user, e.g., as in other embodiments. However, the UE may be compromised (e.g., hacked) and thus the core network or an AF may not fully trust it. To address this problem, in an embodiment that may be combined with other embodiments or used independently, the core network and/or AF may rely on device attestation techniques to evaluate whether:
the core network and/or AF may rely on the result of a local identification/authentication/authorization procedure performed by the UE, or
the core network and/or AF may not rely on the result of a local identification/authentication/authorization procedure performed by the UE, or the core network and/or AF may rely on a combined identification/authentication/authorization procedure performed by both the UE and core network/application function.

In a related embodiment that may be combined with other embodiments or used independently, a UE may include a module to allow performing device attestation. This module may be a hardware secure module that may be embedded in the UE hardware, e.g., an embedded Universal integrated circuit card capable of storing an eSIM or a secure element that may be able to store credentials or applications in a secure manner. This module may be a CPU that may have a trusted environment such as Arm TrustZone technology that provides hardware-enforced isolation and security. An application may be an application that computes the fingerprint (e.g., the hash function) certain memory areas storing the code used to obtain the identity of the user and/or authenticate the user, e.g., when such identification or authentication is done locally. The fingerprint may be computed on demand, e.g., when requested by the core network and/or application function, or regularly or according to a policy/configuration. The fingerprint may be compared with a second fingerprint of the memory areas storing the correct/trusted code, wherein the second fingerprint may be securely stored in the hardware secure module. Additionally, or alternatively, the core network or application function may send a request to the hardware secure module to obtain the fingerprint of certain memory areas that need to be verified. The hardware secure module may obtain the fingerprint and return it to the core network and/or application function for verification.

In a related embodiment, an application may be installed/configured on the device (e.g. by the manufacturer or the MNO before the device is deployed in the field or may be installed by the user later) that will be executed in the hardware secure module, whereby the application may be able to securely communicate the fingerprint related to device attestation or other data (e.g. result of a user authentication or a key derivation performed by the hardware secure module) to the network.

Additionally or alternatively, the USIM has a secure interface with the hardware secure module, e.g. to securely exchange messages, to enable that a USIM application can obtain the fingerprint related to device attestation or other data (e.g. result of a user authentication or a key derivation performed by the hardware secure module), so that the USIM application can use this information in a secure capability exchange with the network and/or in a user authentication procedure with the network, and/or whereby the USIM application may be used to relay traffic between the hardware secure module and the core network or to determine further actions locally (e.g., if the device attestation result fails, the USIM may lock itself).

Additionally or alternatively, the USIM may trigger/perform the device attestation step.

Additionally or alternatively, before transmitting the fingerprint and/or other results of the device attestation performed at the device to the core network and/or application function, the fingerprint and/or other results of the device attestation may be protected (e.g., encrypted and/or integrity protected) by a key, e.g., a pre-shared key (or derived from it) stored in a device's hardware secure module or the device's USIM, whereby the pre-shared key may be provided and/or stored by a certificate authority responsible for the initial device attestation (e.g. device manufacturer and/or certified test center).

Additionally or alternatively, a certificate authority may provide a private key and/or a public/private key pair to be stored in a device's hardware secure module or the device's USIM, and may also issue a client certificate (e.g. using ACME protocol). These private key and/or public/private key pair and client certificate can be used to cryptographically verify the device is genuine during an authentication procedure. The pre-shared key or private/public key may not be provided, signed and/or stored unless the device has passed a set of tests to confirm that the device performs the security protocols and other protocols to connect to the 5G core network properly as required by the MNO and/or that the device is properly hardened against attacks and/or that one or more of its user authentication methods (e.g. fingerprint recognition, face recognition) works properly and can be trusted. The device may only transmit the fingerprint and/or other results of the device attestation if the receiving party (e.g. core network) can be properly authenticated by the device (e.g. by using a key, e.g., based on 5G Kausf and/or by performing mutual public key-based authentication). Based on the received device attestation fingerprint and/or other results of the device attestation, the core network and/or application can retrieve the device's capabilities, e.g. from a database. In a related embodiment (UIA_1) that may be combined with other embodiments or used independently, the core network and/or AF retrieves information about the UE, e.g., UE capabilities, to assess whether the UE is trusted or not. The UE may include its capability for user identification/authentication as part of the UE capabilities in a message, e.g., registration request. The UE capabilities for user authentication/identification may include the local authentication methods supported by the device e.g., biometric-based such as fingerprint identification or facial recognition, credentials-based such as PIN or password lock, graphical password-based such as pattern lock, or support for re-authentication/re-identification via a secondary UE (e.g., wearable) such as a smart watch/ring that is associated with the first UE.

In a further related embodiment, the set of capabilities may also include information about the user authentication method used for unlocking the device and/or the device's SIM. Additionally or alternatively, the device may inform the network (e.g. through updated UE capabilities or separate message or via an AF/NEF) if the user changes the user authentication method used for unlocking the device and/or the device's SIM (e.g. in case the registration of the user that is using the device or the user authentication method relies on the device's local authentication to unlock the device and/or the device's SIM, e.g. if the UE only includes the resulting user identity from a local user authentication method in a registration request).

Additionally or alternatively, the set of capabilities may include information about user consent to use a particular user authentication method by the core network and/or application function, whereby the user consent may be provided/configured differently for different PLMNs, different network services or different applications. The user consent settings/configuration may include a flag whether or not notification to the user is required/requested, whereby if required/requested the user may be shown a notification to confirm that the respective user authentication method can be used, before the respective user authentication method is invoked. The user consent settings/configuration may be part of a privacy profile that may be stored in the UDM/UDR, i.e. as part of a UE's subscription and/or may be stored per user as part of a user database or as part of user information linked to a set of subscriptions in the UDM/UDR. The core network and/or application function may retrieve the privacy profile and/or received user consent information and apply the user consent settings/configuration related to the user authentication methods to determine which user authentication methods it may use and which ones it may not. The user consent may also include whether the user authorizes sharing his (fully) identity with third parties, e.g., with the serving network or rather a user profile.

As mentioned, the core network may apply a user authentication policy that may include amongst others user authentication methods applicable or required to access different services and/or a user consent to use a predetermined authentication method. The core network and/or application function may use the retrieved/received UE capabilities to determine if the device has sufficient capabilities to perform user identification to access the services available to a particular user and/or make use of the differentiated handling per user (e.g. QoS settings applied per user) offered by the core network and/or application function and/or whether or not it has user consent to use a particular user authentication method. If not, only the default services and/or default QoS (e.g. for all devices or for a particular device, but not per user) may be made available, or a message (e.g. error message) may be provided to the device upon device registration, or when starting a PDU session or when accessing a particular service and/or application.

Additionally or alternatively, the core network may provide a similar user authentication policy to the device (e.g. upon device registration or starting a PDU session), based on which the device may determine which services/applications the device is able to access and/or which ones not. The policy may also be used by the device to determine which user identification method to use for each service or application, since some services/applications may require more advanced user identification methods than others. The user identification methods may be prioritized as part of such user authentication policy on the device and/or core network.

Additionally or alternatively, a combination of user identification methods may be required (e.g. fingerprint and RF based sensing) to gain access to a set of services/applications. Combinations of user methods may also be prioritized. Additionally or alternatively, the core network and/or device selects/configures one of the user identification methods or a minimum user identification method (e.g. supporting fingerprint recognition at a certain resolution or having a certain confidence level, as minimum level) or a combination of user authentication methods, that is required to enable access to all or an identifiable subset of services and/or applications (e.g. based on a prioritized list of user authentication methods).

Additionally or alternatively, an application function may determine also some of the actions (e.g., the user identification methods used) and may communicate them to a core network/UE, either directly or indirectly. For instance, an application function in charge of identity management may be able to steer the identification/authentication capabilities of a UE, and may communicate/configure them according to the needs of a core network and the requirements of the core network that may have been communicated to the UE and/or application function.

Furthermore, in the core network each service or application function (or set of services/applications) may be registered/configured with or may configure a set of acceptable user identification methods and/or a minimum user identification method that the device has to support in order to gain access to the respective service and/or application function.

Additionally or alternatively, each service or application function (or set of services/applications) may require (e.g. as part of their configuration or configured as part of the user authentication policy in the core network and/or the device) additional security measures to be supported, e.g. by requiring the use of device attestation, by requiring periodic authentication or verification of the user and/or by indicating whether device unlocking or SIM unlocking using a user authentication method is sufficient or insufficient (whereby in case it is insufficient, the user may be required/requested to authenticate again or with a different authentication method). Furthermore, each service or application function (or set of services/applications) may be configured as part of the user authentication policy or require as part of their configuration whether primary authentication of the device using a UE's USIM credentials (i.e. as in legacy 5G primary authentication) is required or not in addition to one or more or minimum user authentication methods (whereby the user authentication methods may be applied during an authentication exchange (e.g. in addition/subsequent to primary authentication) or be part of biometric-enhanced primary authentication procedure).

In an embodiment that may be combined with other embodiments or used independently, if the above is configured as part of a user authentication policy on the device, then the device may skip primary device authentication and/or may include a parameter that indicates that it can/will skip primary device authentication in the initial message exchange with the core network (e.g. as part of registration request message) or during the security exchange with the core network (e.g. as part of the identity response message or authentication response). Skipping primary authentication may also be done based on the configuration of the core network and when a user keeps using a UE. In this case, the re-authentication of the UE by means of primary authentication may not be required, and only the user may be re-authenticated. The re-authentication of the user by means of the same UE serves as a proof of the usage of the same UE and user. This couple of UE/user may be stored in a data function in the core network and when the primary authentication is skipped, the user authentication procedure may be accepted if it matches the pair of UE/user. For instance, a security context based on a previous primary authentication may be available (e.g., a security context in which a root key such as 5G K_AUSF is derived from which the AS/NAS security contexts are derived). When re-identifying/re-authenticating the user, the user identification/authentication information is protected with said security context (e.g., in a NAS message or in a message sent to an authentication function such as AUSF protected with a key derived from K_AUSF). If user can be re-identified/re-authenticated, then the pair of UE/user remain active. If the re-identification/re-authentication fail, then further steps of the overall authentication procedure may need to be executed again, e.g., primary authentication.

Additionally or alternatively, in these messages the device may directly proceed with including the user authentication results based on the configured/selected user authentication method. If this is not (yet) configured as part of a user authentication policy on the device, then the core network may provide a (similar) user authentication policy to the device upon device registration and/or it may include a parameter in its security related message exchange with the device (e.g. as part of the identity request message or authentication request message) whether or not primary device authentication is required and/or whether the device can immediately proceed with user authentication instead.

Additionally or alternatively, based on the selected/required/minimum user authentication method (e.g. selected by the core network and/or application function based on the above mentioned user authentication policy in the network and/or based on the configured/provided service/application authentication requirements and/or privacy profile), the core network may include information about the selected/required/minimum user authentication method as part of the security related message exchange with the device (e.g. as part of the identity request message or authentication request message), based on which the device will trigger and perform the selected/required/minimum user authentication method based on the available user authentication methods at the device. If the selected/required/minimum authentication method is (temporarily) not available (e.g. camera in use), the device may show an error message to the user and/or provide an error message to the network indicating that the user authentication method is (temporarily) not available and/or that the related services/applications are not available.

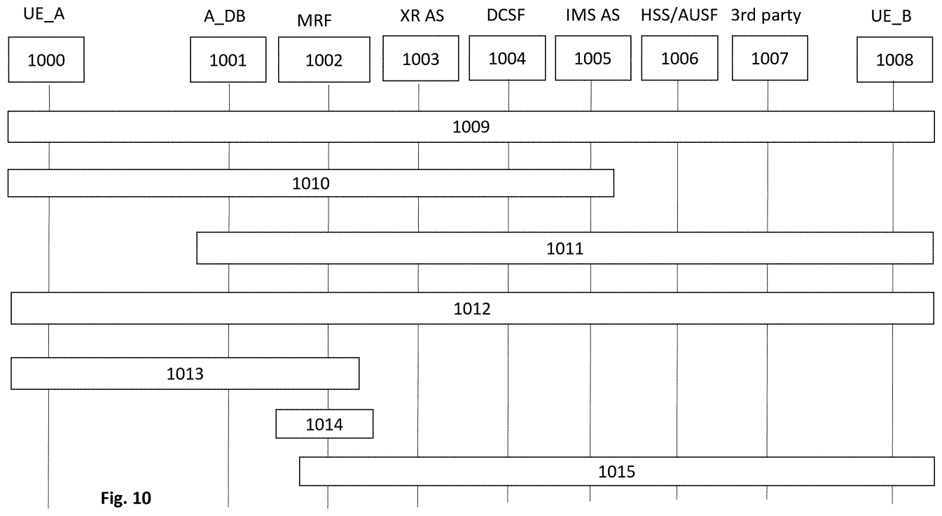

FIG. 11 shows an overall procedure for the identification/authentication/authorization of a user according to various embodiments. Entities 1100, 1101, 1102, 1103, 1104, 1105, 1106, 1107, 1108, and 1109 may refer to a user, a UE, RAN, AMF, SMF, PCF, AUSF, UDM, 3^{rd} party ID provider, and AF, respectively. Subsequent steps refer to potential phases of the communication procedure. These steps may be performed in the sequential order described here, or in a different order. Some steps may be performed multiple times. In particular:

Step 1110 may refer to an initial access to the UE by the user, a step in which the user may unlock the SIM card including user information. In this step the user may also unlock the ME and/or SIM including the UE information.

Step 1111 may refer to an initial UE registration procedure and authentication procedure. In this step, the user specific credentials (e.g., a user identity, biometric information, etc) may be transferred in a secure manner to the home network, e.g., by protecting (e.g., encrypting and integrity protecting) this information using the public-key of the home network. The AUSF/UDM may receive this information and may require the UDM to process (e.g., decrypt and integrity verify) it.

Step 1112 may refer to a request by the core network requesting the user specific credentials for identification of the user. This request may be triggered based on the type of service a user wants to access.

Step 1113 may refer to an answer by the UE, upon confirmation by the user, providing further user identification information, e.g., the user identity or profile based on local UE verification, e.g., as indicated in other embodiments.

Step 1114 may refer to an authentication protocol certifying the identity of the user. This protocol may be between UE and core network (e.g., AUSF/UDM) and/or AF and may consist in checking the biometric information of the user, or user credentials (e.g., a password). This protocol may also rely on a third-party ID provider that may be in charge of performing the user authentication, and upon successful authentication, provide the user identity. This protocol may only be executed when required (e.g., when the user identity provided in Step 1113 (that may have been obtained based on local verification) cannot be fully trusted, as described in other embodiments). For instance, the UE may send a user identifier, e.g., stored in the user SIM, introduced in the screen by the user, or derived from the user biometrics (e. g, face). The receiving party (e.g., AUSF, UDM, UDR, or a user identification NF) may look up specific credentials, and it may trigger an authentication protocol between, e.g., User SIM/UE and e, g., AUSF. For instance, the UE/User SIM may also protect said user identity and/or credentials (e.g., a key/password) with the public key of the home network and send this information to the home network. For instance, the user identity may be an identifier derived from the user biometrics (e.g., face). The message may also include a value (e.g., nonce, UTC time) so that the freshness of the message can be verified. The message may also include an identifier of the current UE or UE registration. The message may be:
Protection(Public_key_home_network, User_Identity, User_Credentials, freshness value, SUPI)

The above message may allow for one-way authentication, where (CN/AF) identifies/authenticates the user. For instance, upon reception, the receiving party may decrypt/integrity verify the message, it may use the User_Identity to look up credentials and may check whether the credentials match. Furthermore, it may check whether the message is fresh (recent) e.g., based on a UTC-based value. Furthermore, it may check that the message is associated to a user/UE with the indicated SUPI. Furthermore, it may check whether the User_Identity is associated with the SUPI included. It is to be noted that the key pair used for the encryption of the User_Identity, User_Credentials may be different than the key pair used for the encryption of the SUPI. An example of Public_Key_Encryption( ) may be Elliptic Curve Integrated Encryption Scheme. Other fields that may be required in this message may include the type of User Identity, the Home Network Identifier, a Routing Indicator, a Protection Scheme, a public key identifier. The receiving entity (e.g., AUSF, UDM) may then check the subscription and user profile and verify which services the user is entitled/authorized to and how they may be provided/optimized. Additionally, or alternatively, the message may also include a 3^{rd} party identity provider identifier, and the credentials may be protected with cryptographic keys issued or associated to the 3^{rd} party identity provider. The 3^{rd} party identity provider may then verify the identity of the user and authenticate the user, and the authenticated identity may be provided to the core network (e.g., AUSF/UDM/UDR) that may authorize the user based on the identity provided and the service(s) requested by the user.

In Steps 1115 and 1116, upon successful identification, authentication and authorization of a user, the AMF/SMF may be provided with user information, e.g., the user identity and/or identifier (e.g. to AMF) and/or information about the type of traffic the user consumes/produces (e.g., to SMF). The PCF may also be requested to provide the UE with user specific policies fitting its user profile and/or UE usage profile (as described in previous embodiments). Furthermore, the serving network may need the user identity, identifier, and identification profile, which may need to be provided to Lawful Interception entities.

In step 1117, the AMF may configure the RAN/UE with information about the user, UE usage, the type of traffic the user provides/consumes, and specific data about how the user is expected to use the UE for communicating, e.g., keeping it at a fixed position, moving it frequently, etc. This user information and UE usage information may be used to improve the communication between RAN and UE.

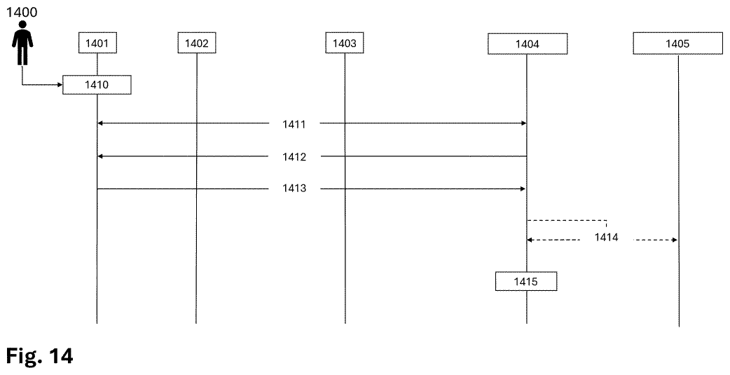

FIG. 14 shows an overall procedure for the identification/authentication/authorization of a user. Entities 1400, 1401, 1402, 1403, 1404, and 1405 may refer to a user, a UE, RAN, AMF, AUSF/UDM, and a 3rd party User Identity Management Server (UIMS), respectively. Subsequent steps refer to potential phases of the communication procedure. These steps may be performed in the sequential order described here, or in a different order. Some steps may be performed multiple times or may be skipped. In particular:

In step 1410, 1400 accesses the UE 1401 e.g., by unlocking the ME and/or SIM(s).

In step 1411, 1401 performs initial registration and primary authentication with 1404. 1401 may include an indication for its capability for user identification if available. Additionally or alternatively, the user identification capability may be part of the subscription details associated with UE 1401. Additionally or alternatively, the user identification/authentication information may be sent already at this stage.

In step 1412, based on one or more of the type of services requested/to be provided, the UE subscription details, and if any, the indication for user identification capability, 1404 may trigger a User Identification/authentication/authorization procedure whereby a User Identity Request is sent to 1401, in particular, if Step 1411 did not include any user identification/authentication information. In step 1413, upon receiving the User Identity Request, 1400 may be prompted (e.g., through the user interface) to provide its User Identity and authentication information. If 1400 approves the request (e.g., by locally (re-)authenticating itself using biometrics e.g., face, fingerprint, etc, the User Identity and authentication information (e.g., User identifier, user biometric data) are sent protected to 1404 in the User Identity Response message. In case 1405 (a 3rd party User Identity Management Server (UIMS) is used for user identification/authentication, the user specific credentials (e.g., User Identity) may be protected by 1401, first, based on security materials (pre-)shared between the UE and the 3rd party UIMS, and then protected using the security materials associated with the established NAS security context (e.g., if NAS context has been established). Otherwise, the User Identity response message may be protected using the home network's public key, as described in the previous embodiment.

In step 1414, 1404 processes the protected User Identity and authentication information received in step 4, and authenticates the User based on whether the User Identity is associated with a UE subscription or a user profile/subscription, as stored in 5GC (e.g., UDR). Alternatively, if the User Identity is managed by 1405, the User identification and authentication is performed by 1405 and the identification and authentication result, along with the User Identity may then be provided to 1404, which may subsequently check whether the identified and authenticated User is associated with a UE subscription or a user profile/subscription, as stored in the 5GC (e.g., UDR).

In step 1415, based on whether the User Identity authentication is successful, and the type of services requested by the user, the 5GC (e.g., PCF) determines whether the User is authorized for such services. If the identification/authentication of the User fails (e.g., at the user's home network, or at the 3rd party identity provider e.g., UIMS in step 1414, or, if the user is not authorized for the type of services they have requested, the home network may send a reject message (e.g., in a NAS message) to 1401, which may indicate the failure cause (e.g., unauthorized service), or the failure may be indicated implicitly, e.g., by only providing services which do not require user authentication/authorization.

### Scenario 4: Avatar Communication

The following embodiments are directed to avatar communication.

In 3GPP specification TR 23700-77, a goal is to study whether and how to enhance an IMS architecture (e.g., as defined in TS 23.228) whose security may be specified e.g. in TS 33.203 and TS 33.210 and TS 33.328 (media plane security), by providing procedures and/or interfaces for supporting an avatar call (including multi-party communication) and communication with accessibility (e.g., as specified in clause 5.2.2 of TS 22.156).

For multi-party communication, a secure real-time protocol (e.g., as defined in RFC 3711) may be used. Multi-party communication may require negotiating as to which type of security is required, using a group key or multiple point to point keys. This may also be a configuration distributed by the network or the IMS network or pushed to the communicating parties. The IMS network may also gather preferences of the users or communicating parties and distribute them to the rest of the users. Key management (e.g., as described in Clause 6.2.3 of TS 33.328) may be based on ticket-based modes of key distribution in multimedia Internet keying (MIKEY-TICKET) as described in IETF RFC 6309. In some cases, a communication may start between a sender and a single receiver of a communicating party, and then increase to two, three, or more receivers of communicating parties. For a communication between sender and a single receiver of a communicating party, a single key may be sufficient to secure the communication between sender and receiver. When the communication takes place between a sender and two receivers of communicating parties, the sender may keep two keys, a first key to protect the communication between the sender and the first receiver and a second key to protect the communication between the sender and second receiver.

In avatar communication, a user may choose a given avatar and it needs to be made sure that avatar objects (such as an avatar representation) can be stored and accessed by the authenticated and authorized UE and/or IMS network nodes while avoiding fraud and ensuring privacy. Similarly, it needs to be made sure that the use of an avatar representation can be authorized in an IMS avatar communication. As per Annex AC.9 in TS 23.228, step 3 is about AR-media rendering negotiation between UE and IMS network.

In an embodiment (EA1) that may be combined with other embodiments or used independently, this step can be enhanced to only configure and store authorized avatar models in a multimedia function (MF) and/or a multimedia resource function (MRF). Additionally or alternatively, a new step may be introduced to achieve said configuration. Additionally or alternatively, the step may also enable the authorization process. For instance, the user and/or UE (e.g., the receiving UE/user) may indicate a given desired avatar model, identified by a given identifier or Avatar-id, but this avatar model may only be authorized by an AR application server if supported and/or authorized for/by the user (e.g., the sending UE/user). Note that this can also require identifying/authenticating a user (e.g., the sending and/or receiving UE) as in other embodiments. The MF/MRF may only allow it if it complies with a policy of the network and/or of the communicating parties involved in the call. For instance, a user may have a personalized avatar model that allows improving his presence, eye contact, etc in video calls. However, the user may want that this avatar model is not misused, and it may only allow its usage if he and other users have been identified/authenticated as the user in the call/using the UE/AR/VR glasses.

In a further embodiment (EA2) that may be combined with other embodiments or used independently, the user may have a preference policy that may be stored locally (e.g., in the user's UE) or in a database in the core network (e.g., UDM or in an Avatar Repository) or part of the user's subscription, the preference policy that may determine whether the avatar model, completely or partially, may be shared also with remote users, e.g., may be locally loaded in the UEs of remote users, e.g., when a split rendering technique is required, or whether it may only be used in a remote edge server serving the remote user. This avatar model may be a predictive model—as indicated in TS 22.156—that enables presentation of avatar media to users based upon timing and other information, so that information can be extrapolated or inferred even if it is not yet available from the network.

In another embodiment (EA3) that may be combined with other embodiments or used independently, a user may own several avatar models/representations which may be used when communicating with different users or groups of users wherein a user may designate a default avatar model that is used as a fallback option in case of e.g., failure to access a particular avatar model/representation during an IMS avatar communication session. The default avatar may be set as part of the user's preference policy and may be owned by the user itself and/or be a generic avatar model that is assigned by the network. The access/use of such generic avatar model may be subject to looser authentication/authorization requirements as it is a fallback option i.e., placeholder avatar. For instance, the user may be required to only be authenticated and/or authorized to perform an IMS avatar communication session to be able to make use of the default avatar model. Moreover, the fallback to use the default avatar model may be on-demand (e.g., through an indication in the SIP invite) and/or automatically upon failure to authenticate/authorize a user to access/use a particular avatar model, in which case the network checks the user's preference policy and/or subscription to determine whether a user specific default avatar model or a network generic default avatar model is to be used instead.

In a further embodiment (EA4) that may be combined with other embodiments or used independently, the user may enter his preferences (e.g., preference policy) when communicating with another party, e.g., by means of the UE user interface.

In a further embodiment (EA5) that may be combined with other embodiments or used independently, the preference policy may be sent or exchanged or retrieved during an authorization process, e.g., as in previous embodiments, used to determine which avatars are authorized to be used or stored. For instance, the preference policy of a user may be shared with the MF or MRF so that it only uses/stores authorized avatar models. For instance, the MF or MRF may check with the AUSF/UDM whether the avatar model for the current communication may be used/stored. For instance, the user may enter his preferences and determine whether to share his model or not.

In a further embodiment (EA6) that may be combined with other embodiments or used independently, the avatar model may be supported (used) if the model includes a signature or certificate or proof of ownership that can be verified successfully by the verifier, e.g., AS or MF/MRF. The signature used to sign the certificate may have been issued by the end party requesting the usage of the avatar model, e.g., the UE/user that is transmitting (transmitting user). The avatar model may be deployed in the AS or MF/MRF or in an edge server or in remote UE used by the receiving user. Similarly, the preference policy may also need to be successfully verified if it is to be accepted.

In a related embodiment (EA7) that may be combined with other embodiments, the receiving user also requires the identification/authentication of the transmitting user, e.g., by checking the biometrics of the transmitting user or by other means as illustrated in other embodiments. Once the receiving user was able to verify the identity of the remote transmitting user, e.g., by means of the techniques described in other embodiments, the receiving user may be securely provisioned with the keying materials that are required to verify the model of the remote transmitting user, e.g., a public key issued to or owned by the remote transmitting user. The provisioning step may be done by the 5G network or the IMS network.

In a further embodiment (EA8) that may be combined with other embodiments, the avatar model may be verified against a distributed ledger such as a blockchain that allows verifying the integrity and/or ownership and/or authenticity of the model. A party willing to communicate may publish in the distributed ledger his/her model, and/or a fingerprint of the model, and/or a link between the model and the party, and/or a signature of them so that any other party retrieving the data can verify this information. A party willing to communicate may also publish any other software and/or libraries required to correctly process the avatar model, e.g., software and/or libraries that are required to properly run a predictive avatar model. The producers of such libraries may also publish the libraries and/or their fingerprints and/or their signature in the distributed ledger. The published avatar model may be encrypted so that it cannot be used without authorization, whereby the authorization may involve the distribution of keys that allow decrypting it, in its entirety or partially. Next several scenario variations related to clause AC. 9.3.1 of TS 23.228 are described in which two UEs may establish and/or use and/or rely on an Avatar based communication where above embodiments may be applied and further elaborated. In these scenarios, a first UE (e.g., UE_A) and a second UE (e.g., UE_B) are involved where both UEs (wish to) interact by means of an Avatar based communication. Next to the Media Function/Media Rendering Function (MF/MRF), other functions involved may include the DC Signaling Function (DCSF), an AR/XR Application Server (AS), a Digital Asset/Avatar repository. In some cases, steps of different scenarios may be skipped or combined with each other.

In a scenario, step 3 in Figure AC.9.3.1-1 in clause AC.9.3.1 of TS 23.228 may include the exchange of an avatar-id from a first UE (UE-A) and the MF/MRF and/or XR application server. Next, the application data channel may be established between UE-A and the IMS network, as well as between UE-B and IMS network, wherein this may also require indicating the Avatar-Id. Next the AR application server may send a request to an Avatar database to retrieve the avatar representation and/or metadata, which may require providing the UE-identity and Avatar-ID. Once the XR application server has the data, it may start controlling rendering, e.g., that may be done by the MF/MRF, UE-A or UE-B. If done by MF-MRF, UE-A may send data, e.g., facial expression(s) of the user, that may be rendered by the MF/MRF, and the rendering may be sent to both UEs (i.e., UE-A and UE-B). If done by UE-A, UE-A may receive from the AR application server the Avatar representation and/or metadata, Avatar Id, and UE identity so that it can perform the rendering locally and send the rendering to UE-B (over RTP). If done by UE-B, UE-B may receive from the XR application server the avatar representation and/or metadata, Avatar ID, and UE identity. UE-B receives from UE-A information about UE-A, so that the rendering is performed at UE-B. Additionally, or alternatively, the avatar representation/metadata may also be available (e.g., stored) at the UEs, thus allowing the UE to perform the rendering locally, thus reducing signaling from XR/AR application server, then sending the rendered Avatar to the receiving UE. Furthermore, to enhance the Avatar communication experience between UEs (i.e., UE-A and UE-B) for their respective users, supplementary data (e.g., changes in facial expression(s) of the user(s)), may be exchanged continuously and in real-time between UEs for the duration of the Avatar communication session.

In another scenario, it is required to download the avatar representations from an avatar repository, and this may be done by means of a bootstrap data channel. The avatar repository may store the avatar representation, which is identified by an avatar ID. The avatar repository may be connected to the Data Channel Signaling Function (DCSF). After the bootstrap data channel establishment, the avatar ID(s) which UE can use is/are provided together via the bootstrap data channel. UE may select an appropriate data channel application and an avatar representation to download from the DCSF through MF/MRF. The action may trigger the download to a network entity (e.g., MF/MRF) and/or UEs (a sending UE and/or a receiving UE).

In yet another scenario, it is required to transition from audio/video communication to avatar communication. A first UE (UE_A) may have audio/video communication with a second UE (UE_B) and may exchange audio/video media through MRF over RTP. A UE (e.g., UE_A) may decide to switch to Avatar communication, so UE_A may need to interact with the DCSF and UE B to negotiate the Avatar media and establish a Data Channel. The DCSF may get the Avatar metadata from an Avatar repository and send it to the Media Function (MF/MRF), that may send it to UE_B. UE_A may then sense the user (e.g., facial data, body motion, etc) and send the sensing user information to the MF/MRF. The MF/MRF may then perform rendering given the Avatar metadata and the sensed user information, and then send it to UE_B and/or may send the Avatar metadata to UE_B that will perform the rendering based on the received sensed user information.

In yet another scenario, the two UEs UE_A and UE_B have established an audio/video connection, the XR_AS and MF/MRF may interact (e.g., XR_AS may send a request through DCSF) so that the MR/MRF performs transcoding and rendering functions. Parameters to consider may include the avatar type (e.g., 2D or 3D), location of the Avatar (e.g., URL). The MF/MRF may download the Avatar metadata/model so that it can perform transcoding/rendering of the audio/video stream into an avatar-based representation by applying the Avatar model that may be an AI-model such as Text-to-Speech, Self-Supervised Learning, Self-Regulated Learning, Automatic Speech Recognition, etc.

In yet another scenario, a first UE (UE_A) may generate or update an Avatar representation (of the user) and upload it to a NF, e.g., a Digital Asset Repository (or Avatar repository). UE_A and a second UE, UE_B, may establish an IMS session for audio/video and bootstrap a data channel that is used to distribute the initial scene. An AR Application Server may generate the scene for this AR session and send it over the data channel to the MF/MRF. This scene may include the Avatar representation(s) (or model(s)) of UE_A and/or UE_B. The MF/MRF may share the scene with UE_A and UE_B that may determine applying the Avatar communication, e.g., UE_B may send a request to obtain Avatar model of UE_A from the Digital Asset repository. The Digital Asset repository may authorize UE B to access UE_A's avatar model. This step may involve the checking of the IMS session details and the authentication of UE-B. It may also include the checking of which assets and which level of details are to be shared. If authorized, the Avatar model of UE_A is shared with UE B. In a subsequent phase, media streams may be transformed into animation streams that may be used as input in the Avatar model for the animation of the Avatar.

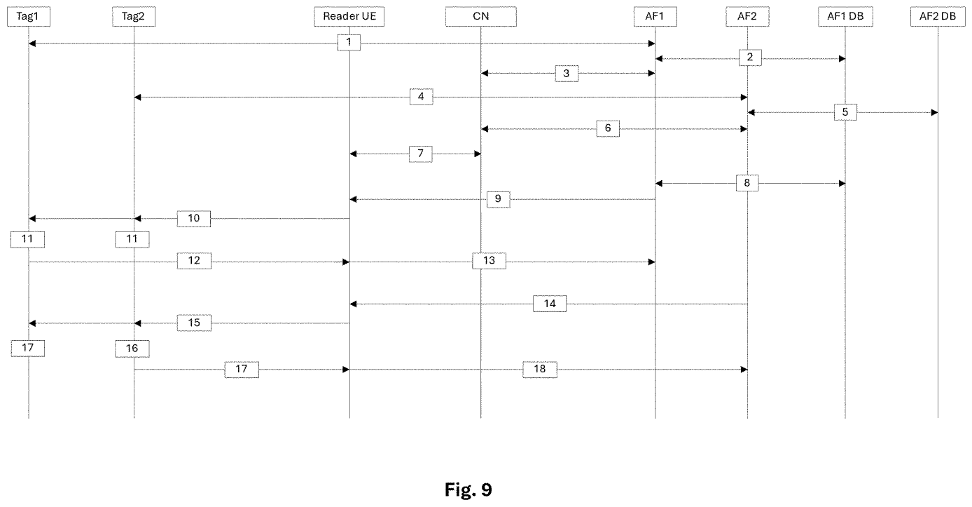

FIG. 10 describes a potential procedure according to some of the embodiments and examples above. Entities 1000, 1001, 1002, 1003, 1004, 1005, 1006, 1007, and 1008 correspond to a first UE UE_A and/or user, an avatar/digital asset repository or database, the MF/MRF, an XR or AR AS, the DCSF, an IMS AS, a core network function in charge of identity management (e.g., HSS or UDM/UDR), a third party issuing identities/signatures, and a second UE UE_B and/or user. Step 1009 may represent an established Audio/Video communication session between UE_A and UE_B or an initial configuration step of UEs (e.g., with authorization tokens, or policies) or authorization policies in some functions (e.g., Avatar repository 1001). Step 1010 may refer to an initial XR media rendering negotiation step (e.g., similar to Annex AC.9 in TS 23.228, step 3) wherein an Avatar model is negotiated, e.g., for UE_A. Step 1011 may refer to media-renegotiation between UE B and IMS network for a given Avatar model. Step 1012 may refer to an internal configuration/authentication/authorization of the Avatar communication based on the user/UE identities, Avatar model to use, and policies, this may involve configuring the Avatar model at the MF/MRF 1002 or at one of the UEs, e.g., UE_A or UE_B. Step 1013 may indicate the start of the communication wherein UE_A transmits stream data (audio/video/sensed gestures/ . . . ) to 1002. In Step 1014, 1002 performs the transcoding/rendering based on the Avatar model. In Step 1015 the rendered data is sent to UE_B. This procedure is exemplary and may be combined with other aspects described before, e.g., the transcoding/rendering may be performed at UE_A 1000 or UE B 1008 requiring the storage of the Avatar model at UE_A or UE B.

In an embodiment (EB1) illustrated by means of FIG. 10 that may be used with other embodiments or used independently, when a network function/server, e.g., XR AS 1003, requests (e.g., in Step 1012) the Avatar metadata or model from an Avatar database 1001, the Avatar database may only return the model if UE-A and/or UE-B and/or MF/MRF are authorized to receive said metadata or model. This may require indicating and/or verifying information such as the UE identities, the User Identity, communication purpose, and communication context. This may require authenticating the UE/User and/or getting authorization data.

In an embodiment (EB2) illustrated by means of FIG. 10, when a network function/server, e.g., XR application server 1003, shares Avatar metadata/model (e.g., in Step 1012), which metadata is allowed to be transmitted may depend on the target entity, e.g., MF/MRF may be authorized to obtain all metadata, but a UE may not. This means that depending on the rendering mode (network based or split rendering, the Avatar metadata or model may be shared or not, and thus, Avatar-based communication may be allowed or disallowed.

In an embodiment (EB3) illustrated by means of FIG. 10 that may be used with other embodiments or used independently, the UEs and/or the users behind the UEs 1000 and/or 1005 may have an identity used for their (mutual) identification, authentication, and/or authorization wherein the identity may be provided by:
A cellular network, e.g., be related to a unique user identity such as the SUPI (e.g., 1006);
An external party such as an application service (e.g., 1003 or 1007) that may be using the cellular network to enable Avatar-based communication;
A third-party identity/signing server in charge of issuing identities for a given organization (e.g., 1007), e.g., following an enhanced STIR/SHAKEN architecture (e.g., as illustrated in FIG. 6.11.1.1-1 in TR 23.700-77 V0.4.0).
A UE itself.

In an embodiment (EB4) illustrated by means of FIG. 10 that may be used with other embodiments or used independently, the verification of an identity of a UE/user may, as well as authentication/authorization for the usage of an Avatar model, be performed by means of an enhanced STIR/SHAKE architecture (TS 24.229) wherein the sending/receiving UE may use a signing server in the domain of the sending/receiving UE operator to sign its identity and/or request to use an Avatar model and/or Avatar model to offer to a remote UE/user, the signed data may be shared with a receiving/sending UE (in the domain of the receiving/sending UE operator) and a verification server may verify the signed data. Once verified, an authorization step may be performed, in other words, the verification of the signed data by the verification server serves as an authorization step.

In an embodiment (EB5) illustrated by means of FIG. 10 that may be used with other embodiments or used independently, the identity UID required for the identification of the (sending) user and/or UE establishing the avatar-based communication that is required for its later authentication/authorization may be exchanged in an initial communication establishment or negotiation phase (e.g., Step 1009 or 1010), e.g., as part of the SIP INVITE message. Next to this identity UID, the identity of the required Avatar ID may be exchanged so that it is possible to:
Identify the user/UE
Authenticate the user/UE
Verify whether the user/UE (or a NF such as MF/MRF) is authorized to use said Avatar model linked to the Avatar ID.

In a related embodiment (EB7) illustrated by means of FIG. 10 that may be used with other embodiments or used independently, the identity UID (or a pseudonym of it) required for the identification of the (sending) user and/or UE establishing the avatar-based communication is included in authorization information (e.g., an authorization token) that allows the receiving party (e.g., Avatar repository 1001) to verify the UE's identity and authorization. Additionally, or alternatively, it includes some authentication information, (e.g., digital signature) allowing the receiving party to verify the identity and authenticate the sending UE/user. Note that the receiving party may need to interact, e.g., with 1006 or 1007, e.g., through 1005, to verify the authorization token.

In a related embodiment (EB8) illustrated by means of FIG. 10 that may be used with other embodiments or used independently, the identity UID (or a pseudonym of it) required for the identification of the (receiving) user and/or UE may also be exchanged in an initial communication establishment or negotiation phase (e.g., Steps 1010/1011), additionally or alternatively, authentication and/or authorization information may be exchanged as per the last embodiment that may be verified in a similar way.

In a related embodiment (EB9) illustrated by means of FIG. 10 that may be used with other embodiments or used independently, a user/UE (e.g., in Step 1009 or 1010) or an XR AS (e.g., in Step 1009 or 1012) or a third party (e.g., in Step 1012) may indicate:
the conditions under which an Avatar model may be used and/or stored, e.g., the type or properties of the connection (data rate, quality of service, latency, jitter, etc) to which it may be applicable, and/or
specific UEs/users that may use or store an Avatar model (e.g., Avatar model may be stored at the MF/MRF 1002, but not at UE_B, e.g., Avatar model may not be stored at UE B if it is not within the same operator network) and/or
a duration during which an Avatar model may be stored at a peer UE e.g., based on anticipated and/or planned Avatar communications during a pre-determined period; and/or
UE/user types that may use an Avatar model, e.g., a user identified as a kid may not use a given Avatar model.

This information may be part of a policy/configuration/metadata linked to the Avatar model that may be identified by a given Avatar ID.

In a related embodiment (EB10) by means of FIG. 10 that may be used with other embodiments or used independently, a receiving UE UE_B may request the storage of the Avatar model used by UE_A so that it can perform local transcoding and rendering by sending its UE/user ID/authentication data/authorization data, the IMS/core network (e.g., Avatar repository 1001) may determine that UE B is not authorized to locally store the model but to use it remotely in a split rendering mode wherein the MF/MRF 1002 may perform the transcoding/rendering, at least, partially. The IMS/core network may then inform UE_B about it and may either trigger this configuration of the MF/MRF with the Avatar model and/or wait for the request from UE_B to perform this configuration. Additionally or alternatively, UE_B may request the storage of the Avatar model (used by UE_A) from UE_A itself, or the IMS/core network may forward the request to check with UE_A whether it allows UE_B to store its Avatar model, and depending on UE_A's response, IMS/core network determines whether UE_B may store and use (or only use) UE_A's Avatar model.

In a related embodiment (EB11) illustrated by means of FIG. 10 that may be used with other embodiments or used independently, the entity performing the transcoding and/or rendering by means of the Avatar model (e.g., MF/MRF 1002 in Step 1014 in FIG. 10) may monitor whether the user changes (e.g., a different face is identified in the incoming data stream, e.g., audio/video stream and/or the sensed data (e.g., way user moves his head, etc follows a different pattern) during the Avatar communication session since this may indicate the involvement of a different user that may not be authorized. The entity performing the transcoding and/or rendering may have a policy/configuration determining the action to take when this is detected, e.g., send an indication to the receiving UE/user and/or switch to a default Avatar model, or switch back to normal Audio/Video communication and/or stop the communication session.

In a related embodiment (EB12) illustrated by means of FIG. 10 that may be used with other embodiments or used independently, the authentication/authorization procedure is performed in two steps: an initial authentication/authorization step performed before the communication starts and based on the identity of the user and an authorization policy; and a second (continuous) authentication/authorization step performed while UE_A and UE_B are performing the Avatar-based communication (e.g., as in previous embodiment).

In a scenario related to Tdoc S3-241212, Steps 1-6: UE-A and UE-B negotiate the usage of an Avatar-ID, and it is checked whether usage of Avatar-ID by UE-A and UE-b is authorized. This is done by sending, by UE-A, an indication of the Avatar-ID and a token in the XR media rendering negotiation step. The IMS AS then checks with the HSS/UDM whether the UE is authorized to use the Avatar ID, and if it is, IMS AS signs the Avatar ID. The signed Avatar-id is exchanged with UE-B to indicate about the avatar session during the signaling. The terminating IMS network checks if the UE-A is allowed to use the Avatar-id by verifying the signed Avatar-id with the verification server. If successful, it forwards the Avatar-id to UE-B. UE-B has the option to reject the avatar alone or terminate the session based on Avatar-id. If this authorization step succeeds, the XR AS retrieves a token through NEF/CAPIF/NRF. The successful retrieval of the token gives access to the avatar model from the avatar repository. The XR application server retrieves model from avatar repository and delivers it to the MR/MRF so that the network rendering can be performed.

This scenario shows some similar steps compared with above embodiments, e.g.: EB1, EB2, EB4, and EB7. Still, this scenario has a number of challenges such as how the procedure to get a token from NEF/CAPIF works, (2) what is included in the UE token, (3) why the signed avatar ID is sent to UE-B, or (4) which information is to be provided via NEF to obtain the token, or (5) whether interaction over NEF is required at all. Furthermore, the UE centric rendering is for further specification.

In an embodiment (EB1′) that may be combined with other embodiments or used independently, an application function (AF) may allow a UE/user to use/select an Avatar ID, e.g., after UE/user purchases said Avatar. This action may give the UE/user authorization to use the Avatar, and this authorization may be provided to the user/UE as an authorization token/policy. The UE may share said authorization token in Step 1009, as in FIG. 10. The IMS system may then be able to verify that UE_A is entitled to use Avatar ID. The token may state also whether said Avatar may be used in network-centric rendering and/or UE-centric rendering, as well, as whether UE-B may store said Avatar metadata model.

In another embodiment (EB2′) that may be combined with other embodiments or used independently, a UE/user that may be authorized not only to use the Avatar but also to manage it e.g., if UE/User owns the avatar. For instance, a UE/user may authorize other UEs/users to use and/or store the avatar, e.g., by requesting authorization tokens from XR AS and providing them to said UEs/Users where the token may determine one of a multitude of usage conditions, which include, but are not limited to:
type of access (e.g., retrieve and use, retrieve, use, and store)
type of rendering (e.g., network-centric, UE-centric, or both)
type of use (e.g., use to represent owner during avatar communication, use as own avatar during avatar communication)
access duration (validity time of the authorization token e.g., one time use or multiple times use)

In an embodiment (EB3′) that may be combined with other embodiments or used independently, the Avatar based communication may focus on network-centric rendering. At some point of time, UE-B may request UE-centric rendering, and may send a request for this purpose. This request may include its UE (and/or user) ID, UE (and/or user) profile, and authorization information, e.g., authorization token. This request may be sent to the IMS AS. The IMS AS may check with the XR AS whether UE B is authorized to obtain the Avatar model. If allowed, it may retrieve the Avatar model/metadata from the Avatar repository, and it may be provided to UE-B. Additionally or alternatively, the request to check whether UE_B is authorized to obtain the Avatar model may be forwarded to UE_A, such that the user/owner of the Avatar model determines whether UE B could be permitted to retrieve it, how it may use it, and for how long/many times. Additionally, or alternatively, it may request the MF/MRF to distribute (part of) the Avatar model to UE-B and signal the change between network-centric rendering and UE-centric rendering.

In an embodiment (EB4′) that may be combined with other embodiments or used independently, an Avatar model/metadata is distributed together with a usage policy or policy that determines the conditions and UE/user/MF/MRF that can use it. The Avatar model/metadata is distributed in a protected manner, e.g., encrypted under key K, next to the usage policy. The device running the model, e.g., MRF/MF/UE-B may evaluate whether the conditions for its usage are met, and only if the conditions are met, the Avatar model/metadata may be unlocked (e.g., after removing protection, i.e., decrypting) and used.

In an embodiment (EB5′) that may be combined with other embodiments or used independently, the MF/MRF/UE-B may already contain/store an Avatar model/metadata associated to an Avatar ID, e.g., from another (previous) communication session. If this happens, the MF/MRF/UE-B does not need to retrieve the Avatar model/metadata, but only check whether the UE(s) in a new communication session are allowed to use it and/or renew the authorization/usage policy, e.g., by sending a request to the authorization entity, e.g., XR AS, or AF (e.g., through NEF). In an embodiment (EB6′) that may be combined with other embodiments or used independently, UE-A/UE-B/MF/MRF is assigned an authorization token that may include one or more of:
UE ID,
Avatar ID,
Conditions for usage,
Key identifier to decrypt the Avatar model/metadata.

Key to decrypt/undo protections of the Avatar model/metadata.

In some cases, the key (identifier) to decrypt/undo protections of the Avatar model/metadata may be provided separately; this may allow, e.g., UE-B to provide the token with UE ID, Avatar ID, conditions for usage to another entity.

In an embodiment (EB7′) that may be combined with other embodiments or used independently, the Avatar model/metadata is provided in protected manner to UE-B/MF/MRF including a key identifier that identifies the key used to protect (or undo the protection). In a scenario, a first UE sends an avatar ID to the XR AS, and the XR AS may determine whether the Avatar ID is in the list of authorized avatars. UE may also send a token to MR/MRF which is supposed to be used to ensure that untrusted parties access a given Avatar. If the XR AS determines that the first UE can use the Avatar ID, it sends a message to the DCSF with instructions for avatar communication media processing, and the DCSF further checks with the MF/MRF (including the Avatar ID). The MF/MRF may then send Avatar ID and token to the avatar/digital asset repository that can verify the token and check the avatar ID. The MRF may then download the Avatar model or an error. This procedure may be improved in multiple ways:

In an embodiment (EC1) that may be combined with other embodiments or used independently, the first UE sends the Avatar ID and token to the XR AS that may verify one or both. If the verification(s) holds, the XR AS may then forward them to the avatar asset repository that may verify them, and may provide MF/MRF and/or the first UE and/or the second UE with the required Avatar model. This embodiment may be advantageous because it links together the requested Avatar ID and the submitted token by the first UE. Additionally or alternatively, the XR AS may forward token/Avatar ID to the DCSF, and the DCSF may forward token/Avatar ID to the MF/MRF that may then request the Avatar model as in above scenario.

In an embodiment (EC2) that may be combined with other embodiments or used independently, the token may include the identities of the first UE UE_A and/or a second receiving UE UE B and/or MF/MRF as well as the type of requested rendering (network and/or UE centric) that can be evaluated (e.g., by the avatar repository) whether the requested Avatar model (e.g., in/through the token) is authorized to be delivered to those parties.

In an embodiment (EC3) that may be combined with other embodiments or used independently, the token is generated by the first UE (UE_A) based on a key pair whose public key may be certified by an authorized party, e.g., XR AS or avatar asset repository or application. Given the certificate the receiving party of the token, e. g,. avatar repository, can verify the token. Additionally or alternatively, a party authorized for the management of avatar models may issue a token to the first UE (UE_A) so that it can be used in later communication interactions.

In a further scenario, a first UE UE_A may first decide the type of rendering (network centric, UA_A centric, UE_B centric) and may perform XR media rendering negotiation sending the attributes of UE_A to the XR AS. Then the XR AS may request the avatar repository the Avatar model by sending the attributes of UE_A. The avatar repository may then check the attributes and return the Avatar model in clear text in the case of network centric rendering and protected with a key specific to UE_A or UE_B depending on whether it is UE_A centric or UE_B centric rendering. The XR AS may share the (protected) model with the requested party. The attributes in the request message sent by UE_A may include:
Avatar ID
identity of XR AS,
rendering option,
expiration time,
ephemeral public key of UE_A or UE_B (in case of UE_A or UE_B centric rendering),
signature generated with UE_A's private key.
   This scenario may be improved in multiple ways.

In an embodiment (EC4) that may be combined with other embodiments or used independently, the avatar repository may also return a protected avatar model in the case of network centric rendering. This ensures that the Avatar model does not leave the repository in unprotected manner. The Avatar repository may know the public key of the target MF/MRF (in this case, the ID of the MF/MRF needs to be included in the request message). Additionally or alternatively, the public key of the MF/MRF may be attached to the request message.

In an embodiment (EC5) that may be combined with other embodiments or used independently, next to the (ephemeral) public key of UE_A or UE_B or MF/MRF, a certificate is required from a trusted entity that can be used to verify those (ephemeral) public keys, in particular, in the case of keys of MF/MRF and UE_B. Otherwise, the receiving party (avatar repository) is not able to verify them, and the Avatar model may be encrypted with a public key whose private key is owned by an unauthorized party.

In an embodiment (EC6) that may be combined with other embodiments or used independently, UE_A may need to obtain UE_B's public key/certificate in step, e.g., in the XR media rendering negotiation. It is also to be noted that only after the XR media rendering negotiation UE A can make the final decision of choosing UE-B centric rendering, and not before since this requires the confirmation from UE-B.

In an embodiment (EC7) that may be combined with other embodiments or used independently, the public key scheme may be an identify based scheme so that the public key of the target device does not need to be explicitly exchanged, but only its identity that serves as public key.

In an embodiment (EC8) similar to EC2 that may be combined with other embodiments or used independently, the attributes included by UE_A may also include the identities of UE A and/or MF/MRF and/or UE B.

In an embodiment (EC9) that may be combined with other embodiments or used independently, the protected Avatar model may be protected with a symmetric key derived from the (ephemeral) public keys, and protection means both integrity protection and confidentiality protection. The protected model may also contain also metadata, e.g., how long it is authorized to be used, in general the conditions under which the avatar model may be used, this is important the receiving party (e.g., MF/MRF or UE_B) are not aware of the attributes provided by UE_A.

In a scenario based on S3-242299, the STIR/SHAKEN framework is used for signing and verification of both the caller and callee avatar related metadata. However, this scenario may only focus on UE rendering and not network rendering. Thus, to address this and other shortcomings embodiments in this invention may be applicable.

In an embodiment (EC10) that may be combined with other embodiments or used independently, the SIP INVITE message sent by a UE may include whether it is network centric or UE_A centric or UE_B centric rendering. Additionally, the SIP INVITE message may include other parameters/metadata, e.g., part of (authorization) tokens in other embodiments. Additionally or alternatively, such parameters/metadata may be included by the signing server of the STIR/SHAKEN framework (e.g., O-STI-AS in S3-242299) after verification/signing.

In an embodiment (EC11) that may be combined with other embodiments or used independently, the originating IMS system may need to provide “proof” to the avatar repository that it is authorized to obtain avatar data. This applies to step 2 and/or step 12 in S3-242299, in particular, step 12 because then the terminating IMS system is accessing the avatar repository and the avatar repository may be in the domain of the originating IMS. Proof may be the signed SIP INVITE message itself or a token as in other embodiments.

In an embodiment (EC11) that may be combined with other embodiments or used independently, the avatar data of UE_A and UE_B required to perform UE-centric rendering or network centric rendering may be returned to either UE_A and/or UE_B and/or MF/MRF. This is advantageous because, e.g., in S3-242299, the callee (UE_B) receives the Caller (UE_A) avatar data, and the caller (UE_A) receives the callee (UE_B) avatar data, but in practice, it could be UE_B the one that may need both the Avatar model of both UE_A and UE_B. Which Avatar model needs to be returned to which UE may be specified in a request message/token/SIP INVITE. This request may also be adapted based on the authorization policy that determines whether an avatar model may be shared or not and with which entity.

In an embodiment (EC11) that may be combined with other embodiments or used independently, according to S3-242299, the originating IMS system may provide UE_A (caller) with the avatar model of UE_B (callee) in Step 20. However, it is not specified when/how it is retrieved. In an option, the model may be retrieved by the terminating IMS system and provided to the originating IMS system in step 16, next to the signed SIP identity header. Additionally or alternatively, the originating IMS system may retrieve it prior to step 20, and it may use a token/information in the received message from the terminating IMS system (e.g., signed SIP identity heater) as an authorization token.

In general, the above embodiments describe a method adapted to:
verifying the authorization of a first device/user to use a digital asset representation and its identifier by a Network Function in charge of identity management; and
upon successful authorization check, signing (and adding a digital signature of) the digital asset identifier to be exchanged by the originating IMS network; and
verifying the signed digital asset identifier with a verification server by the terminating IMS network; and
upon successful signature check, forwarding the digital asset identifier to a second device/user; and
depending on the negotiated rendering type:
   retrieve the digital asset representation from the digital asset repository by XR application server and providing it to MF/MRF to perform network-centric rendering; or
   in case of UE-centric rendering, the second device/user's authorization to obtain the digital asset representation from a digital asset repository is checked by XR AS, and if successful, allow the second device/user to obtain the digital asset representation and perform UE-centric rendering.

In general, above embodiments describe a method that may be implemented in a UE as part of a system enabling real time communications and immersive metaverse services wherein the method is adapted to:
determining an authorization policy (e.g., preference policy) for the sharing and/or using and/or storing of an avatar model where this authorization policy may be stored in a network function or the UE,
exchanging and/or checking the authorization policy for the sharing and/or storing of the avatar model, and
sharing and/or storing the avatar model when the authorization policy allows it.

In a particular aspect, it is proposed a method that may be implemented in a network function enabling real time communications and immersive metaverse services wherein the method is adapted to:
determining or obtaining, by a networking function, an authorization policy for the sharing an avatar model, and
checking, by a network function, the authorization policy for the sharing of the avatar model with a UE and/or a user using the UE,
and wherein the checking of the authorization policy may involve at least one the identification and authentication of the UE and/or user and obtaining an indication of a given desired avatar model,
and wherein the successful check of the authorization policy triggers the distribution of the avatar model to the UE or to a media rendering function.

In a particular aspect, it is proposed a method that may be implemented in a UE enabling real time communications and immersive metaverse services wherein the method is adapted to:
determining, by a UE, a message request containing an indication of a given desired avatar model and/or an Avatar ID and/or a UE ID and/or a UE authentication/authorization token and/or an authorization policy and/or user ID and/or user authentication data, and
sending, by the UE, the message request to a network function,
receiving at least one of:
   a confirmation to use the Avatar model identified by the Avatar ID remotely at a second UE,
   a confirmation to use the Avatar model identified by the Avatar ID remotely at a media rendering function,
   a confirmation to use the Avatar model identified by the Avatar ID locally at the UE, and
   a rejection of the usage of the Avatar model.

In a particular aspect, the request sent by the UE is included in an AR-media rendering negotiation or re-negotiation message sent to the IMS network and includes an indication of a given desired avatar model.

In TR 23.700-77 v0.4.0, Solutions 10, 11, 12, and 13 focus on the verification of third party identities wherein these solutions involve a first UE sending a 3rd party public identity in an initial SIP INVITE message, the signing of the SIP INVITE message by a signing entity in the domain of the operator of the first UE, the forwarding of the signed SIP INVITE message to the domain of a second UE operator, the verification of the signed statement by a verification entity in that domain, and if the verification succeeds, the forwarding of the SIP INVITE to a second receiving UE. This procedure may be excessively complex and may be prone to privacy attacks. Thus, the following embodiments improve it:

In a related embodiment that may be used with other embodiments or used independently, the 3rd party public identity included in an initial SIP may be:
A pseudonym that may be rotated according to a policy (e.g., once every t seconds)
Encrypted with the public-key of the signing entity/operator of the first UE.

So that the sending user may not be tracked.

In a related embodiment that may be used with other embodiments or used independently, the signed SIP INVITE message forwarded to the verification entity in the domain of a second UE operator may be encrypted based on the public-key of the verification entity/operator of the second UE.

In a related embodiment that may be used with other embodiments or used independently, the signing entity may issue an authorization token to the first UE (e.g., during a configuration phase), and the first UE may attach said authorization token to the SIP INVITE. The network of the first operator (CSCF, IBCF as in FIG. 6.11.1.1-1 in TR 23.700-77) may then forward the SIP INVITE with the authorization token after verification and if the authorization token is still valid (e.g., not used before or not expired), the SIP INVITE with authorization token may then be received in the domain of the operator of the second UE (e.g., IBCF, CSCF) that may request the verification of the authorization token (e.g., to the verification entity) e.g., by checking the signature or checking that it is still valid (e.g., only used once or not expired), that may then forward the SIP INVITE (with authorization token and/or other identification data of the first UE) to the second UE that may verify the authorization token.

To summarize, apparatuses/methods for enhanced authentication in cellular networks have been described, wherein the apparatus/method checks for a preferred authentication procedure, performs the preferred authentication procedure with a core network, and sets up a connection. Thereby, authentication challenges (such as retrieving core network data, optimizing resources and strength of authentication) arising from users of one or more devices (e.g., UEs) using multiple/different networks, (e.g., with multiple subscriber identity modules and/or different radio access technologies), avatar-based communication and/or biometrics (e.g., by means of embedded sensors or wireless sensing) can be addressed.

Although embodiments have been described in the context of virtual space such as metaverse, their applications are not limited to such a type of operation. Low latency systems, e.g., in Industrial IoT systems, would also benefit from the teachings of this invention and its embodiments. The invention can be applied to various types of UEs or terminal devices, such as mobile phone, vital signs monitoring/telemetry devices, smartwatches, detectors, vehicles (for vehicle-to-vehicle (V2V) communication or more general vehicle-to-everything (V2X) communication), V2X devices, Internet of Things (IoT) hubs, IoT devices, including low-power medical sensors for health monitoring, medical (emergency) diagnosis and treatment devices, for hospital use or first-responder use, virtual reality (VR) headsets, etc.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be evident, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Additionally, the expression “at least one of A, B, and C” is to be understood as disjunctive, i.e., as “A and/or B and/or C”.

A single unit or device may fulfil the functions of several items recited in the claims. The mere fact that certain measures are recited in mutually different dependent claims does not indicate that a combination of these measures cannot be used to advantage.

The described operations like those indicated in the above embodiments may be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A method comprising:
selecting one of a plurality of authentication procedures;
performing the selected authentication procedure with or through a core network; and
setting up a the connection once the selected authentication procedure is successful.

2. The method of claim 1, further comprising
announcing a presence over a local communication interface
receiving authentication parameters from a second user device;
combining the authentication parameters from the second user device and first authentication parameters to perform a combined authentication procedure; and
receiving communication parameters for a the first user device and the second user device.

3. The method of claim 1, wherein the selected authentication procedure comprises:
performing a primary authentication procedure;
collecting user authentication information; and
securely sending the collected user authentication information to the core network.

4. The method of claim 1, wherein the selected authentication procedure comprises:
collecting user authentication information;
securely sending the user authentication information to the core network; and
receiving a confirmation to set up the connection.

5. The method of claim 2, further comprising forwarding a random access network identifier for the second user device upon performing a joint random-access procedure, or upon performing a joint random-access procedure and upon successful authentication of the second user device.

6. The method of claim 2, wherein combining the authentication parameters from the second user device and first authentication parameters comprises:
concatenating the authentication parameters of the apparatus and the second user device; or
obtaining a new authentication parameter as a cryptographic function of the first authentication parameters and the authentication parameters from second user device.

7. The method of claim 6, further comprising:
executing the authentication procedure based on the new authentication parameter and
executing the authentication procedure based on the concatenation of the authentication parameters of the apparatus and the second user device if the authentication procedure fails.

8. The method of claim 1, further comprising:
obtaining a first measurement from a first sensor;
obtaining a second measurement from a second sensor; and
correlating the first measurement and the second measurement to validate a user.

9. The method of claim 1, further comprising establishing an avatar-based communication with a remote user device upon successful biometric verification or joint authentication.

10. The method of claim 1,
wherein the connection is for real time communications and immersive metaverse services,
wherein performing the selected authentication procedure with or through a core network comprises:
determining an authorization policy for the sharing and/or using and/or storing of an avatar model, wherein the authorization policy is stored in a network function or internally the apparatus;
exchanging and/or checking the authorization policy for the sharing and/or storing of the avatar model; and
wherein setting up the connection comprises sharing and/or storing the avatar model when the authorization policy allows it.

11. The method of claim 1,
wherein the connection is for real time communications and immersive metaverse services,
wherein performing the selected authentication procedure with or through a core network comprises:
determining an authorization policy for using and/or storing an avatar model, wherein the authorization policy is stored in a network function or internally;
checking the authorization policy for the storing of the avatar model; and
storing the avatar model when the authorization policy allows it.

12. The method of claim 1, further comprising checking the authorization policy for the storing of the avatar model, wherein the authorization policy is stored in a network function.

13. The method of claim 11
wherein a first UE verifies the identity of a second UE,
wherein—the first UE is configured with keying materials to verify the avatar model prior to its storage after the verification.

14. The apparatus of claim 1,
wherein the connection is for real time communications and immersive metaverse services,
wherein performing the selected authentication procedure with or through a core network comprises:
determining a message request, wherein the message request comprises an indication of a given desired avatar model and/or an Avatar ID and/or a UE ID and/or a UE authentication/authorization token and/or an authorization policy and/or user ID and/or user authentication data; and
sending the message request to a network function; and
receiving at least one of a confirmation to use the Avatar model identified by the Avatar ID remotely at a second UE, a confirmation to use the Avatar model identified by the Avatar ID remotely at a media rendering function, a confirmation to use the Avatar model identified by the Avatar ID locally, and a rejection of the usage of the Avatar model.

15. The method of claim 10, wherein the authorization policy that determines whether an avatar model may be stored is based on the rendering mode.

16. The method of claim 13, wherein the identity may be provided by a cellular network, an external party,
a third-party identity/signing server, wherein the third-party identity/signing server issues identities for a given organization following a STIR/SHAKEN architecture.

17. The method of claim 13, further comprising a signing server in the domain of the apparatus operator to sign its identity and/or request to use an Avatar model,
wherein the verification of an identity of a UE and/or authentication/authorization for the usage of an Avatar model uses an enhanced STIR/SHAKE architecture,
wherein the signed data is shared with a receiving UE in the domain of the receiving UE operator,
wherein a verification server verifies the signed data.

18. The method of claim 13, wherein the identity of the apparatus and/or Avatar is exchanged in an initial communication establishment message.

19. The method of claim 13,
wherein the authorization information is an authorization token,
wherein the authorization information comprises the identity of the apparatus.

20. The method of claim 13,
wherein the Avatar model is linked to a policy,
wherein the policy may indicate at least one of the conditions under which an Avatar model may be used and/or stored,
wherein the conditions comprises at least one of type or properties of the connection to which it is applicable, and/or specific UEs/users that may use or store an Avatar model and/or a duration during which an Avatar model is stored at a peer UE; and/or UE/user types that may use an Avatar model.

21. The method of claim 20, further comprising:
checking the authorization policy or sending a message request to use/store an Avatar model locally; and
receiving a rejection to use/store the Avatar model locally and a request to use/store the Avatar model central at a Multimedia Function and/or Multimedia Resource Function, MF and/or MRF.

22. The method of claim 19, further comprising:
monitoring whether a user changes during Avatar transcoding/rendering; and
determining a reaction to a user change, wherein the reaction may be one of Sending an indication to the second UE and/or Switching to a default Avatar model, and/or Switching back to normal audio/video communication, and/or Stopping the communication session.

23. The method of claim 13, further comprising authorizing the second UE to use and/or store the avatar model by providing an authorization token to the second UE.

24. The method of claim 23, wherein the token is associated to at least one of a plurality of usage conditions, wherein the plurality of usage conditions comprises at least one of type of access, type of rendering, type of use, and access duration.

25. The method of claim 10,
wherein the Avatar model and/or policy are sent protected,
wherein a UE checks the policy,
wherein the Avatar model/metadata is unlocked if the usage conditions are met.

26. The method of claim 10, wherein the Avatar model is retrieved if authorized to be stored and not stored from a previous communication.

27. The method of claim 10, wherein the apparatus or the first UE or second UE or the MF/MRF are configured with an authorization token that comprises at least one of UE ID, an Avatar ID, a Conditions for usage, a Key identifier to decrypt the Avatar model/metadata, and a Key to decrypt/undo protections of the Avatar model/metadata.

28. The method of claim 1, further comprising:
performing an authentication and key management procedure for user authentication and authorization, or
optimizing the connection based on an identified user, or
enabling a transmission of user identification data during an emergency call.

29. The method of claim 1, further comprising retrieving or configuring or applying a user authentication policy in a core network function,
wherein the user authentication policy is user-defined or subscription-defined; and/or
wherein the user authentication policy comprises user authentication methods applicable or required to access different services,
the user authentication policy comprises a user consent to use a predetermined authentication method.

30. The method of claim 1, further comprising:
registering to a network and indicating its user authentication capabilities as part of the selection of one of a plurality of authentication procedures;
receiving a user authentication request;
performing local user authentication; and
sending the user authentication result as part of performing the selected authentication procedure with or through a core network; and
setting up the user-specific connection when the selected authentication procedure succeeds.

31. The method of claim 1, further comprising performing a selected authentication procedure wherein the performing of the selected authentication procedure comprises:
performing a primary authentication procedure;
collecting user authentication information, wherein the user authentication information comprises at least one of biometric information, information of other user devices close or connected to or attached to the apparatus and the user, and user credentials; and
locally checking the user authentication information to perform a local user identification authentication or sending the collected user authentication information to the core network for remote user identification and authentication.

32. The method of claim 8, and 31,
wherein the second measurement is obtained from a second user device,
wherein the second device is close, or connected to, or attached to the apparatus and a user,
wherein the second measurement is correlated with the first measurement to provide enhanced user authentication.

33. The method of claim 30, further comprising performing continuous user authentication at random instants of time, or periodically, wherein the periodicity is based on at least one of authentication capabilities/methods supported by the user equipment, network configuration, user preferences, type of service requested, connectivity state of the user equipment, and the number of users associated with a user equipment or subscription.

34. The method of claim 30, further comprising:
logging the failed authentication event if user authentication procedure fails, and/or
sending an authentication error message to the network indicating the failure cause if user authentication procedure fails, and/or
performing based on a policy or configuration at least one of a user authentication using an alternative local user authentication method, or credentials associated with the user if user authentication procedure fails, or,
triggering a user authentication and authorization procedure involving the home network and/or an application function if user authentication procedure fails.

35. The method of claim 30, further comprising providing the network with user credentials and/or user specific emergency supplementary information during emergency session establishment,
wherein the user credentials and/or user specific emergency supplementary information is protected based on an emergency policy or user preferences,
wherein the user preferences which comprises at least one of requesting user approval for null security protection, requesting user approval to include user credentials and/or emergency supplementary information, protecting the user credentials and/or user specific emergency supplementary information using one of the following home network public key, long-term key associated with user SIM, emergency-specific key, and null security algorithms.

36. The method of claim 30, further comprising:
receiving a user authentication request;
performing user authentication locally;
performing device attestation;
sending a user authentication response, wherein the user authentication response comprises the user identity and the result of the performed device attestation.

37. The method of any of claim 30, further comprising:
receiving a configuration with generic user profiles, wherein a generic user profile is the anonymous user profile;
identifying a user and assign it to a generic user profile; and
transmitting the assigned user profile to the network.

38. The method of claim 37, further comprising:
transmitting the assigned user profile to the radio access network; and
receiving configuration parameters for the communication link with the radio access network tailored to the transmitted user profile.

39. The method of claim 30, further comprising storing user credentials in a user SIM,
wherein a user SIM or user biometrics are required to unlock the user SIM and access the user credentials,
wherein the user credentials comprise at least one of user identity, user identifier, user identification profile, user profile, emergency supplementary information, keying materials, biometrics associated with the user.

40. The method of claim 1, further comprising:
receiving a first message, wherein the first message comprises at least one of a first freshness parameter, wherein the first freshness parameter comprises a random number or counter, an identity of a device, an access device, authentication service, or group of devices, or application or network, a supported message type, a supported device type, a data container, a request to retrieve certain information, and a supported communication topology,
determining whether the first message is intended for the apparatus, and
ending a second message to perform the selected authentication procedure and setting up the connection, Wherein the second message comprises at least one of a data container, a second freshness parameter including a random number or counter, an identity of the access device or the authentication service or application or network, a message type, a device type, an amount of energy harvested and an energy harvest duration, and a communication topology.

41. The method of claim 40, further comprising:
receiving the first message, wherein the first message comprises a first freshness parameter, wherein the first freshness parameter comprises a random number or counter, an identity of an access device, authentication service, a device and/or a group/class of devices, or application or network, a data container, a request to retrieve certain information;
selecting the authentication procedure after determining whether the first message is intended for the apparatus; and
sending the second message to perform the selected authentication procedure and set-up the connection, wherein the second message comprises at least one of a second freshness parameter including a random number or counter, a data container, an identity of the access device or the authentication service or application or network.

42. The method of claim 40, wherein the determining whether the first message is intended for the apparatus is based on matching one or a combination of the fields in the first message.

43. The method of claim 40, further comprising:
computing a first security value, wherein the first message comprises an indication of at least a first security value to be generated for authentication with a reader; and
transmitting the first security value or a message authentication code computed using the first security value in a second message.

44. The method of claim 40, wherein the data container in the second message is protected between an apparatus and an application function.

45. The method of claim 40, further comprising transmitting an indication of low energy state when the apparatus lacks the energy resources to transmit the second message.

46. The method of claim 45, further comprising checking whether the subsequent message received comprises a request to switch the transmission mode to backscatter communication.

47. A method comprising:
registering and announcing its capabilities to a the network;
receiving, from the network and/or an application function, a configuration for connection set up and management between a first device and the network and/or application function; and
managing, messages exchanged between the first device and the network or application function based on the configuration.

48. The method of claim 47, further comprising requesting the first device to switch its transmission mode to backscatter communication upon receiving an indication of low energy from the first device.

49. The method of claim 48, wherein the capabilities announced to the network comprises at least one of transmission of messages, wherein the messages comprise data containers, receiving messages, wherein the messages comprise data containers, exchanging security protocol-specific parameters, a list of at least one topology supported, a list of at least one authentication method supported, an interim authentication results verification, an aggregation and/or storage of received response messages, processing received response messages to identify and/or authenticate the first device.

50. The method of claim 48, further comprising:
receiving authorization by the network to connect to an application function to exchange messages with at least one first device;
receiving a first container with at least a first message for at least one first device;
transmitting at least the first message to the first device in the communication resources authorized by the network;
receiving at least one second message from the first device; and
aggregating the at least one second message from the second device in a second container and sending it to the application function.

51. The method of any of claim 47, wherein a configuration comprises determines at least one an Authorized communication topology, a periodicity of communication requests, an authorized communication resources, a time window or schedule for data retrieval from the first device, a time window or schedule, for delivering messages to the network or application function, a list of at least one intermediate node to be used, a timing information to trigger communication request(s), an indication for collecting network resources usage data, an identity of a device and/or group of devices to target, an identity of a service, authentication method, network, or application to match against messages received from the first device, a security keying materials associated to one or a group of devices, a location information of devices to target, an intermediate authentication verification values, an indication to verify authentication results received, an indication to forward, or discard, authentication response messages which failed verification, an indication to allow communication, data retrieval and/or storage of data received from the first device, when out of 3GPP coverage, conditions to trigger communication with the first device, when out of 3GPP coverage.

52. A device comprising:
a receiver circuit,
a transmitter circuit,
a controller circuit and a memory circuit, wherein the memory is arranged to store instructions for the controller circuit,
wherein the controller circuit is arranged to select one of a plurality of authentication procedures,
wherein the controller circuit is arranged to perform the selected authentication procedure with or through a core network,
wherein the controller circuit is arranged to set up the connection, if the selected authentication procedure is successful.

53. A device comprising:
a receiver circuit,
a transmitter circuit,
a controller circuit and a memory circuit, wherein the memory is arranged to store instructions for the controller circuit,
wherein the controller circuit is arranged to establish and manage a connection between a first device and a network or application function, wherein the establishing and managing comprises:
registering and announcing capabilities to the network;
receiving a configuration for connection set up and management between the first device and the network and/or application function; and
managing messages exchanged between the first device and the network or application function based on the configuration.

54. (canceled)

55. A non-transitory computer-readable medium storing a computer program, wherein the computer program when executed on a processor performs the method as claimed in claim 1.

56. A non-transitory computer-readable medium storing a computer program, wherein the computer program when executed on a processor performs the method as claimed in claim 47.
